(19) United States
(12) Patent Application Publication
(10) Pub. No.: US 2025/0376385 A1
(43) Pub. Date: Dec. 11, 2025

(54) PEROVSKITE POWDER, LIGHT EMITTING LAYER FOR LIGHT EMITTING DEVICE AND METHOD FOR MANUFACTURING THE SAME

(71) Applicant: Seoul National University R&DB Foundation, Seoul (KR)

(72) Inventors: Tae-Woo Lee, Seoul (KR); Jung-Min Heo, Seoul (KR); Chan-Yul Park, Seoul (KR); Joo Sung Kim, Seoul (KR)

(21) Appl. No.: 19/228,648

(22) Filed: Jun. 4, 2025

(30) Foreign Application Priority Data
Jun. 5, 2024 (KR) 10-2024-0074037
Jun. 2, 2025 (KR) 10-2025-0072241

(51) Int. Cl. C01D 17/00; C09K 11/61

(52) U.S. Cl. CPC C01D 17/003; C09K 11/613; C01P 2002/34

(57) ABSTRACT

A perovskite powder, a light emitting layer for a light emitting device, a perovskite layered structure, an optoelectronic device including the same, and a method for manufacturing the same are provided. The perovskite powder is easy to control the crystal phase ratio in the light emitting layer and is not pyrolyzed during deposition. In addition, the light emitting layer for the light emitting device has an enhanced exciton confinement effect to have excellent light emission efficiency and the like. In addition, the method for manufacturing the light emitting layer for the light emitting device may control the ratio of crystal phases in the light emitting layer and is advantageous for large-area manufacturing. In addition, the perovskite layered structure maintains very high phase uniformity. Further, the optoelectronic device has excellent performance. Furthermore, the method for manufacturing the perovskite layered structure may manufacture a large-area and uniform perovskite thin film.

### TECHNICAL FIELD

The present disclosure relates to a perovskite powder, a light emitting layer for a light emitting device, and a method for manufacturing the same, and more particularly, to a perovskite powder, which is easy to adjust a crystal phase ratio in a light emitting layer and is not pyrolyzed during deposition, a light emitting layer for a light emitting device that has an enhanced exciton confinement effect to have excellent light emission efficiency and the like, and a method for manufacturing a light emitting layer for a light emitting device, which may control a crystal phase ratio of the light emitting layer and is advantageous for large-area manufacture.

Further, the present disclosure also relates to a perovskite layered structure using a dry deposition method, an optoelectronic device including the same, and a method for manufacturing the same, and more particularly, to a perovskite layered structure that maintains very high phase uniformity, an optoelectronic device including the same and a method for manufacturing a perovskite layered structure capable of manufacturing the same in a large area.

### DISCUSSION OF RELATED ART

In recent years, the display industry has evolved beyond research on high efficiency and high resolution to research on high color purity and natural color expression. For this purpose, an organic light emitting device and a light emitting device using an inorganic quantum dot are commercially available in the related art. However, the organic light emitting device has low color purity, and the inorganic quantum dot has a problem in that it is difficult to control a size distribution in blue light emission.

On the other hand, perovskite is a material in which a metal, an organic material, and a halogen group (fluorine (F), chlorine (Cl), bromine (Br), and the like) are bonded to form a compound crystal structure, and has high light absorptivity and excellent charge transfer capability. Accordingly, the perovskite has high color purity, easily adjusts color, and may increase light emission efficiency, and thus has been in the spotlight as a substitute material for conventional organic light emitting devices. In addition, the perovskite is expected to be commercialized quickly because the material costs are lower than those of silicon-based inorganic solar cells.

In Patent Document 1 (Korean Patent Registration No. 10-2531001), a light emitting layer using perovskite has been developed mainly based on a solution process using a spin-coating method. However, limitations of the solution process-based perovskite include poor reproducibility depending on thin film formation conditions and surrounding environments, difficulty in thickness adjustment, and difficulty in forming a thin film having a uniform morphology due to difficulty in large-area coating. These limitations need to be improved as the most important factor for limiting commercialization in the display market.

In order to solve this problem, studies on various methods such as a deposition method, a sol-gel method, a blade coating method, a spray coating method, an inkjet coating method, and the like have been attempted as a method for enabling a large-area process of a perovskite light emitting layer. For reference, a thermal deposition method is a typical process in which materials are added into a crucible in a vacuum, heated, and deposited in a vacuum state, and is one of representative dry deposition methods.

In particular, among these, the dry deposition method is representatively physical vapor deposition and chemical vapor deposition, and as a technology mainly used in the thin film and semiconductor industries, has an economic advantage in that deposition equipment used in conventional organic light emitting diode (OLED) industry may be used as it is. In addition, since the process is mainly performed in a vacuum state and solid precursors are used, the dry deposition method is less sensitive to the process environment, so that more uniform and large-area pixels may be obtained than other solution-based large-area processes, and thickness adjustment is also easy. In addition, the dry deposition method has an advantage that it is possible to improve the pixel definition for application to a large-area display, and patterning is enabled by using a mask.

For example, in Patent Document 2 (Korean Patent Registration No. 10-2144090), there has been developed a method capable of improving an energy level, a charge transport degree, and an emission wavelength of a light emitting layer through co-deposition of a perovskite-organic low molecular host mixed light emitting layer in a light emitting device to adjust a type of material, a ratio between materials, and a deposition rate. This method has an advantage that the crystal size of perovskite may be reduced.

As another example, in Non-Patent Document 1 (Nat. Photon. 17, 435-441 (2023)), a nanoparticle structure in which a phosphine oxide ligand passivates defects on a perovskite surface through a triple source co-deposition process was realized through co-deposition, and the possibility of improving the efficiency and patterning of a light emitting body was reported.

Meanwhile, 3D perovskite has good electrical conductivity and is advantageous in terms of charge transport, but has a problem in that an effect of confining excitons is small, and thus there is a limit to its application to a light emitting device.

In addition, in the case of using perovskite having a quantum dot size, there is an effect of more strongly confining the excitons, but there are disadvantages that a ratio of the surface area to the volume rapidly increases, and thus the surface defects increase, and a charge transport is disadvantageous due to a decrease in electrical conductivity caused by long alkyl ligands.

The size of perovskite may be easily decreased or increased using a deposition process, but studies on quasi-2D perovskites are extremely rare, which may lead to desired properties through adjustment of the phase distribution and have only the advantages of 3D perovskite and quantum dot-sized perovskite.

Particularly, in the related art, when a light emitting layer is manufactured by using a perovskite precursor together as a deposition source in a deposition process and perovskite crystals are formed at the same time, there are problems that it has been difficult to selectively obtain only a desired crystal phase, it is difficult to adjust a crystal phase ratio, and a precursor material remains without being synthesized into perovskite.

In addition, in the related art, when quasi-2D perovskite is formed through a deposition process, not only various n-phases such as high n-phase, intermediate-n-phase and low n-phase are non-uniformly mixed, but also 0D and 3D perovskites are non-uniformly mixed. For this reason, an energy absorption or energy funneling effect is inefficiently generated, and thus when applied to a device, the light absorption performance, the photoelectric conversion efficiency, the light emission performance, or the like are deteriorated, and there is a limitation in that the light emission FWHM of the light emission spectrum is widened, and thus the high color purity characteristics of perovskite materials may be lost.

### RELATED ART DOCUMENTS

### Patent Documents

(Patent Document 1) Korean Patent Registration No. 10-2531001
(Patent Document 2) Korean Patent Registration No. 10-2144090

### Non-Patent Documents

(Non-Patent Document 1) Efficient all-thermally evaporated perovskite light-emitting diodes for active-matrix displays, Volume 17, Issue 5, pp. 435-441.

### SUMMARY OF THE INVENTION

### Problem to be Solved

A first object to be solved in the present disclosure is to provide a method for manufacturing a perovskite powder capable of selectively extracting only a desired crystal phase.

A second object to be solved by the present disclosure is to provide a perovskite powder that may form a desired dimensional phase even though an excess of A-site ions is used, secure a small crystal size advantageous for a light emitting body at the same time while removing a metallic material, may be used as a single-source deposition source in the manufacturing of a light emitting layer to easily adjust a ratio of crystal phases in the light emitting layer, may act as a single-source deposition source without being pyrolyzed even though other ions are doped in the A-site, and is not pyrolyzed during deposition.

A third object to be solved by the present disclosure is to provide a method for manufacturing a light emitting layer for a light emitting device, which may control a crystal phase ratio and grain sizes of 3D and quasi-2D perovskites in the light emitting layer, may lower a metallic material in the light emitting layer, may uniformly adjust the thickness and density of the light emitting layer, has an advantage in large-area manufacturing, and is advantageous in patterning.

A fourth object to be solved by the present disclosure is to provide a light emitting layer for a light emitting device, which includes quasi-2D perovskites to have an enhanced exciton confinement effect, is excellent in reproducibility, is efficient in energy funneling, has a uniform surface and few defects, may have an efficient orbital function overlap to have high electron mobility, and has excellent light emission efficiency and light emission intensity.

A fifth object to be solved by the present disclosure is to provide a light emitting device having excellent luminance, excellent light emission efficiency and light emission intensity, high electron mobility, and excellent color purity.

The present disclosure has been devised to solve the problems, and an object of the present disclosure is to provide a perovskite layered structure in which a perovskite thin film manufactured by a dry deposition method maintains high phase uniformity, thereby maximizing light emission performance such as light-absorption performance and photoelectric conversion efficiency in use in solar cells or light emission efficiency and external quantum efficiency in use in light emitting devices, and having a very low light emission FWHM in a light emitting spectrum.

Further, another object of the present disclosure is to provide an optoelectronic device that maximizes light emission performance or light absorption performance, photoelectric conversion efficiency, and the like and has a low turn-on voltage.

Yet another object of the present disclosure is to provide a method for manufacturing a perovskite layered structure capable of manufacturing a perovskite thin film having high phase uniformity by inhibiting low n-phase quasi-2D perovskite crystal growth, and manufacturing a layered structure having a large area that maintains excellent light emission performance or excellent light absorption performance and photoelectric conversion efficiency.

Technical objects to be achieved in the present disclosure are not limited to the aforementioned objects, and other technical objects not described above will be apparently understood to those skilled in the art from the following disclosure of the present disclosure.

### Means for Solving the Problem

In order to solve the first object described above, there is provided a method for manufacturing a perovskite powder, including reacting CsX and BX₂ to manufacture a perovskite powder.

At this time, B is a metal ion and X is F⁻, Cl⁻, Br⁻, I⁻, SCN⁻, OCN⁻, SeCN⁻, HCO²⁻, CH₃COO⁻, CF₃COO⁻ or a combination thereof.

In addition, the B described above may be a divalent transition metal ion, a rare earth metal ion, an alkaline earth metal ion, a monovalent metal ion, a trivalent metal ion, or a combination thereof.

According to a preferred embodiment of the present disclosure, a molar ratio of the CsX and BX₂ described above may be 1.15:1 to 1.95:1, preferably 1.3:1 to 1.7:1. More preferably, the molar ratio may be 1.5:1 to 1.6:1. More specifically, the molar ratio may be 1.15:1, 1.2:1, 1.25:1, 1.3:1, 1.35:1, 1.4:1, 1.45:1, 1.5:1, 1.55:1, 1.6:1, 1.65:1, 1.7:1, 1.75:1, 1.8:1, 1.85:1, 1.9:1 or 1.95:1. When the ratio of CsX is less than 1.15, there is a problem in that metallic lead (Pb) is formed to lower the light emission efficiency, and when the ratio of CsX exceeds 1.95, by-products (e.g., Cs₄PbBr₆) are generated, and uniform deposition may not be performed.

In addition, A′X may further react with the solution described above.

At this time, A′ is a monovalent organic cation, a monovalent inorganic cation without Cs⁺ or a combination thereof, and X is F⁻, Cl⁻, Br⁻, I⁻, SCN⁻, OCN⁻, SeCN⁻, HCO²⁻, CH₃COO⁻, CF₃COO⁻ or a combination thereof.

In addition, the perovskite powder may be Cs₁₋ₐA′ₐBX₃ crystals.

At this time, A′ is a monovalent organic cation, a monovalent inorganic cation without Cs⁺, or a combination thereof, and a is 0, 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9.

In order to solve the second object described above, there is provided a perovskite powder having a CsBX₃ structure with a crystallite size of 110 nm or less, in which the powder has peaks at 14 to 16°, 20 to 22°, 30 to 31°, 33 to 35°, and 37 to 38° without peaks at 11 to 14° as 20 values in an XRD graph.

In this case, the B is a metal ion, the X is F⁻, Cl⁻, Br⁻, I⁻, SCN⁻, OCN⁻, SeCN⁻, HCO²⁻, CH₃COO⁻, CF₃COO⁻ or a combination thereof, the crystallite size of the powder is measured by X-ray diffraction and then obtained using Scherrer equation (D=Kλ/β cos θ), in which D is a crystallite size, K is a shape factor, λ is an X-ray wavelength, β is the full width at half maximum (FWHM) of a maximum intensity peak, and θ is an X-ray incident angle.

In addition, in the perovskite powder described above, perovskites having a CsBX₃ structure may be manufactured into powder by adding and reacting an aqueous solution of HX (H is hydrogen) in a solution dissolved with CsX and BX₂ precursors.

In addition, the B described above may be a divalent transition metal ion, a rare earth metal ion, an alkaline earth metal ion, a monovalent metal ion, a trivalent metal ion, or a combination thereof.

In addition, the molar ratio of CsX and BX₂ described above may be 1.15:1 to 1.95:1.

In addition, A′X may further react with the solution described above.

At this time, the A′ is a monovalent organic cation, a monovalent inorganic cation without Cs⁺ or a combination thereof, and X is F⁻, Cl⁻, Br⁻, I⁻, SCN⁻, OCN⁻, SeCN⁻, HCO²⁻, CH₃COO⁻, CF₃COO⁻ or a combination thereof.

In addition, the powder described above may not have peaks at binding energy of 136 to 138 eV and 141 to 142 eV and may have peaks at binding energy of 138 to 140 eV and 143 to 145 eV in the XPS graph.

In order to solve the second object described above, there is provided a perovskite powder containing a powder containing Cs₁₋ₐA′ₐBX₃ crystals.

At this time, the A′ is a monovalent organic cation, a monovalent inorganic cation excluding Cs⁺ or a combination thereof, the B is a metal ion, the X is F⁻, Cl⁻, Br⁻, I⁻, SCN⁻, OCN⁻, SeCN⁻, HCO²⁻, CH₃COO⁻, CF₃COO⁻ or a combination thereof, and the a is greater than 0 and 0.9 or less, more specifically 0.05, 0.1, 0.15, 0.2, 0.25, 0.3, 0.35, 0.4, 0.45, 0.5, 0.55, 0.6, 0.65, 0.7, 0.75, 0.8, 0.85 or 0.9.

In addition, the B described above may be Pb²⁺ and X may be Br⁻.

In addition, the powder described above may not have peaks at binding energy of 136 to 138 eV and 141 to 142 eV, and may have peaks at binding energy of 138 to 140 eV and 143 to 145 eV in the XPS graph.

In addition, the powder described above may have peaks at 14˜16°, 20˜22°, 30˜31°, 33˜35°, and 37˜38° without peaks at 11-14° as the 20 values in the XRD graph.

In order to solve the third object described above, there is provided a method for manufacturing a light emitting layer for a light emitting device, including: depositing a perovskite powder containing Cs₁₋ₐA′ₐBX₃ crystals with a single-source deposition source to manufacture a light emitting layer.

At this time, the A′ is a monovalent organic cation, a monovalent inorganic cation excluding Cs⁺ or a combination thereof, the B is a metal ion, the X is F⁻, Cl⁻, Br⁻, I⁻, SCN⁻, OCN⁻, SeCN⁻, HCO²⁻, CH₃COO⁻, CF₃COO⁻ or a combination thereof, and the a is 0 to 0.9, more specifically, 0, 0.05, 0.1, 0.15, 0.2, 0.25, 0.3, 0.35, 0.4, 0.45, 0.5, 0.55, 0.6, 0.65, 0.7, 0.75, 0.8, 0.85 or 0.9.

In addition, the step of manufacturing the light emitting layer may be a step of manufacturing the light emitting layer for the light emitting device by using a perovskite powder containing Cs₁₋ₐA′ₐBX₃ crystals as a single-source deposition source, performing vapor deposition by applying heat in a high vacuum state of 10-5 torr or less, and forming a thin film through the vapor deposition.

Further, the deposition rate of the single-source deposition source described above may be 0.1 to 2.0 Å/s, preferably 0.5 to 1.5 Å/s and more preferably 0.7 to 1.2 Å/s. More specifically, the deposition rate may be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9 or 2.0 Å/s.

According to a preferred embodiment of the present disclosure, the deposition described above may be co-deposition of a compound containing cations having an ionic radius larger than the ionic radius of Cs in order to substitute part or all of the Cs.

Further, the compound described above may be an aromatic ammonium halide compound.

According to a preferred embodiment of the present disclosure, the deposition rate ratio of the single-source deposition source and the deposition source containing the compound in the co-deposition described above may be 1:0.05 to 1:1, preferably 1:0.2 to 1:0.85, and more preferably 1:0.65 to 1:0.85. More specifically, the deposition rate ratio may be 1:0.05, 1:0.1, 1:0.15, 1:0.2, 1:0.25, 1:0.3, 1:0.35, 1:0.4, 1:0.45, 1:0.5, 1:0.55, 1:0.6, 1:0.65, 1:0.7, 1:0.75, 1:0.8, 1:0.85, 1:0.9, 1:0.95 or 1:1.

In order to solve the fourth object described above, there is provided a light emitting layer for a light emitting device manufactured by the method for manufacturing the light emitting layer described above.

In order to solve the fourth object described above, there is provided a light emitting layer for a light emitting device, which includes Cs₁₋ₐA′ₐBX₃ crystals and/or A″₂(Cs₁₋ₐA′ₐ)ₘ₋₁BₘX₃ₘ₊₁ crystals in the light emitting layer, in which in an XPS graph of the light emitting layer, peaks are not shown at binding energy of 136 to 138 eV and 141 to 142 eV and peaks are shown at binding energy of 138 to 140 eV and 143 to 145 eV.

At this time, the A′ is a monovalent organic cation, a monovalent inorganic cation excluding Cs⁺ or a combination thereof, the A″ is a cation having an ionic radius greater than the ionic radius of Cs for partially or fully substituting Cs, the B is a metal ion, the X is F⁻, Cl⁻, Br⁻, I⁻, SCN⁻, OCN⁻, SeCN⁻, HCO²⁻, CH₃COO⁻, CF₃COO⁻ or a combination thereof, the a is 0 to 0.9, more specifically 0, 0.05, 0.1, 0.15, 0.2, 0.25, 0.3, 0.35, 0.4, 0.45, 0.5, 0.55, 0.6, 0.65, 0.7, 0.75, 0.8, 0.85 or 0.9, and the m may be an integer of 2 to 6.

In addition, the B described above may be Pb²⁺ and the X may be Br⁻.

In addition, the Cs₁₋ₐA′ₐBX₃ crystal described above may be a 3D perovskite crystal, and the A″₂(Cs₁₋ₐA′ₐ)ₘ₋₁BₘX₃ₘ₊₁ crystal described above may be a quasi-2D perovskite crystal.

In addition, a mean grain size of the Cs₁₋ₐA′ₐBX₃ crystal and/or A″₂(Cs₁₋ₐA′ₐ)ₙ₋₁BₙX₃ₙ₊₁ crystal described above may be 5 to 50 nm. The mean grain size may be preferably 10 to 30 nm, and more preferably 15 to 25 nm. More specifically, the mean grain size may be 5 nm, 5.5 nm, 6 nm, 6.5 nm, 7 nm, 7.5 nm, 8 nm, 8.5 nm, 9 nm, 9.5 nm, 10 nm, 10.5 nm, 11 nm, 11.5 nm, 12 nm, 12.5 nm, 13 nm, 13.5 nm, 14 nm, 14.5 nm, 15 nm, 15.5 nm, 16 nm, 16.5 nm, 17 nm, 17.5 nm, 18 nm, 18.5 nm, 19 nm, 19.5 nm, 20 nm, 20.5 nm, 21 nm, 21.5 nm, 22 nm, 22.5 nm, 23 nm, 23.5 nm, 24 nm, 24.5 nm, 25 nm, 25.5 nm, 26 nm, 26.5 nm, 27 nm, 27.5 nm, 28 nm, 28.5 nm, 29 nm, 29.5 nm, 30 nm, 30.5 nm, 31 nm, 31.5 nm, 32 nm, 32.5 nm, 33 nm, 33.5 nm, 34 nm, 34.5 nm, 35 nm, 35.5 nm, 36 nm, 36.5 nm, 37 nm, 37.5 nm, 38 nm, 38.5 nm, 39 nm, 39.5 nm, 40 nm, 40.5 nm, 41 nm, 41.5 nm, 42 nm, 42.5 nm, 43 nm, 43.5 nm, 44 nm, 44.5 nm, 45 nm, 45.5 nm, 46 nm, 46.5 nm, 47 nm, 47.5 nm, 48 nm, 48.5 nm, 49 nm, 49.5 nm, or 50 nm, and preferably 15 nm, 15.5 nm, 16 nm, 16.5 nm, 17 nm, 17.5 nm, 18 nm, 18.5 nm, 19 nm, 19.5 nm, 20 nm, 20.5 nm, 21 nm, 21.5 nm, 22 nm, 22.5 nm, 23 nm, 23.5 nm, 24 nm, 24.5 nm or 25 nm. When the mean grain size is less than 5 nm, it may be difficult to adjust the size distribution of the crystals, and the surface is increased to increase the number of defects, thereby reducing the light emission efficiency. When the mean grain size is more than 50 nm, as the exciton binding energy becomes smaller in a large grain, the confinement effect of the exciton becomes smaller, and then radioactive recombination is reduced, so that the light emission efficiency may be reduced.

In order to solve the fifth object described above, there is provided a light emitting device including the light emitting layer for the light emitting device described above.

In order to solve the problems, there is provided a perovskite layered structure including: a first scaffold layer; a second scaffold layer formed on the first scaffold layer; and a perovskite thin film formed on the second scaffold layer.

In addition, the first scaffold layer may induce self-assembly of the second scaffold layer.

Further, the first scaffold layer may also include a metal halide.

Further, the metal halide is represented by MXₙ, wherein n is an integer of 1 to 3, the Mis at least one of Li, Na, K, Rb, Cs, Fr, Be, Mg, Ca, Sr, Ba, Ra, B, Al, Ga, In, Ti, Sn, and Pb, and the X may be at least one of F, Br, Cl, and I.

In addition, the second scaffold layer may crystallize the perovskite thin film into a high n-phase quasi-2D structure.

In addition, the second scaffold layer may include a polar organic molecule containing an acid functional group for self-assembly of the second scaffold layer on the first scaffold layer.

In addition, the acid functional group may be at least any one of a carboxylic acid group (—COOH), a hydroxyl group (—OH), a sulfonic acid group (—SO₃H), a sulfuric acid group (—OSO₃H), a thiol group (—SH), and a phosphoric acid group (—PO₃H₂, —PO₄H₂).

In addition, the organic molecule may include an aromatic moiety.

In addition, the organic molecule may be P—R or P-Q-R. At this time, the P is an aromatic group including 1 to 5 aromatic rings, the Q is C1 to C10 hydrocarbon, and the R is an acid functional group.

In addition, the organic molecule may be at least any one of benzoic acid, 4-methylbenzoic acid, 4-vinylbenzoic acid, phenylacetic acid, 3-phenylpropionic acid, 5-phenylvaleric acid, 1-naphthoic acid, 2-naphthoic acid, 9-anthracene carboxylic acid, 2-fluorene carboxylic acid, 1-pyrene carboxylic acid, 3-chrysene carboxylic acid, 3-carbazole carboxylic acid, phenol, 4-methylphenol (p-cresol), 4-vinylphenol, 1-naphthol, 2-naphthols, anthracenol, fluorenol, pyrenol, chrysenol, carbazolol, benzenesulfonic acid, toluene sulfonic acid, naphthalene-2-sulfonic acid, anthracene sulfonic acid, fluorene sulfonic acid, pyrene sulfonic acid, chrysene sulfonic acid, carbazole sulfonic acid, phenyl sulfate, naphthyl sulfate, benzenethiol, toluenethiol, naphthalenethiol, anthracenethiol, fluorenethiol, pyrenethiol, chrysenethiol, carbazole thiol, phenylphosphonic acid, benzylphosphonic acid, naphthalenylphosphonic acid, anthracenylphosphonic acid, fluorenylphosphonic acid, pyrenylphosphonic acid, chrysenylphosphonic acid, carbazolylphosphonic acid, phenylphosphoric acid, 1-Naphthyl phosphate and their derivatives.

In addition, the perovskite thin film may further include an organic ligand.

In addition, the organic ligand may be the same as the organic molecule included in the second scaffold layer.

Further, the thickness of the first scaffold layer may be 0.1 to 10 nm, and the thickness of the second scaffold layer may be 0.4 to 10 nm.

In addition, in the perovskite thin film, (002)ₙ₌₁ and (012) op peaks may not be shown in a Grazing Incident Wide Angle X-ray Scattering (GIWAXS) Z-direction graph.

In addition, the perovskite layered structure may further include an additional scaffold layer between the second scaffold layer and the perovskite thin film, and the additional scaffold layer may be formed of multiple layers in which the same layers as the first scaffold layer and the same layers as a second scaffold layer are alternately stacked several times.

In order to solve the problems, there is provided an optoelectronic device including the perovskite layered structure described above.

In order to solve the problems, there is provided a method for manufacturing a perovskite layered structure, the method including: (1) forming a first scaffold layer on a substrate; (2) forming a second scaffold layer on the first scaffold layer; and (3) depositing a perovskite thin film on the second scaffold layer.

In addition, in step (3), the deposition may be dry deposition using a perovskite double source or triple source.

In addition, during the deposition, an organic ligand source may be further used.

Further, in step (3), before depositing the perovskite thin film, an additional scaffold layer may be further formed on the second scaffold layer, and the additional scaffold layer may be formed by alternately stacking the same layers as the first scaffold layer and the same layers as the second scaffold layer.

### [National Research and Development Project 1 Supporting the Disclosure]

[Project Unique Number] 2400422598
[Project Number] RS-2024-00422598
[Ministry name] Ministry of Science and ICT
[Project Management (Special) Institution Name] Commercialization Promotion Agency for R&D Outcomes
[Research Project Name] University Technology Management Promotion (1P Star Scientist. Support Type)
[Research Subject Name] IP Enhancement and Commercialization for Promoting Commercialization of Next-Generation Electronic Materials and Electronic Device Technologies Applying Optical and Electrical Properties of Perovskite
[Project performance institute name] Seoul National University Industry-Academic Cooperation Foundation
[Research Period] Apr. 1, 2024 to Dec. 31, 2025

### Effects of the Invention

According to the present disclosure, the method for manufacturing the perovskite powder can selectively extract only a desired crystal phase.

Further, the perovskite powder can form a phase of a desired dimension even though an excess of A-site ions is used, secure a small crystal size advantageous for a light emitting body while removing a metallic material, can be used as a single-source deposition source in the manufacturing of a light emitting layer to easily adjust a ratio of crystal phases in the light emitting layer, can act as a single-source deposition source without being pyrolyzed even though other ions are doped in the A-site, and is not pyrolyzed during deposition.

Further, the method for manufacturing the light emitting layer for the light emitting device can control a crystal phase ratio and grain sizes of 3D and quasi-2D perovskites in the light emitting layer, lower a metallic material in the light emitting layer, and uniformly adjust the thickness and density of the light emitting layer, has an advantage in large-area manufacturing, and is advantageous in patterning.

Further, the light emitting layer for the light emitting device includes quasi-2D perovskites to have an enhanced exciton confinement effect, is excellent in reproducibility, is efficient in energy funneling, has a uniform surface and few defects, can have an efficient orbital function overlap to have high electron mobility, and has excellent light emission efficiency and light emission intensity.

Furthermore, the light emitting device has excellent luminance, excellent light emission efficiency and light emission intensity, high electron mobility, and excellent color purity.

In the perovskite layered structure according to the present disclosure, the perovskite thin film included therein maintains a high degree of uniformity, maximizes light emitting performance such as light-absorption performance and photoelectric conversion efficiency in use in a solar cell or light emission efficiency and external quantum efficiency in use in the light emitting device, and has a very low emission half-width in the emission spectrum.

In addition, the optoelectronic device according to the present disclosure maximizes light emission performance or light absorption performance, photoelectric conversion efficiency, and the like, and has a low turn-on voltage.

Furthermore, in the method for manufacturing the perovskite layered structure according to the present disclosure, it is possible to manufacture a perovskite thin film having high phase uniformity by inhibiting low n-phase quasi-2D perovskite crystal growth, and to manufacture a layered structure having a large area that maintains excellent light emission performance or excellent light absorption performance and photoelectric conversion efficiency.

It should be understood that the effects of the present disclosure are not limited to the effects described above, but include all effects that can be deduced from the detailed description of the present disclosure or configurations of the disclosure described in claims.

### BRIEF DESCRIPTION OF THE DRAWINGS

FIG. 1A is an image showing a process for manufacturing a single perovskite powder according to a preferred embodiment of the present disclosure;

FIG. 1B is a step diagram showing a step of manufacturing a single perovskite powder according to a preferred embodiment of the present disclosure;

FIG. 1C is a schematic diagram showing a deposition process using a single perovskite deposition source according to a preferred embodiment of the present disclosure;

FIG. 1D is a schematic diagram showing a co-deposition process of a single perovskite deposition source and an organic ammonium halide compound according to a preferred embodiment of the present disclosure;

FIG. 2 is a schematic diagram illustrating a patterning implementation method using a deposition process according to a preferred embodiment of the present disclosure;
(a), (b), and (c) of FIG. 3 are images showing perovskite crystal lattice structures having a 3D structure, a quasi-2D structure, and a 2D structure, respectively;

FIG. 4A is a graph showing a photoluminescence spectrum of light emitting layers including perovskite crystals prepared at various ratios of CsBr and PbBr₂;

FIG. 4B is a TCSPC analysis graph showing light emitting layers including perovskite crystals prepared at various ratios of CsBr and PbBr₂;

FIG. 4C is a graph showing comparing optical characteristics of light emitting layers including perovskite crystals prepared at various ratios of CsBr and PbBr₂;

FIG. 4D is an XRD graph of perovskite powders prepared at various ratios of CsBr and PbBr₂;

FIG. 4E is an XRD graph of perovskite light emitting layers prepared at various ratios of CsBr and PbBr₂;

FIG. 4F is an XRD graph of a perovskite light emitting layer prepared using CsBr and PbBr₂ as a double deposition source for perovskite synthesis;

FIG. 4G is an XPS graph of perovskite powders prepared at various ratios of CsBr and PbBr₂;

FIG. 5A is a TGA curve of perovskite powders prepared at various ratios of CsBr and PbBr₂;

FIG. 5B is a TGA curve of a perovskite powder prepared with CsBr, FA (Formamidinium) Br, and PbBr₂, and a perovskite powder prepared with CSBr, MA (Methylammonium) Br and PbBr₂;

FIG. 6A is a graph showing comparing results of a photoluminescence spectrum of a light emitting layer for a light emitting device according to a deposition rate (BzABr rate) of benzylammonium bromide with respect to a single perovskite deposition source having a deposition rate of 1 Å/s, according to a preferred embodiment of the present disclosure;

FIG. 6B is a graph showing comparing results of a UV-vis spectrum of a light emitting layer for a light emitting device according to a deposition rate (BzABr rate) of benzylammonium bromide with respect to a single perovskite deposition source having a deposition rate of 1 Å/s, according to a preferred embodiment of the present disclosure;

FIG. 6C is an SEM image of a light emitting layer for a light emitting device when the deposition rate (BzABr rate) of benzylammonium bromide is 0.2 Å/s with respect to a single perovskite deposition source having a deposition rate of 1 Å/s, according to a preferred embodiment of the present disclosure;

FIG. 6D is an SEM image of a light emitting layer for a light emitting device when the deposition rate (BzABr rate) of benzylammonium bromide is 0.4 Å/s with respect to a single perovskite deposition source having a deposition rate of 1 Å/s, according to a preferred embodiment of the present disclosure;

FIG. 6E is an SEM image of a light emitting layer for a light emitting device when the deposition rate (BzABr rate) of benzylammonium bromide is 0.6 Å/s with respect to a single perovskite deposition source having a deposition rate of 1 Å/s, according to a preferred embodiment of the present disclosure;

FIG. 6F is an SEM image of a light emitting layer for a light emitting device when the deposition rate (BzABr rate) of benzylammonium bromide is 0.8 Å/s with respect to a single perovskite deposition source having a deposition rate of 1 Å/s, according to a preferred embodiment of the present disclosure;

FIG. 6G is an SEM image and grain sizes of a light emitting layer for a light emitting device according to a relative deposition rate (BzABr rate) of benzylammonium bromide with respect to a single perovskite deposition source having a deposition rate of 1 Å/s, according to a preferred embodiment of the present disclosure;

FIG. 7A is a graph showing comparing photoluminescence spectrum results of a light emitting layer for a light emitting device according to a deposition rate of a single perovskite deposition source while a deposition rate ratio of the single perovskite deposition source and benzylammonium bromide is fixed at 1:0.7 in an embodiment of the present disclosure;

FIG. 7B is a graph showing comparing UV-vis spectrum results of a light emitting layer for a light emitting device according to a deposition rate of a single perovskite deposition source while a deposition rate ratio of the single perovskite deposition source and benzylammonium bromide is fixed at 1:0.7 in an embodiment of the present disclosure;

FIG. 7C is an SEM image of a light emitting layer for a light emitting device when the deposition rate of a single perovskite deposition source is 0.4 Å/s, while a deposition rate ratio of the single perovskite deposition source and benzylammonium bromide is fixed at 1:0.7 in an embodiment of the present disclosure;

FIG. 7D is an SEM image of a light emitting layer for a light emitting device when the deposition rate of a single perovskite deposition source is 1.0 Å/s, while a deposition rate ratio of the single perovskite deposition source and benzylammonium bromide is fixed at 1:0.7 in an embodiment of the present disclosure;

FIG. 7E is an SEM image of a light emitting layer for a light emitting device when the deposition rate of a single perovskite deposition source is 1.4 Å/s, while a deposition rate ratio of the single perovskite deposition source and benzylammonium bromide is fixed at 1:0.7 in an embodiment of the present disclosure;

FIG. 8A is a structural diagram of an LED device manufactured using a light emitting layer for a light emitting device deposited through co-deposition of a single perovskite deposition source and benzylammonium bromide, according to a preferred embodiment of the present disclosure;

FIG. 8B is a current density-voltage graph of an LED device manufactured using a light emitting layer for a light emitting device deposited with a single perovskite deposition source and an LED device manufactured using a light emitting layer for a light emitting device deposited through co-deposition of benzyl ammonium bromide and a single perovskite deposition source;

FIG. 8C is a current efficiency-voltage graph of an LED device manufactured using a light emitting layer for a light emitting device deposited with a single perovskite deposition source and an LED device manufactured using a light emitting layer for a light emitting device deposited through co-deposition of benzyl ammonium bromide and a single perovskite deposition source;

FIG. 8D is a luminance-voltage graph of an LED device manufactured using a light emitting layer for a light emitting device deposited with a single perovskite deposition source and an LED device manufactured using a light emitting layer for a light emitting device deposited through co-deposition of benzyl ammonium bromide and a single perovskite deposition source;

FIG. 9 is a schematic cross-sectional view of a perovskite layered structure according to a preferred embodiment of the present disclosure;

FIG. 10 is a schematic cross-sectional view of a non-uniform perovskite thin film formed without a first scaffold layer and/or a second scaffold layer. FIG. 10A is a schematic diagram for a perovskite thin film formed without a first scaffold layer and a second scaffold layer, and FIG. 10B is a schematic diagram of a perovskite thin film formed without a first scaffold layer;

FIG. 11 is a scanning electron microscopy (SEM) image of the morphology of perovskite thin films formed on several materials without a scaffold layer;
(a) of FIG. 12 is a surface potential result of a hole transport layer, (b) of FIG. 12 is a surface potential result when a second scaffold layer is formed on the hole transport layer and (c) of FIG. 12 is a surface potential result when a first scaffold layer and a second scaffold layer are sequentially formed on the hole transport layer;
(a) of FIG. 13 is a surface roughness result of a hole transport layer, (b) of FIG. 12 is a surface roughness result when a second scaffold layer is formed on the hole transport layer and (c) of FIG. 13 is a surface roughness result when a first scaffold layer and a second scaffold layer are sequentially formed on the hole transport layer;

FIG. 14 is a binding energy result for each element when only a first scaffold layer is formed; when only a second scaffold layer is formed, and when both the first scaffold layer and the second scaffold layer are formed. (a) of FIG. 14 is a result for a Li 1s orbital when only the first scaffold layer is formed and when both the first scaffold layer and the second scaffold layer are formed. (b) of FIG. 14 is a result for a P 2p orbital when only the second scaffold layer is formed and when both the first scaffold layer and the second scaffold layer are formed. (c) of FIG. 14 is a result for a O 1s orbital when only the second scaffold layer is formed and when both the first scaffold layer and the second scaffold layer are formed;

FIG. 15 is a surface roughness result of a perovskite thin film. (a) of FIG. 15 is a result when a perovskite thin film is formed on a hole transport layer without a scaffold layer, (b) of FIG. 15 is a result when a second scaffold layer is formed on the hole transport layer and then a perovskite thin film is formed thereon, and (c) of FIG. 15 is a result when both a first scaffold layer and the second scaffold layer are formed on the hole transport layer and then a perovskite thin film is formed thereon;

FIG. 16 is a scanning electron microscopy (SEM) image of the morphology of perovskite thin films according to a scaffold layer. (a) of FIG. 16 is an image when a perovskite thin film is formed on a hole transport layer without a scaffold layer, (b) of FIG. 16 is an image when a second scaffold layer is formed on the hole transport layer and then a perovskite thin film is formed thereon, and (c) of FIG. 16 is an image when both a first scaffold layer and the second scaffold layer are formed on the hole transport layer and then a perovskite thin film is formed thereon. (d), (e) and (f) of FIG. 16 are enlarged images of (a), (b) and (c) of FIG. 16 at a magnification of 10 times, respectively;

FIG. 17 shows results of Grazing Incident Wide Angle X-ray Scattering (GIWAXS) of a perovskite thin film according to a scaffold layer. The upper drawing of (a) of FIG. 17 is a result when forming a perovskite thin film on a hole transport layer without a scaffold layer, and the lower drawing of (a) of FIG. 17 is a Z-direction graph of the upper drawing of (a) of FIG. 17. The upper drawing of (b) of FIG. 17 is a result when forming a second scaffold layer on the hole transport layer and then forming a perovskite thin film thereon, and the lower drawing of (b) of FIG. 17 is a Z-direction graph of the upper drawing of (b) of FIG. 17. The upper drawing of (c) of FIG. 17 is a result when forming a first scaffold layer and a second scaffold layer on the hole transport layer and then forming a perovskite thin film thereon, and the lower drawing of (c) of FIG. 17 is a Z-direction graph of the upper drawing of (c) of FIG. 17;

FIG. 18 is a confocal-hyperspectral photoluminescence (PL) analysis result. (a) of FIG. 18 is a confocal-hyperspectral PL map when a perovskite thin film is formed on a hole transport layer without a scaffold layer, and (d) of FIG. 18 is a PL spectrum extracted and processed from the map of (a) of FIG. 18. (b) of FIG. 18 is a confocal-hyperspectral PL map when a second scaffold layer is formed on the hole transport layer and then a perovskite thin film is formed thereon, and (e) of FIG. 18 is a PL spectrum extracted and processed from the map of (b) of FIG. 18. (c) of FIG. 18 is a confocal-hyperspectral PL map when a first scaffold layer and a second scaffold layer are formed on a hole transport layer and then a perovskite thin film is formed thereon, and (f) of FIG. 18 is a PL spectrum extracted and processed from the map of (c) of FIG. 18;

FIG. 19 is a PL spectral graph of a perovskite thin film according to a scaffold layer;

FIG. 20 is a Transient PL (TrPL) spectral graph of a perovskite thin film according to a scaffold layer;

FIG. 21 is a power dependent PLQY (PDPLQY) graph of a perovskite thin film according to a scaffold layer;
(a) and (b) of FIG. 22 are cross-sectional SEM images and schematic cross-sectional views of a light emitting device as an optoelectronic device according to an embodiment of the present disclosure, respectively, and (c) of FIG. 22 is a schematic cross-sectional view of a solar cell as an optoelectronic device according to an example of the present disclosure;

FIG. 23 is a current density-external quantum efficiency graph of a light emitting device according to a scaffold layer;

FIG. 24 is an electroluminescence spectrum of a light emitting device according to a scaffold layer, in which the spectral FWHM is represented; and

FIG. 25 is a photograph of dry deposition large-area patterning and a flexible (10×10, each active area 4.5 mm×4.5 mm) perovskite light emitting device including a perovskite layered structure according to a preferred embodiment of the present disclosure.

### DETAILED DESCRIPTION OF EMBODIMENTS

Hereinafter, examples of the present disclosure will be described in detail with reference to the accompanying drawings so as to easily implement those with ordinary skill in the art to which the present disclosure pertains. The present disclosure may be implemented in various different forms and is not limited to examples described herein. In the drawings, parts not associated with required description are omitted for clearly describing the present disclosure and like reference numerals designate like elements throughout the specification.

Terms used in the present specification are used only to describe specific examples, and are not intended to limit the present disclosure. A singular expression includes a plural expression unless the context indicates otherwise. In the present application, it should be understood that term “including” or “having” indicates that features, numbers, steps, operations, components or combinations thereof described in the specification is present, but does not exclude a possibility of presence or addition of one or more other features, numbers, steps, operations, components or combinations thereof, in advance.

Unless otherwise contrarily defined, all terms used herein including technological or scientific terms have the same meanings as those generally understood by those skilled in the art. Terms which are defined in a generally used dictionary should be interpreted to have the same meaning as the meaning in the context of the related art, and are not interpreted as ideal or excessively formal meanings unless otherwise defined in the present disclosure.

When it is described that a certain part such as a layer, a film, a region, a substrate, etc., is located “on” another part, it means that the certain part may be located “directly on” the other part and another part may be interposed therebetween. In contrast, when it is described that a certain part is located “directly on” another part, it means that there is no third part therebetween.

### <Perovskite Powder, Light Emitting Layer for Light Emitting Device, and Method for Manufacturing the Same>

Hereinafter, in the present specification, the term “single-source deposition source” does not mean that only one deposition source is used at the time of deposition, but means a deposition source in which a perovskite crystal rather than a perovskite precursor is contained in the deposition source and thus a perovskite thin film may be deposited with only the one deposition source.

As described above, in the related art, when a light emitting layer is manufactured by using a perovskite precursor together as a deposition source in a deposition process and perovskite crystals are formed at the same time, it has been difficult to selectively obtain only a desired crystal phase, it has been difficult to adjust a crystal phase ratio, and there is a problem that a precursor material remains without being synthesized into perovskite.

Accordingly, the present disclosure seeks to solve the problems by providing a method for manufacturing a perovskite powder, which including reacting CsX and BX₂ to manufacture a perovskite powder. As a result, in the related art, unlike a case where a light emitting layer is manufactured by using a perovskite precursor together as a deposition source in a deposition process and perovskite crystals are formed at the same time, a desired crystal phase may be selectively obtained by depositing the light emitting layer using the powder as a single-source deposition source, a ratio of the crystal phases in the light emitting layer may be easily adjusted, and a problem that a precursor material remains in the light emitting layer may be solved.

Specifically, in the method for manufacturing the perovskite powder including reacting CsX and BX₂ to manufacture the perovskite powder, the B described above is a metal ion, preferably the B may be a divalent transition metal ion, a rare earth metal ion, an alkaline earth metal ion, a monovalent metal ion, a trivalent metal ion, or a combination thereof, and more preferably the B may be divalent Pb.

In addition, the X described above is F⁻, Cl⁻, Br⁻, I⁻, SCN⁻, OCN⁻, SeCN⁻, HCO²⁻, CH₃COO, CF₃COO⁻ or a combination thereof, and preferably X may be Br.

Most preferably, CsX may be CsBr and BX₂ may be PbBr₂.

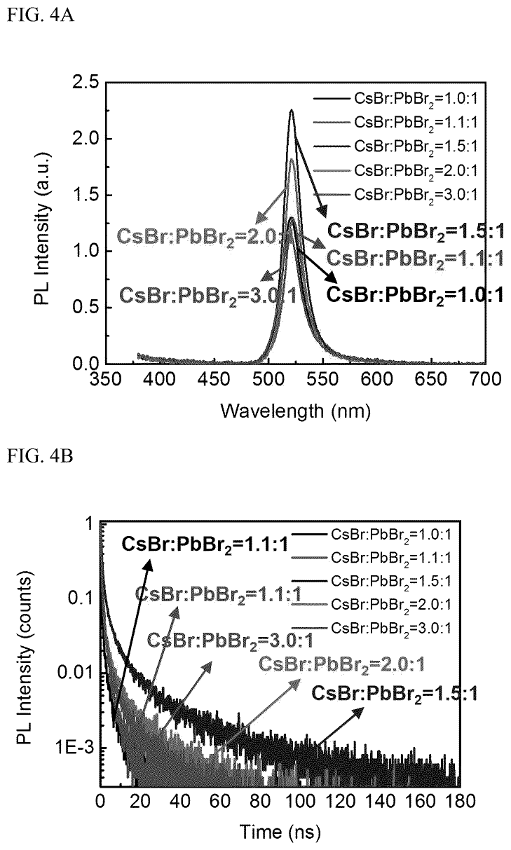

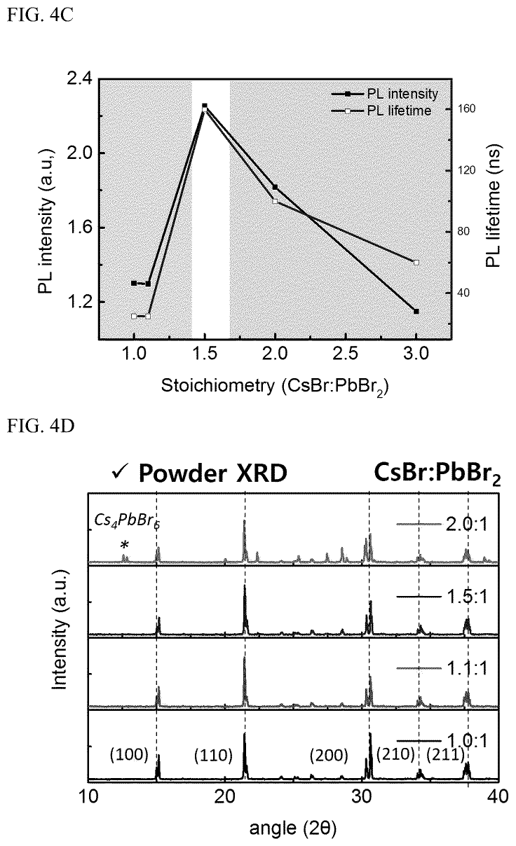

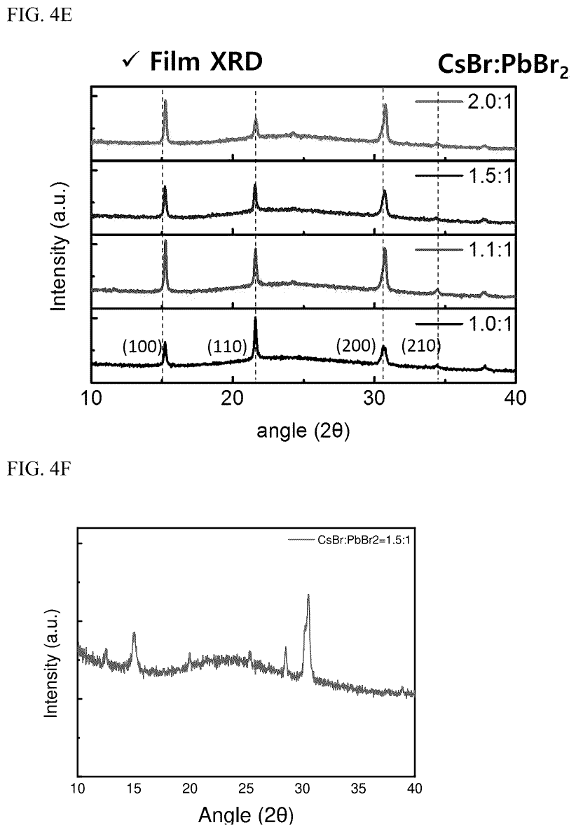

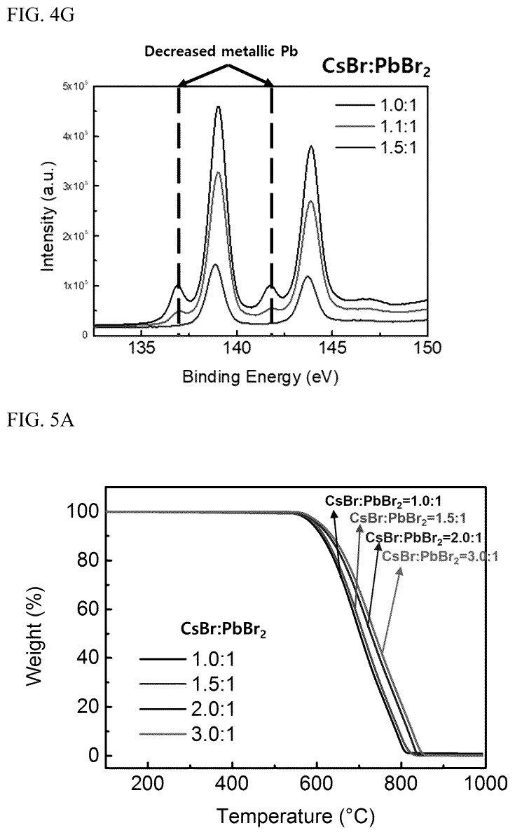

In addition, the molar ratio of the CsX and BX₂ described above is usually sufficient to form a perovskite powder by reacting CsX and BX₂, but may preferably be 1.15:1 to 1.95:1. More preferably, the molar ratio may be 1.3:1 to 1.7:1. Much more preferably, the molar ratio may be 1.5:1 to 1.6:1. Specifically, the molar ratio may be 1:1, 1.05:1, 1.1:1, 1.15:1, 1.2:1, 1.25:1, 1.3:1, 1.35:1, 1.4:1, 1.45:1, 1.5:1, 1.55:1, 1.6:1, 1.65:1, 1.7:1, 1.75:1, 1.8:1, 1.85:1, 1.9:1, 1.95:1, 2:1, 2.05:1, 2.1:1, 2.15:1, 2.2:1, 2.25:1, 2.3:1, 2.35:1, 2.4:1, 2.45:1, 2.5:1, 2.55:1, 2.6:1, 2.65:1, 2.7:1, 2.75:1, 2.8:1, 2.85:1, 2.9:1, 2.95:1 or 3:1. By adjusting the molar ratio as such, a desired 3D perovskite crystal phase may be prepared, and only a desired 3D structure perovskite phase may be present in the light emitting layer deposited with the powder manufactured by adjusting the molar ratio. Referring to FIGS. 4A to 4F, when the molar ratio of CsX is less than 1.15, the grain size of the perovskite powder manufactured by reacting CsX and BX₂ increases, so that an exciton confinement effect is poor, and the amount of metallic B increases, so that exciton disappears due to a quenching phenomenon, and thus the light emission efficiency may decrease. When the molar ratio is more than 1.95, a crystal phase other than the desired crystal phase may be generated so that photoluminescence efficiency may be reduced. In addition, when the molar ratio is 1.3 or more, the grain size of the powder becomes small and the light emission efficiency may be good, and when the molar ratio becomes 1.7 or less, a desired crystal phase is generated and thus the light emission efficiency may be excellent.

On the other hand, in the step of manufacturing the perovskite powder by reacting the CsX and BX₂ described above, A′X may be further reacted when reacting CsX and BX₂. At this time, A′ may be a monovalent organic cation, a monovalent inorganic cation (however, excluding Cs⁺), or a combination thereof. Examples of A′ include (CₓH₂ₓ₊₁NH₃)⁺, (C₆H₅CₓH₂ₓ₊₁NH₃)⁺, (CH(NH₂)₂)⁺, (CₓH₂ₓ(NH₃)₂)⁺ (NH₄)⁺, (NF₄)⁺, (NCl₄)⁺, (N(CₓH₂ₓ₊₁)₄)⁺, ((CₓH₂ₓ₊₁)₂NH₂)⁺, (C₄H₁₀N)⁺, (C₃H₅N₂)⁺, (PH₄)⁺, (PF₄)⁺, (PCl₄)⁺, (C(NH₂)₃)⁺, ((CₓH₂ₓ₊₁)ₙNH₃)₂(CHNH₃)ₙ⁺, (CF₃NH₃)⁺, ((CₓF₂ₓ₊₁)ₙNH₃)₂(CFNH₃)ₙ⁺, ((CₓF₂ₓ₊₁)ₙNH₃)ₙ⁺, (CH₃PH₃)⁺, (CH₃AsH₃)⁺, (CH₃SbH₃)⁺, (AsH₄)⁺ (SbH₄)⁺, alkali metals (however, excluding Cs⁺) (n is an integer of 1 to 100, and x is an integer of from 1 to 100), or a combination thereof. As A′, formamidinium, methylammonium, rubidium, or the like may be added to manufacture a light emitting layer, but the light emitting layer may be deposited without pyrolysis.

X may be F⁻, Cl⁻, Br⁻, I⁻, SCN⁻, OCN⁻, SeCN⁻, HCO²⁻, CH₃COO⁻, CF₃COO⁻ or a combination thereof, and preferably X may be Br.

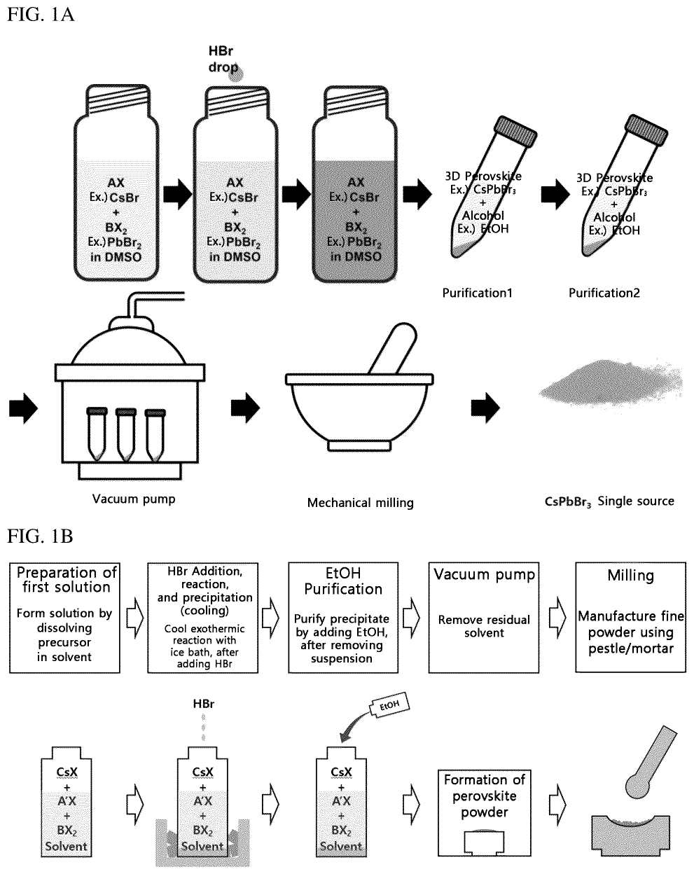

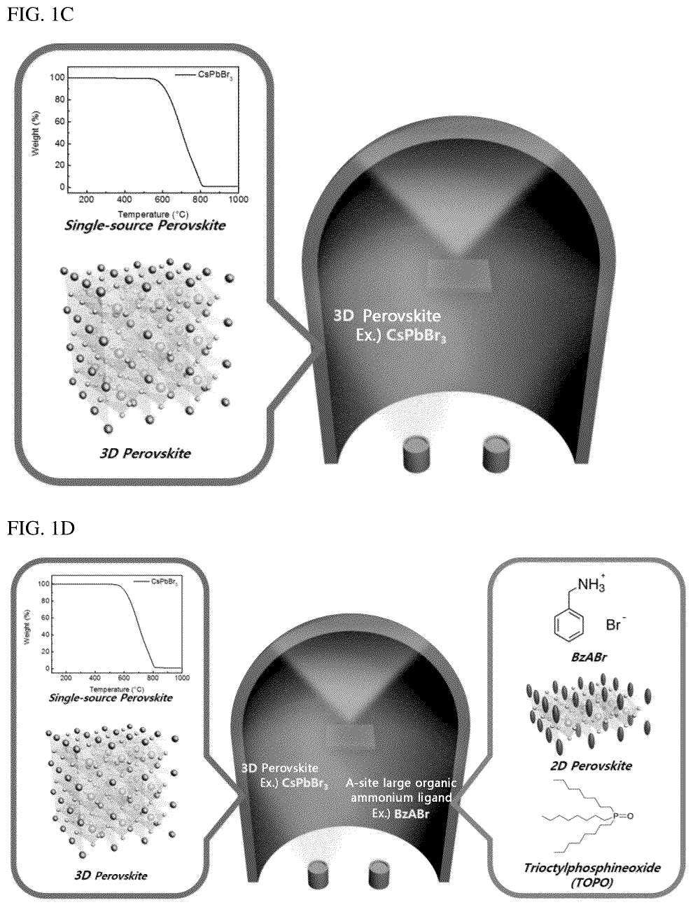

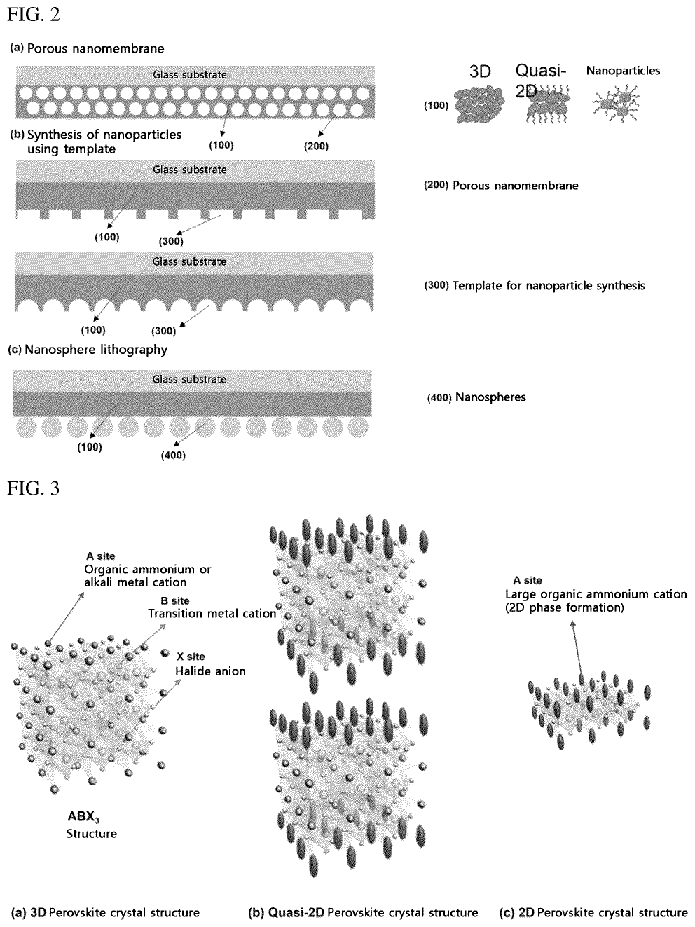

The following will be described with reference to FIGS. 1A and 1B.

The step of manufacturing the perovskite powder described above may include a step (1) of mixing CsX and BX₂ in a solvent to form a first solution, a step (2) of adding HX to the first solution to form a perovskite precursor solution, a step (3) of purifying the perovskite precursor solution, a step (4) of vacuum-treating the purified perovskite precursor solution to form a perovskite material, and a step (5) of mechanically milling the perovskite material to manufacture a perovskite powder.

The solvent of step (1) described above may be used without limitation as long as the solvent is for dissolving the CsX and BX₂, and thus it is not particularly limited in the present disclosure. Preferably, dimethylformamide (DMF), dimethylsulfoxide (DMSO), g-butyrolactone (GBL), N-methyl-2-pyrrolidone (NMP), 2-methoxyethanol and the like may be used. Most preferably, the solvent may be dimethylsulfoxide (DMSO).

In addition, 0.1 to 0.5 mol of each of CsX and BX₂ per 1000 ml of the solvent in step (1) described above may be mixed with the solvent.

The reason for adding HX in the step (2) described above is that when synthesis is performed by precipitating under a condition of excess CsBr, a Cs₄PbBr₆ phase may be generated, and only a CsPbBr₃ light emitting body, which is a desired phase, may be synthesized by using a method of precipitating the Cs₄PbBr₆ phase with HX.

At this time, the solvent of the HX solution may be used without limitation as long as the solvent is for dissolving HX, and therefore, the solvent is not particularly limited in the present disclosure. The solvent may preferably be water.

On the other hand, 500 to 3000 mL of HX may be mixed per 1000 mL of the solvent of the HX solution described above. Preferably, HX may be 500 to 2000 mL. More preferably, HX may be 500 to 1500 mL. Specifically, HX may be 500 ml, 600 ml, 700 ml, 800 ml, 900 ml, 1000 ml, 1100 ml, 1200 ml, 1300 ml, 1400 ml, 1500 ml, 1600 ml, 1700 ml, 1800 ml, 1900 ml, 2000 ml, 2100 ml, 2200 ml, 2300 ml, 2400 ml, 2500 ml, 2600 ml, 2700 ml, 2800 ml, 2900 ml, or 3000 ml.

In addition, the volume ratio of the first solution and the HX solution in step (2) described above may be 1:0.5 to 1:3.

Furthermore, in the HX described above, X may be F⁻, Cl⁻, Br⁻, I⁻, SCN⁻, OCN⁻, SeCN⁻, HCO²⁻, CH₃COO⁻, CF₃COO⁻ or a combination thereof, and preferably the same anion as X in the CsX and BX₂ described above.

Meanwhile, in the step of reacting the first solution containing CsX and BX₂ with HX, a significant amount of heat is generated by an exothermic reaction. Since such heat may result in an increase in crystallites and grains, the present disclosure includes methods for lowering the reaction heat generated during powder synthesis. For example, the methods of lowering the reaction heat include a method of synthesizing a perovskite powder using a low concentration of precursor solution, or a method of continuously cooling reactants during synthesis as a method for reducing the heat generated during the reaction.

The purifying of the precursor solution in step (3) described above may be used without limitation as long as the method is a purification method commonly used in the art, and thus is not particularly limited in the present disclosure. Preferably, the method may be a method of removing unreacted CsBr and PbBr₂ by purifying the precipitated perovskite precipitate with ethanol (EtOH) twice or more in a volume corresponding to a 1:1 volume ratio to the original precursor solution.

In step (4) described above, the vacuum-treating may be performed by removing a volatile material contained in the precursor solution described above to form a targeting perovskite material. Preferably, the vacuum-treating may be a method of removing all of the remaining solvent of the powder in a vacuum desiccator.

The mechanical milling in step (5) described above may mean cutting the perovskite material to form particles having smaller sizes. The mechanical milling may be performed using a conventional milling apparatus.

A similar method to the method for manufacturing the perovskite powder described above has been introduced in the journal ACS Omega 2019, 4, 8081-8086, but is not suitable as a source for manufacturing a light emitting body having a crystallite size of 110 nm or more. This is because the perovskite precursor reacted at a high concentration (0.63 M or about 0.6 M or more) and was synthesized with a large amount of heat.

The present disclosure includes a method for manufacturing a powder having smaller and more uniform crystals more suitable as a light emitting body by controlling the perovskite precursor to a low concentration (about 0.2 M or less) so as to reduce heat generation and minimize reaction heat generated during precipitation through a cooling technique of a reaction vessel using an ice bath.

In the comparison between the journal and the present disclosure, the crystallite size is obtained through Scherrer equation for analysis after measuring X-ray diffraction, and the Scherrer equation is as follows.

$$D = \frac{K λ}{β cos θ} \qquad Scherrer equation$$

In the Scherrer equation, D denotes a crystallite size, K denotes a shape coefficient, λ denotes an X-ray wavelength, β denotes a full width at half maximum (FWHM) of a maximum intensity peak, and θ denotes an X-ray incident angle. The crystal size obtained through the Scherrer equation is a crystallite size. The present disclosure showed a smaller crystallite size compared to the literature ACS Omega, 2019, 4, 8081-8086, as shown in the following table. Table 1 below shows a crystallite size of the perovskite powder of the present disclosure according to a Cs/Pb ratio.

TABLE 1

| | ACS Omega, 2019, | Present | Present | Present |
|---|---|---|---|---|
| | 4, 8081-8086 | disclosure | disclosure | disclosure |
| Cs/Pb ratio | 1.0 | 1.0 | 1.1 | 1.5 |
| Crystallite size | 117.12 | 73.46 | 70.77 | 70.55 |
| [nm] | | | | |

The crystallite size obtained through the Scherrer equation may be 110 nm or less, preferably less than 110 nm and 5 nm or more, and more preferably less than 100 nm and 30 nm or more. The crystallite size may be even more preferably less than 90 nm and 50 nm or more. More specifically, the crystallite size of the powder may be 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, 31 nm, 32 nm, 33 nm, 34 nm, 35 nm, 36 nm, 37 nm, 38 nm, 39 nm, 40 nm, 41 nm, 42 nm, 43 nm, 44 nm, 45 nm, 46 nm, 47 nm, 48 nm, 49 nm, 50 nm, 51 nm, 52 nm, 53 nm, 54 nm, 55 nm, 56 nm, 57 nm, 58 nm, 59 nm, 60 nm, 61 nm, 62 nm, 63 nm, 64 nm, 65 nm, 66 nm, 67 nm, 68 nm, 69 nm, 70 nm, 71 nm, 72 nm, 73 nm, 74 nm, 75 nm, 76 nm, 77 nm, 78 nm, 79 nm, 80 nm, 81 nm, 82 nm, 83 nm, 84 nm, 85 nm, 86 nm, 87 nm, 88 nm, 89 nm, 90 nm, 91 nm, 92 nm, 93 nm, 94 nm, 95 nm, 96 nm, 97 nm, 98 nm, 99 nm, 100 nm, 101 nm, 102 nm, 103 nm, 104 nm, 105 nm, 106 nm, 107 nm, 108 nm, 109 nm, or 110 nm, and the range of the crystallite sizes of the powder may range from a minimum value of a small number to a maximum value of a large number among two numbers selected from the crystallite sizes of the powder.

When the crystallite size is more than 110 nm, it is difficult to form a uniform thin film when deposition is performed using a single source, and the light emission efficiency of the obtained thin film may be lowered. In addition, when the crystallite size is 5 nm or less, cooling is required in order to terminate many reactions, but the crystal size is non-uniform, and the surface increases due to the small crystal size, so that powder with many defects may be manufactured, thereby lowering the light emission efficiency of the obtained thin film. In addition, color control may be difficult due to non-uniform crystal sizes.

The perovskite powder manufactured in the step of manufacturing the perovskite powder described above may be Cs₁₋ₐA′ₐBX₃ crystals. At this time, A′ may be a monovalent organic cation, a monovalent inorganic cation (however, excluding Cs⁺), or a combination thereof. Examples of A′ include (CₓH₂ₓ₊₁NH₃)⁺, (C₆H₅CₓH₂ₓ₊₁NH₃)⁺, (CH(NH₂)₂)⁺, (CₓH₂ₓ(NH₃)₂)⁺ (NH₄)⁺, (NF₄)⁺, (NCl₄)⁺, (N(CₓH₂ₓ₊₁)₄)⁺, ((CₓH₂ₓ₊₁)₂NH₂)⁺, (C₄H₁₀N)⁺, (C₃H₅N₂)⁺, (PH₄)⁺, (PF₄)⁺, (PCl₄)⁺, (C(NH₂)₃)⁺, ((CₓH₂ₓ₊₁)ₙNH₃)₂(CHNH₃)ₙ⁺, (CF₃NH₃)⁺, ((CₓF₂ₓ₊₁)ₙNH₃)₂(CFNH₃)ₙ⁺, ((CₓF₂ₓ₊₁)ₙNH₃)ₙ⁺, (CH₃PH₃)⁺, (CH₃AsH₃)⁺, (CH₃SbH₃)⁺, (AsH₄)⁺, (SbH₄)⁺, alkali metals (however, excluding Cs⁺) (n is an integer of 1 to 100, and x is an integer of from 1 to 100), or a combination thereof. As A′, formamidinium, methylammonium, rubidium, or the like may be added to manufacture a light emitting layer, but may be deposited as the light emitting layer without pyrolysis.

In addition, B is a metal ion, preferably B may be a divalent transition metal ion, a rare earth metal ion, an alkaline earth metal ion, a monovalent metal ion, a trivalent metal ion, or a combination thereof, and more preferably B may be divalent Pb.

In addition, X may be F⁻, Cl⁻, Br⁻, I⁻, SCN⁻, OCN⁻, SeCN⁻, HCO²⁻, CH₃COO⁻, CF₃COO⁻ or a combination thereof, and preferably X may be Br. Furthermore, a may be 0 to 0.9, more specifically 0, 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9.

Referring to FIG. 3, the Cs₁₋ₐA′ₐBX₃ crystal described above corresponds to a 3D perovskite crystal. The 3D perovskite crystal performs a function of emitting light and has good electrical conductivity, which is advantageous in terms of charge transport.

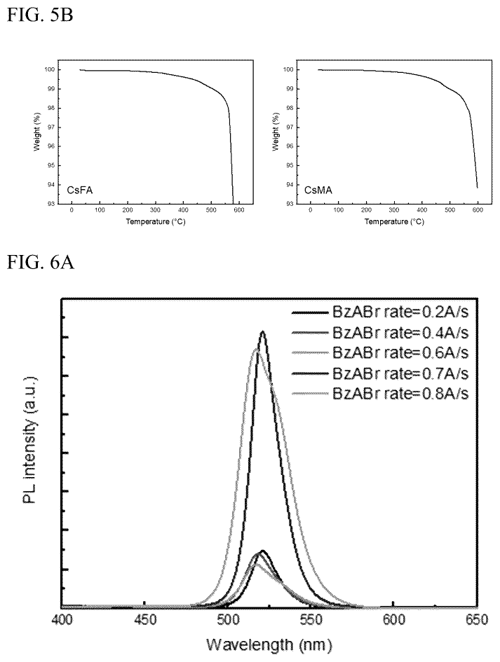

The Cs₁₋ₐA′ₐBX₃ crystal described above may be a CsPbBr₃ crystal without A′. Referring to FIG. 5, the CsPbBr₃ crystal has a pyrolysis temperature of 580° C. or higher, and may be stably deposited without being pyrolyzed even in a thermal deposition process.

The perovskite powder described above may be used for deposition of the light emitting layer. This may be seen through FIGS. 1C and 1D.

When the light emitting layer is deposited through the perovskite powder described above, large-area manufacturing is easy, a uniform light emitting layer may be formed, and the thickness of the light emitting layer may be easily adjusted, as compared with a case where the light emitting layer is manufactured by a solution process such as a spin process and the like. In addition, there is an advantage that it is possible to improve the pixel definition for application to a large-area display, and patterning is enabled by using a mask.

In addition, the perovskite powder manufactured by the manufacturing method includes perovskite crystals, and may be used as a single perovskite deposition source when the light emitting layer is deposited. Thus, a desired crystal phase may be selectively obtained, the ratio of crystal phases in the light emitting layer may be easily adjusted, and a problem that the precursor material remains in the light emitting layer may be solved.

In addition, the deposition powder for the light emitting layer manufactured by the manufacturing method described above may be deposited without pyrolysis even through the deposition powder is manufactured by adding various A-site cations such as formamidinium, methylammonium, and rubidium.

In order to solve the second object described above, there is provided a perovskite powder having a CsBX₃ structure with a crystallite size of 110 nm or less, in which the powder has peaks at 14˜16°, 20˜22°, 30˜31°, 33˜35°, and 37˜38° without peaks at 11˜14°, which are 20 values in an XRD graph.

The B is a metal ion, preferably B may be a divalent transition metal ion, a rare earth metal ion, an alkaline earth metal ion, a monovalent metal ion, a trivalent metal ion, or a combination thereof, and more preferably B may be divalent Pb.

The X described above is F, Cl, Br⁻, I, SCN⁻, OCN⁻, SeCN⁻, HCO²⁻, CH₃COO⁻, CF₃COO⁻ or a combination thereof, and preferably X may be Br⁻.

The crystallite size of the powder is measured by X-ray diffraction and then obtained using Scherrer equation (D=Kλ/β cos θ), and in the Scherrer equation, D represents a crystallite size, K represents a shape factor, λ represents an X-ray wavelength, β represents a full width at half maximum (FWHM) of a maximum intensity peak, and 0 represents an X-ray incident angle.

When the crystallite size is more than 110 nm, it is difficult to form a uniform thin film when the powder is deposited using a single source, and the light emission efficiency of the obtained thin film may be lowered.

When the 20 values of the powder in the XRD graph have the peaks described above, the powder has a CsPbBr₃ crystal phase and does not have a Cs₄PbBr₆ crystal phase, so that vulnerability to moisture may be solved, and charge injection may be smoothly performed in a LED device, so that the light emitting layer deposited with the powder described above may have excellent light emission efficiency.

In addition, the perovskite powder described above may be manufactured into a perovskite powder having a CsBX₃ structure by adding and reacting an HX solution (H is hydrogen) to a solution in which the CsX and BX₂ precursors are dissolved. The HX solution is as described above, and thus specific details thereof will be omitted.

In addition, the molar ratio of the CsX and BX₂ may be 1.15:1 to 1.95:1. When the molar ratio of CsX is less than 1.15, the grain size in the perovskite powder manufactured by reacting CsX and BX₂ increases, so that an exciton confinement effect is poor, and the amount of metallic B increases, so that exciton disappears due to a quenching phenomenon, and thus the light emission efficiency may decrease. When the molar ratio is more than 1.95, a crystal phase other than the desired crystal phase may be generated so that photoluminescence efficiency may be reduced.

In addition, in the case of manufacturing the powder described above, A′X may be further added and reacted. At this time, the specific details of A′ and X are as described above, and thus will be omitted.

In addition, the powder described above may not have peaks at binding energy of 136 to 138 eV and 141 to 142 eV in the XPS graph, and may have peaks at binding energy of 138 to 140 eV and 143 to 145 eV. If the peaks appear at binding energy 136 to 138 eV and 141 to 142 eV, the metallic B form will be present and the exciton disappears due to a quenching phenomenon by the metallic B to reduce the light emission efficiency.

In order to solve the object described above, there is provided a perovskite powder containing a powder containing Cs₁₋ₐA′ₐBX₃ crystals.

At this time, A′ may be a monovalent organic cation, a monovalent inorganic cation (however, excluding Cs⁺), or a combination thereof. Examples of A′ include (CₓH₂ₓ₊₁NH₃)⁺, (C₆H₅CₓH₂ₓ₊₁NH₃)⁺, (CH(NH₂)₂)⁺, (CH₂ₓ(NH₃)₂)⁺ (NH₄)⁺, (NF₄)⁺, (NCl₄)⁺, (N(C×H₂ₓ₊₁)₄)⁺, ((CₓH₂ₓ₊₁)₂NH₂)⁺, (C₄H₁₀N)⁺, (C₃H₅N₂)⁺, (PH₄)⁺, (PF₄)⁺, (PCl₄)⁺, (C(NH₂)₃)⁺, ((CₓH₂ₓ₊₁)ₙNH₃)₂(CHNH₃)ₙ⁺, (CF₃NH₃)⁺, ((CₓF₂ₓ₊₁)ₙNH₃)₂(CFNH₃)ₙ⁺, ((CₓF₂ₓ₊₁)ₙNH₃)ₙ⁺, (CH₃PH₃)⁺, (CH₃AsH₃)⁺, (CH₃SbH₃)⁺, (AsH₄)⁺, (SbH₄)⁺, alkali metals (however, excluding Cs⁺) (n is an integer of 1 to 100, and x is an integer of from 1 to 100), or a combination thereof. As A′, formamidinium, methylammonium, rubidium, or the like may be added to manufacture a light emitting layer, but may be deposited as the light emitting layer without pyrolysis.

In addition, B is a metal ion, preferably B may be a divalent transition metal ion, a rare earth metal ion, an alkaline earth metal ion, a monovalent metal ion, a trivalent metal ion, or a combination thereof, and more preferably B may be divalent Pb.

In addition, X may be F⁻, Cl⁻, Br⁻, I⁻, SCN⁻, OCN⁻, SeCN⁻, HCO²⁻, CH₃COO⁻, CF₃COO⁻ or a combination thereof, and preferably X may be Br⁻.

Furthermore, a may be 0 to 0.9, more specifically 0, 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9.

Most preferably, since A′ is not present, the Cs₁₋ₐA′ₐBX₃ crystal may be CsPbBr₃.

Referring to FIG. 4F, the perovskite powder in which B is Pb²⁺ and X is Br⁻ may not have peaks at binding energy of 136 to 138 eV and 141 to 142 eV in the XPS graph, and may have peaks at binding energy of 138 to 140 eV and 143 to 145 eV. Specifically, the perovskite powder manufactured in which B is Pb²⁺, X is Br⁻, and the molar ratio of CsX and BX₂ is 1.3:1 to 1.7:1 may not have peaks at binding energy or 136 to 138 eV and 141 to 142 eV in the XPS graph, and may have peaks at binding energy of 138 to 140 eV and 143 to 145 eV. If the peaks appear at binding energy 136 to 138 eV and 141 to 142 eV, the metallic B form is present and the exciton disappears due to a quenching phenomenon by the metallic B to reduce the light emission efficiency.

Referring to FIG. 4D, the perovskite powder in which B is Pb²⁺ and X is Br⁻ may have peaks at 14˜16°, 20˜22°, 30˜31°, 33˜35°, and 37˜38° without peaks at 11 to 14° as the 20 values in the XRD graph. Specifically, the perovskite powder manufactured in which B is Pb²⁺ and X is Br, and the molar ratio of CsX and BX₂ is 1.3:1 to 1.7:1 may have peaks at 14˜16°, 20˜22°, 30˜31°, 33˜35°, and 37˜38° without peaks at 11 to 14° as the 20 values in the XRD graph. If having these peaks, the perovskite powder has a CsPbBr₃ crystal phase and does not have a Cs₄PbBr₆ crystal phase, so that vulnerability to moisture may be solved, and charge injection may be smoothly performed in a LED device, so that the light emitting layer deposited with the powder described above may have excellent light emission efficiency.

On the other hand, the powder described above may be a single crystal bulk powder or a polycrystalline bulk powder, and preferably may be a polycrystalline bulk powder.

Further, since the powder described above includes perovskite crystals, the powder may be used as a single perovskite deposition source (single-source deposition source) when the light emitting layer is deposited. Thus, a desired crystal phase may be selectively obtained, the ratio of crystal phases in the light emitting layer may be easily adjusted, and a problem that the precursor material remains in the light emitting layer may be solved. In addition, the powder manufactured by the manufacturing method may be deposited without pyrolysis even through the powder is manufactured by adding various A-site cations such as formamidinium, methylammonium, and rubidium.

In order to solve the object, there is provided a method for manufacturing a light emitting layer for a light emitting device, including: depositing a perovskite powder containing Cs₁₋ₐA′ₐBX₃ crystals as a single-source deposition source to manufacture a light emitting layer.

At this time, A′ may be a monovalent organic cation, a monovalent inorganic cation (however, excluding Cs⁺), or a combination thereof. Examples of A′ include (CₓH₂ₓ₊₁NH₃)⁺, (C₆H₅CₓH₂ₓ₊₁NH₃)⁺, (CH(NH₂)₂)⁺, (CₓH₂ₓ(NH₃)₂)⁺ (NH₄)⁺, (NF₄)⁺, (NCl₄)⁺, (N(CₓH₂ₓ₊₁)₄)⁺, ((CₓH₂ₓ₊₁)₂NH₂)⁺, (C₄H₁₀N)⁺, (C₃H₅N₂)⁺, (PH₄)⁺, (PF₄)⁺, (PCl₄)⁺, (C(NH₂)₃)⁺, ((CₓH₂ₓ₊₁)ₙNH₃)₂(CHNH₃)ₙ⁺, (CF₃NH₃)⁺, ((CₓF₂ₓ₊₁)ₙNH₃)₂(CFNH₃) n*, ((CₓF₂ₓ₊₁)ₙNH₃) n*, (CH₃PH₃)⁺, (CH₃AsH₃)⁺, (CH₃SbH₃)⁺, (AsH₄)⁺, (SbH₄)⁺, alkali metals (however, excluding Cs⁺) (n is an integer of 1 to 100, and x is an integer of from 1 to 100), or a combination thereof. As A′, formamidinium, methylammonium, rubidium, or the like may be added to manufacture a light emitting layer, but the light emitting layer may be deposited without pyrolysis.

In addition, B is a metal ion, preferably B may be a divalent transition metal ion, a rare earth metal ion, an alkaline earth metal ion, a monovalent metal ion, a trivalent metal ion, or a combination thereof, and more preferably B may be divalent Pb.

In addition, X may be F⁻, Cl⁻, Br⁻, I⁻, SCN⁻, OCN⁻, SeCN⁻, HCO²⁻, CH₃COO⁻, CF₃COO⁻ or a combination thereof, and preferably X may be Br⁻.

Furthermore, a may be 0 to 0.9. More specifically, a may be 0, 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9.

Most preferably, since A′ is not present, the Cs₁₋ₐA′ₐBX₃ crystal may be CsPbBr₃.

According to the present disclosure, the step of manufacturing the light emitting layer described above may be a step of manufacturing a light emitting layer for a light emitting device by using a perovskite powder containing Cs₁₋ₐA′ₐBX₃ crystals as a single-source deposition source, performing vapor deposition by applying heat in a high vacuum state of 10-5 torr or less, and forming a thin film through the vapor deposition.

In other words, the method for manufacturing the light emitting layer for the light emitting device of the present disclosure may be a method for manufacturing a light emitting layer for a light emitting device, including: manufacturing a light emitting layer for a light emitting device by using a perovskite powder containing a Cs₁₋ₐA′ₐBX₃ crystal as a single source deposition source, performing vapor deposition by applying heat in a high vacuum state of 105 torr or less, and forming a thin film through the vapor deposition, in which the A′ is a monovalent organic cation, a monovalent inorganic cation excluding Cs⁺, or a combination thereof, the B is a metal ion, the X is F, Cl, Br, I, SCN, OCN, SeCN⁻, HCO²⁻, CH₃COO⁻, CF₃COO⁻ or a combination thereof, and the a is 0 to 0.9.

When the light emitting layer for the light emitting device described above is formed through the deposition, large-area manufacturing is easy, a uniform light emitting layer may be formed, and the thickness of the light emitting layer may be easily adjusted, as compared with a case of manufacturing a light emitting layer by a solution process such as a spin process and the like. In addition, there is an advantage that it is possible to improve the pixel definition for application to a large-area display, and patterning is enabled by using a mask, so that the limitation of the light emitting layer based on an existing solution process may be overcome.

The deposition described above may be performed by a conventional deposition method, and specifically, may be performed by any one or more methods selected from evaporation, thermal deposition, flash deposition, laser deposition, chemical vapor deposition, atomic layer deposition, and physical vapor deposition.

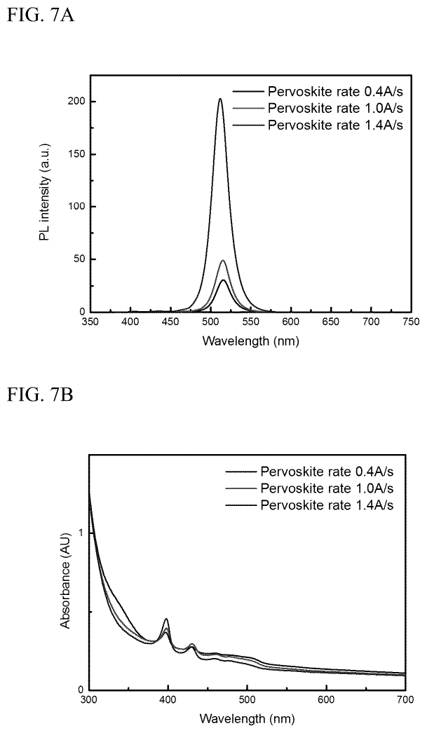

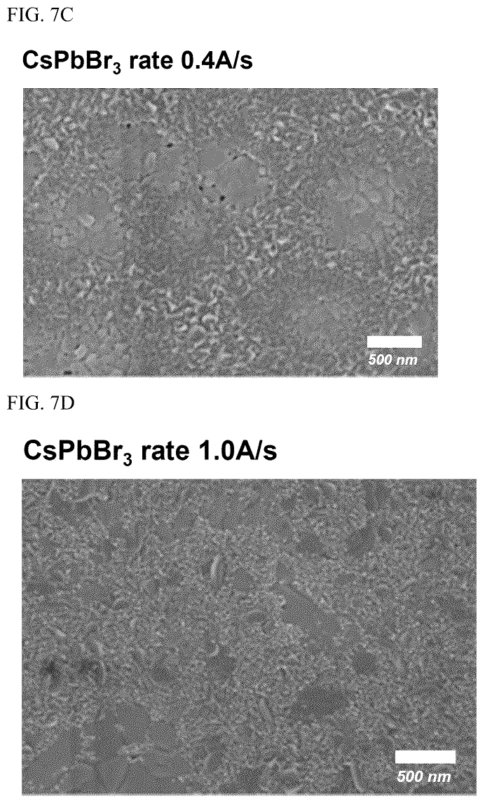

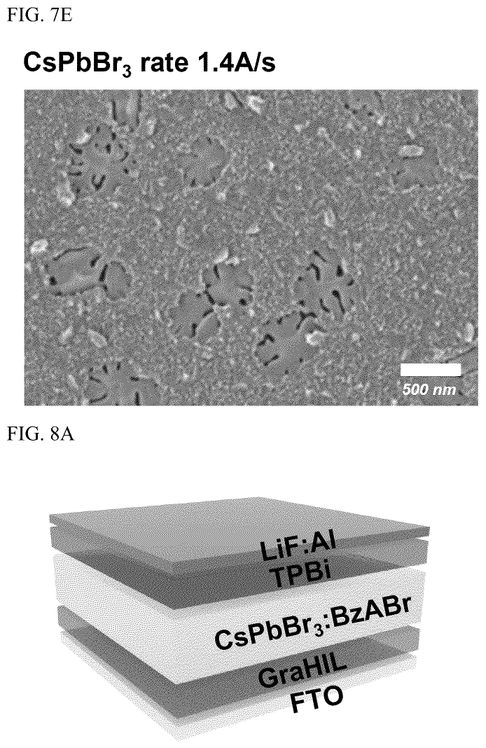

Referring to FIGS. 7A to 7E, the deposition rate of the single-source deposition source may be 0.1 to 2.0 Å/s, preferably 0.5 to 1.5 Å/s and more preferably 0.7 to 1.2 Å/s. More specifically, the deposition rate may be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9 or 2.0 Å/s.

By adjusting the deposition rate, it is possible to further improve the light emitting characteristics of the light emitting layer and to easily adjust the thickness of perovskite. When the deposition rate is less than 0.7 Å/s, an aggregation phenomenon of BzABr increases, and the light emission efficiency of the perovskite light emitting body decreases. On the other hand, when the deposition rate exceeds 1.2 Å/s, there are many pores in the light emitting layer, which may be a passage through which light emission loss may occur in an LED device.

The deposition described above may be co-depositing a compound containing cations having an ionic radius larger than the ionic radius of Cs in order to substitute part or all of the Cs.

The compound containing the above-mentioned cation may preferably be an organic cation compound, and more preferably an organic ammonium cation compound. Specifically, the organic ammonium cation compound may be phenylammonium, benzylammonium, phenylethylammonium, phenylbutylammonium, 1-naphthylmethylammonium, 2-phenoxyethylamine, butylammonium, 4-ammonium butyric acid, and methylenediammonium. Much more preferably, the organic ammonium cation compound may be an organic ammonium halide compound, even more preferably an aromatic ammonium halide, even more preferably a benzylammonium halide compound, and most preferably a benzyl ammonium bromide (BzABr) compound. The aromatic ammonium halide has a benzene ring, and may be substituted with some or all of Cs ions through a self-assembly effect in the co-deposition process. Specifically, a benzene group may be attached to the surface of the perovskite crystal to induce a self-assembly effect through van der Walls interaction. A 2D phase or a quasi-2D phase may be induced through the self-assembly effect, and the light emission efficiency is increased through an exciton quantum confinement effect.

In addition, the compound containing the cations described above is not a perovskite deposition source. That is, in the present disclosure, the perovskite deposition source is only the perovskite powder described above, and the perovskite powder serves as a single-source deposition source. As a result, it is easy to adjust a crystal phase ratio in the light emitting layer, and it is possible to solve the problem that the precursor material remains in the light emitting layer. In addition, the deposition powder for the light emitting layer manufactured by the manufacturing method described above may be deposited without pyrolysis even through the deposition powder is manufactured by adding various A-site cations such as formamidinium, methylammonium, and rubidium.

Next, the co-deposition will be described.

The co-deposition described above is also referred to as co-deposition and may mean simultaneously depositing all precursors. Specifically, for example, the deposition method may be selected from the group consisting of evaporation, thermal deposition, flash deposition, laser deposition, chemical vapor deposition, atomic layer deposition, physical vapor deposition, physical-chemical co-evaporation deposition, sequential vapor deposition, and solution process-assisted thermal deposition. Preferably, physical-chemical co-evaporation deposition or sequential vapor deposition may be used, and more preferably, physical-chemical co-evaporation deposition may be used.

Through the co-deposition described above, Cs cations in the 3D structural perovskite included in the powder may be replaced with cations having an ionic radius larger than the ionic radius of Cs, thereby forming a quasi-2D structure perovskite crystal. The quasi-2D structure was shown in FIG. 3. In the quasi-2D structure perovskite crystal, a 3D structure having excellent charge injection and transport due to good electrical conductivity is integrated with a 2D structure capable of facilitating an exciton confinement effect, so that the exciton confinement effect in the light emitting layer is increased, charge injection is smooth, energy funneling is efficient, and light emission efficiency and light emission intensity are excellent.

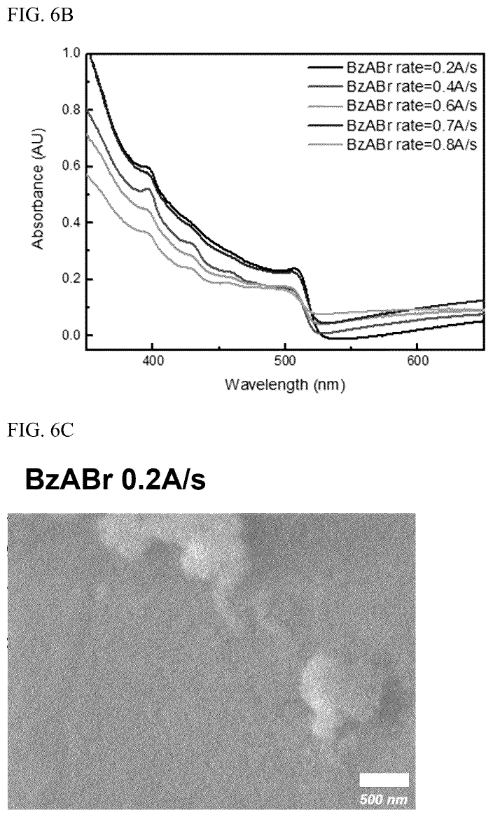

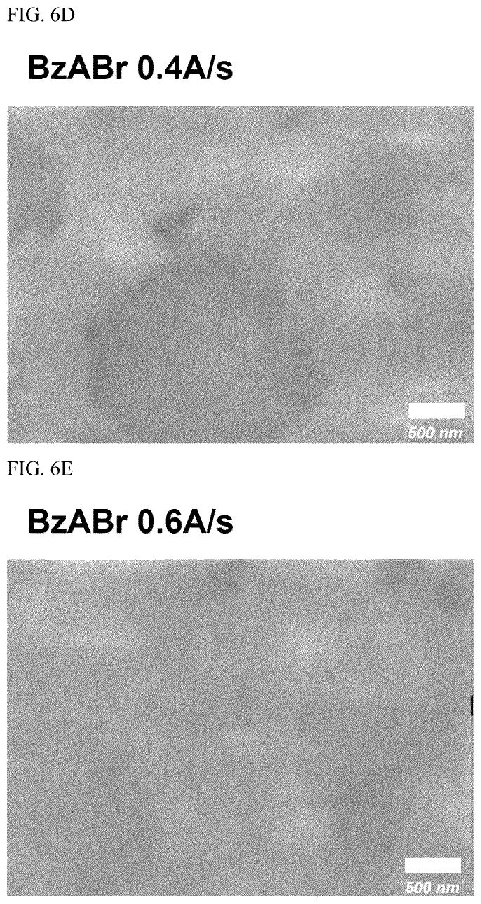

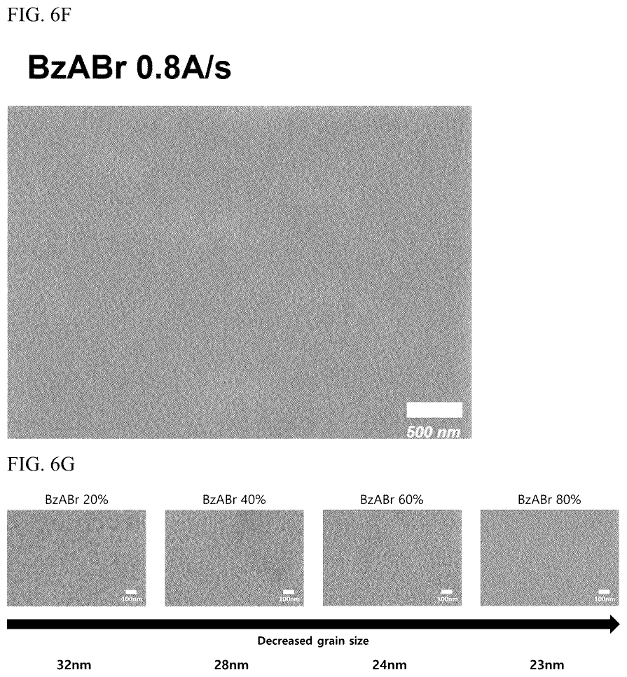

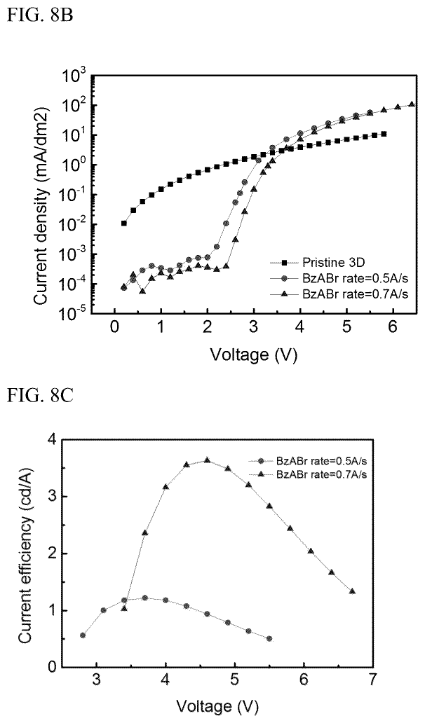

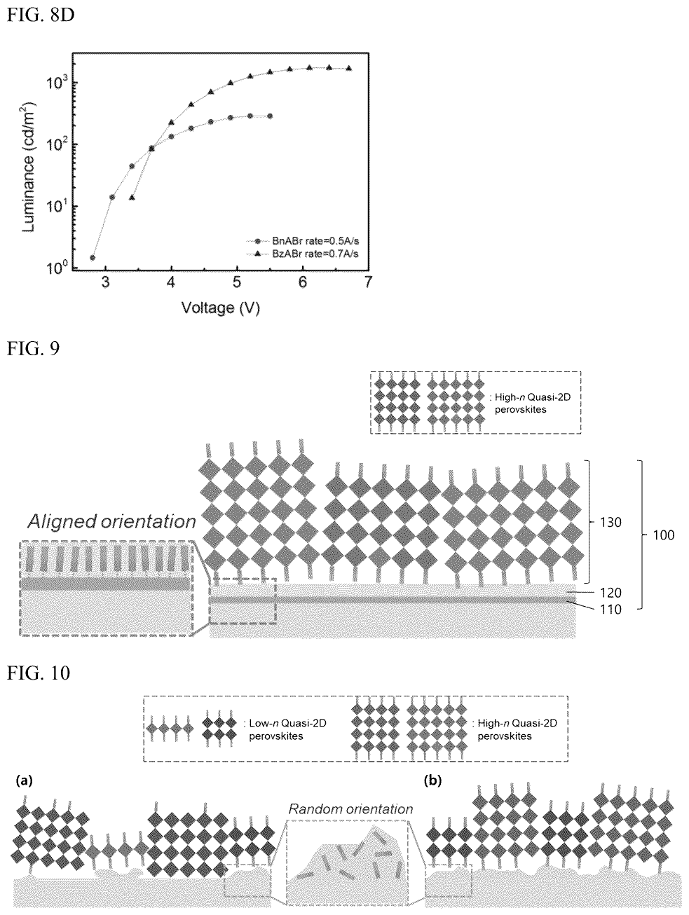

Referring to FIGS. 6A to 6F and 8B to 8D, according to a preferred embodiment of the present disclosure, the deposition rate ratio of the single-source deposition source and the deposition source containing the compound in the co-deposition may be 1:0.05 to 1:1, preferably 1:0.2 to 1:0.85, and more preferably 1:0.65 to 1:0.85. More specifically, the deposition rate ratio may be 1:0.05, 1:0.1, 1:0.15, 1:0.2, 1:0.25, 1:0.3, 1:0.35, 1:0.4, 1:0.45, 1:0.5, 1:0.55, 1:0.6, 1:0.65, 1:0.7, 1:0.75, 1:0.8, 1:0.85, 1:0.9, 1:0.95 or 1:1. By adjusting the deposition rate ratio, an addition ratio of the perovskite material and the compound may be adjusted, thereby effectively adjusting a ratio of quasi-2D structure crystals in the light emitting layer. If the deposition rate ratio of the deposition source including the compound is less than 0.65, sufficient quasi-2D structure perovskite crystals may not be formed and the surface of the light emitting layer may become non-uniform. If the deposition rate ratio exceeds 0.85, there may be a problem of reduction in photoluminescence efficiency along with aggregation of the deposition source including the compound in an excessive amount.

Further, the deposition rate of the single-source deposition source may be 0.1 to 2.0 Å/s, preferably 0.5 to 1.5 Å/s and more preferably 0.7 to 1.2 Å/s. More specifically, when the deposition rate is 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0 Å/s, and the deposition rate ratio of the single-source deposition source and the deposition source containing the compound described above is 1:0.65 to 1:0.85, the co-deposited light emitting layer has a uniform surface and quasi-2D structure perovskite crystals having an appropriate crystal size, so that the light emission efficiency may be very excellent.

Referring to FIG. 2, the light emitting layer for the light emitting device manufactured through the step of manufacturing the light emitting layer described above may be applied with a patterning method such as nanoparticle synthesis using a porous nanomembrane or a template or nanosphere lithography. By applying co-deposition on a porous material having a regular arrangement of nano-sizes, there is an effect of strengthening exciton confinement as the size of 3D grain, quasi-2D grain, or quantum dot decreases.

When introducing the method into the deposition process, it is advantageous in patterning, and it is possible to realize nano-sized grains or quantum dots regardless of a phase of perovskite.

In addition, the thickness of the light emitting layer described above may be 10 to 300 nm, and specifically may be 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 105 nm, 110 nm, 115 nm, 120 nm, 125 nm, 130 nm, 135 nm, 140 nm, 145 nm, 150 nm, 155 nm, 160 nm, 165 nm, 170 nm, 175 nm, 180 nm, 185 nm, 190 nm, 195 nm, 200 nm, 215 nm, 210 nm, 215 nanometers, 220 nm, 225 nm, 230 nm, 235 nm, 240 nm, 245 nm, 250 nm, 255 nm, 260 nm, 265 nm, 270 nm, 275 nm, 280 nm, 285 nm, 290 nm, 295 nm, or 300 nm. If the thickness is less than 10 nm, a passage through which current leakage occurs in the light emitting device may be generated because the entire substrate is not covered due to island growth, and in a thin film of more than 300 nm which is too thick, there may be a problem that the light emission efficiency is drastically lowered due to reabsorption of excitons.

In order to solve the problem, there is provided a light emitting layer for a light emitting device manufactured by the method for manufacturing the light emitting layer for the light emitting device described above.

In order to solve the problem, there is provided a light emitting layer for a light emitting device including Cs₁₋ₐA′ₐBX₃ crystals and/or A″₂(Cs₁₋ₐA′ₐ)ₘ₋₁BₘX₃ₘ₊₁ crystals inside the light emitting layer. At this time, A′ may be a monovalent organic cation, a monovalent inorganic cation (however, Examples of A′ include ((CₓH₂ₓ₊₁NH₃)⁺, excluding Cs⁺), or a combination thereof. (C₆H₅CₓH₂ₓ₊₁NH₃)⁺, (CH(NH₂)₂)⁺, (CₓH₂ₓ(NH₃)₂)⁺ (NH₄)⁺, (NF₄)⁺, (NCl₄)⁺, (N(CₓH₂ₓ₊₁)₄)⁺, ((CₓH₂ₓ₊₁)₂NH₂)⁺, (C₄H₁₀N)⁺, (C₃H₅N₂)⁺, (PH₄)⁺, (PF₄)⁺, (PCl₄)⁺, (C(NH₂)₃)⁺, ((CₓH₂ₓ₊₁)ₙNH₃)₂(CHNH₃)ₙ⁺, (CF₃NH₃)⁺, ((CₓF₂ₓ₊₁)ₙNH₃)₂(CFNH₃)ₙ⁺, ((CₓF₂ₓ₊₁)ₙNH₃)ₙ⁺, (CH₃PH₃)⁺, (CH₃AsH₃)⁺, (CH₃SbH₃)⁺, (AsH₄)⁺, (SbH₄)⁺, alkali metals (however, excluding Cs⁺) (n is an integer of 1 to 100, and x is an integer of from 1 to 100), or a combination thereof. As A′, formamidinium, methylammonium, rubidium, or the like may be added to manufacture a light emitting layer, but may be deposited as the light emitting layer without pyrolysis.

In addition, B is a metal ion, preferably B may be a divalent transition metal ion, a rare earth metal ion, an alkaline earth metal ion, a monovalent metal ion, a trivalent metal ion, or a combination thereof, and more preferably B may be divalent Pb.

In addition, X may be F⁻, Cl⁻, Br⁻, I⁻, SCN⁻, OCN⁻, SeCN⁻, HCO²⁻, CH₃COO⁻, CF₃COO⁻ or a combination thereof, and preferably X may be Br⁻.

Furthermore, a may be 0 to 0.9, more specifically 0, 0.05, 0.1, 0.15, 0.2, 0.25, 0.3, 0.35, 0.4, 0.45, 0.5, 0.55, 0.6, 0.65, 0.7, 0.75, 0.8, 0.85 or 0.9, and m may be an integer between 2 and 6.

Most preferably, A′ is not present, and thus the Cs₁₋ₐA′ₐBX₃ crystal may be CsPbBr₃ and the A″₂(Cs₁₋ₐA′ₐ)ₘ₋₁BₘX₃ₘ₊₁ crystal may be A″Csₘ₋₁PbₘBr₃ₘ₊₁.

The A″ described above may be a cation having an ionic radius larger than the ionic radius of Cs, for partially or entirely substituting Cs, preferably may be an organic cation, more preferably may be an organoammonium cation, even more preferably may be an aromatic ammonium cation, and most preferably may be a benzylammonium cation.

Referring to FIG. 3, the Cs₁₋ₐA′ₐBX₃ crystal may be a 3D perovskite crystal, and the A″₂(Cs₁₋ₐA′ₐ)ₙ₋₁BₙX₃ₙ₊₁ crystal may be a quasi-2D perovskite crystal. When 3D perovskite is included in the light emitting layer, the 3D perovskite crystal performs the function of emitting light and has good electrical conductivity, which is advantageous in terms of charge transport. In addition, when the quasi-2D structure perovskite crystal is included in the light emitting layer, a 3D structure having excellent charge injection and transport due to good electrical conductivity is integrated with a 2D structure capable of facilitating an exciton confinement effect, so that the exciton confinement effect in the light emitting layer is increased, charge injection is smooth, energy funneling is efficient, and light emission efficiency and light emission intensity are excellent.

Furthermore, when the Cs₁₋ₐA′ₐBX₃ crystal and the A″₂(Cs₁₋ₐA′ₐ)ₙ₋₁BₙX₃ₙ₊₁ crystal are simultaneously included in the light emitting layer, the quasi-2D perovskite has a larger band gap, so that an exciton confinement effect in the 3D perovskite may be enhanced, and the charge injection is not disturbed by a gradual band gap structure, and effective charge injection is possible. The charges thus injected may have light emission efficiency and light emission intensity with a strong confinement effect in the 3D perovskite.

In the light emitting layer, the molar ratio of Cs and A″ may be 1:0.2 to 1:0.8. If the molar ratio of A″ is less than 0.2, quasi-2D perovskite crystals are not uniformly formed, and a problem of aggregation of A″ cation compounds occurs, resulting in poor surface characteristics. When the molar ratio of A″ is more than 0.8, the electric conductivity is lowered due to an excess quasi-2D phase, which causes a problem that charge injection is not smooth in terms of application to a light emitting device.

In the XPS graph of the light emitting layer including the perovskite crystal in which B is Pb²⁺ and X is Br described above, peaks may not be shown at binding energy of 136 to 138 eV and 141 to 142 eV, and peaks may be shown at binding energy of 138 to 140 eV and 143 to 145 eV. Specifically, the light emitting layer deposited with the perovskite powder manufactured in which B is Pb²⁺ and X is Br⁻, and the molar ratio of CsX and BX₂ is 1.3:1 to 1.7:1 may not have peaks at binding energy or 136 to 138 eV and 141 to 142 eV in the XPS graph, and may have peaks at binding energy of 138 to 140 eV and 143 to 145 eV. If the peaks appear at binding energy 136 to 138 eV and 141 to 142 eV, the metallic B form is present and the exciton disappears due to a quenching phenomenon by the metallic B to reduce the light emission efficiency.

Meanwhile, referring to FIG. 6G, a mean grain size of the Cs₁₋ₐA′ₐBX₃ crystal and/or A″₂(Cs₁₋ₐA′ₐ)ₙ₋₁BₙX₃ₙ₊₁ crystal may be 5 to 50 nm. The mean grain size may be preferably 10 to 30 nm, and more preferably 15 to 25 nm. Specifically, the mean grain size may be 5 nm, 5.5 nm, 6 nm, 6.5 nm, 7 nm, 7.5 nm, 8.0 nm, 8.5 nm, 9 nm, 9.5 nm, 10 nm, 10.5 nm, 11 nm, 11.5 nm, 12 nm, 12.5 nm, 13 nm, 13.5 nm, 14 nm, 14.5 nm, 15 nm, 15.5 nm, 16 nm, 16.5 nm, 17 nm, 17.5 nm, 18 nm, 18.5 nm, 19 nm, 19.5 nm, 20 nm, 20.5 nm, 21 nm, 21.5 nm, 22 nm, 22.5 nm, 23 nm, 23.5 nm, 24 nm, 24.5 nm, 25 nm, 25.5 nm, 26 nm, 26.5 nm, 27 nm, 27.5 nm, 28 nm, 28.5 nm, 29 nm, 29.5 nm, 30 nm, 30.5 nm, 31 nm, 31.5 nm, 32 nm, 32.5 nm, 33 nm, 33.5 nm, 34 nm, 34.5 nm, 35 nm, 35.5 nm, 36 nm, 36.5 nm, 37 nm, 37.5 nm, 38 nm, 38.5 nm, 39 nm, 39.5 nm, 40 nm, 40.5 nm, 41 nm, 41.5 nm, 42 nm, 42.5 nm, 43 nm, 43.5 nm, 44 nm, 44.5 nm, 45 nm, 45.5 nm, 46 nm, 46.5 nm, 47 nm, 47.5 nm, 48 nm, 48.5 nm, 49 nm, 49.5 nm, or 50 nm, and preferably may be 15 nm, 15.5 nm, 16 nm, 16.5 nm, 17 nm, 17.5 nm, 18 nm, 18.5 nm, 19 nm, 19.5 nm, 20 nm, 20.5 nm, 21 nm, 21.5 nm, 22 nm, 22.5 nm, 23 nm, 23.5 nm, 24 nm, 24.5 nm, or 25 nm.

The grain size is measured and calculated by a method for calculating a mean value through a diameter measurement method. If the mean grain size is less than 5 nm, it may be difficult to adjust the size distribution of the crystals, and the surface is increased to increase the number of defects, thereby reducing the light emission efficiency. When the mean grain size is more than 50 nm, as the exciton binding energy becomes smaller in a large grain, the confinement effect of the exciton becomes smaller, and then radioactive recombination is reduced, so that the light emission efficiency may be reduced.

Further, as described above, the thickness of the light emitting layer of the present disclosure may be 10 to 300 nm. Specifically, the thickness may be 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 105 nm, 110 nm, 115 nm, 120 nm, 125 nm, 130 nm, 135 nm, 140 nm, 145 nm, 150 nm, 155 nm, 160 nm, 165 nm, 170 nm, 175 nm, 180 nm, 185 nm, 190 nm, 195 nm, 200 nm, 215 nm, 210 nm, 215 nm, 220 nm, 225 nm, 230 nm, 235 nm, 240 nm, 245 nm, 250 nm, 255 nm, 260 nm, 265 nm, 270 nm, 275 nm, 280 nm, 285 nm, 290 nm, 295 nm, or 300 nm. If the thickness is less than 10 nm, a passage through which current leakage occurs in the light emitting device may be generated because the entire substrate is not covered due to island growth, and in a thin film of more than 300 nm which is too thick, there may be a problem that the light emission efficiency is drastically lowered due to reabsorption of excitons.

In order to solve the problem, there is provided a light emitting device including the light emitting layer for the light emitting device described above.

The light emitting device described above may exhibit high color purity and excellent light emission efficiency and luminance by including quasi-2D perovskite crystals in the light emitting layer. In an embodiment, the light emitting device including the perovskite light emitting film may exhibit a low turn-on voltage of 2.5 V or less.

The light emitting device described above may include all devices that emit light, such as a light emitting diode device, a light emitting transistor device, a laser device, and a polarized light emitting device. The light emitting device may preferably be a green light emitting diode device.

Referring to FIG. 8A, the light emitting device may include a substrate, a hole injection layer, a light emitting layer, an electron transport layer, and a cathode. Preferably, the light emitting device may be configured by stacking an anode, a hole injection layer, a hole transport layer, a light emitting layer, an electron transport layer, an electron injection layer, and a cathode in sequence.

The light emitting device is based on a principle of electric drive operation using injection of electrons and holes, and may operate through a combination of the electron and hole mobility balance of each layer and the light emitting characteristics in the light emitting layer.

The anode described above may be a conductive metal oxide, a metal, a metal alloy, or a carbon material. The conductive metal oxide may be ITO (Indium tin oxide), FTO (F-doped SnO₂), AZO (Al-doped ZnO), GZO (Ga-doped ZnO), IGZO (In,Ga-doped ZnO), MZO (Mg-doped ZnO), Mo-doped ZnO, Al-doped MgO, Ga-doped MgO, Nb-dpoed TiO₂ or CuAlO₂, or a combination thereof; the metal or metal alloy may be Au and CuI; and the carbon material may be graphite, graphene, or carbon nanotubes. Preferably, the conductive metal oxide may be FTO (F-doped SnO₂). In addition, the thickness of the anode described above may be applied without limitation as long as the thickness is a thickness that may be usually used as the anode and thus is not particularly limited in the present disclosure. Specifically, the thickness may be 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 105 nm, 110 nm, 115 nm, 120 nm, 125 nm, 130 nm, 135 nm, 140 nm, 145 nm, 150 nm, 155 nm, 160 nm, 165 nm, 170 nm, 175 nm, 180 nm, 185 nm, 190 nm, 195 nm, 200 nm, 205 nm, 210 nm, 215 nm, 220 nm, 225 nm, 230 nm, 235 nm, 240 nm, 245 nm, or 250 nm.

The hole injection layer may include a hole injecting material. For example, the hole injection layer may include one or more of a metal oxide and a hole-injecting organic material. The metal oxide may include one or more metal oxides selected from the group consisting of MoO₃, WO₃, V₂O₅, nickel oxide (NiO), copper oxide (Copper (II) Oxide: CuO), copper aluminum oxide (CAO, CuAlO₂), zinc rhodium oxide (ZRO, ZnRh₂O₄), GaSnO, and GaSnO doped with metal-sulfide (FeS, ZnS, or CuS). The hole-injecting organic material may include at least one selected from the group consisting of Fullerene (C₆₀), HAT-CN, F16CuPC, CuPC, m-MTDATA [4,4′,4″-tris(3-methylphenylphenylamino) triphenylamine], NPB [N,N′-Di(1-naphthyl)-N,N′-diphenyl-(1,1′-biphenyl)-4,4′-diamine)], TDATA, 2T-NATA, Pani/DBSA (Polyaniline/Dodecylbenzenesulfonic acid), PEDOT/PSS (Poly(3,4-ethylenedioxythiophene)/Poly(4-styrenesulfonate), Pani/CSA (Polyaniline/Camphor sulfonicacid), and PANI/PSS (Polyaniline)/Poly(4-styrenesulfonate).

In addition, the thickness of the hole injection layer described above may be applied without limitation as long as the thickness is a thickness that may be usually used as the hole injection layer and thus is not particularly limited in the present disclosure. Specifically, the thickness may be 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm or 100 nm, preferably 30 nm, 35 nm, 40 nm, 45 nm, 50 nm, 55 nm, 60 nm, 65 nm, 70 nm, 75 nm, 80 nm, 85 nm or 90 nm, and more preferably 50 nm, 55 nm, 60 nm, 65 nm, 70 nm, 75 nm or 80 nm.

The hole transport layer may be at least any one selected from poly(3,4-ethylenedioxythiophene):poly(styrenesulfonate) (PEDOT:PSS), poly(9-vinylcarbazole) (PVK), poly(4-butylphenyl-diphenyl-amine ([Poly-TPD], poly(p-phenylenesulfide), poly(p-phenylene vinylene) (PPV), poly(3-methylthiophene), polypyrrole, polyaniline, a-NPD (N,N′-Di(1-naphthyl)-N,N′-diphenyl-(1,1′-biphenyl)-4,4′-(diamine), NPB (N,N′-Di(1-naphthyl)-N,N′-diphenyl-(1,1′-biphenyl)-4,4′-(diamine), TAPC (4,4′-Cyclohexylidenebis[N,N-bis(4-methylphenyl)benzenamine]), HAT-CN (1,4,5,8,9,11-hexaazatriphenylene hexacarbonitrile), CBP (4,4′-Bis(N-carbazolyl)-1,1′-biphenyl), mCBP (amorphous_4,4′-Bis(Ncarbazolyl)-1,1′-biphenyl), Spiro-OMeTAD (2,2′,7,7′-Tetrakis[N,N-di(4-methoxyphenyl)amino]-9,9′-spirobifluorene), and P-type metal oxides, but is not limited thereto.

In addition, the thickness of the hole transport layer described above may be applied without limitation as long as the thickness is a thickness that may be usually used as the hole transport layer and thus is not particularly limited in the present disclosure. Specifically, the thickness may be 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm or 100 nm, preferably 30 nm, 35 nm, 40 nm, 45 nm, 50 nm, 55 nm, 60 nm, 65 nm, 70 nm, 75 nm, 80 nm, 85 nm or 90 nm, and more preferably 50 nm, 55 nm, 60 nm, 65 nm, 70 nm, 75 nm or 80 nm.

The electron transport layer described above may include quinoline derivatives, particularly tris(8-hydroxyquinoline)aluminum (Alq3), bis(2-methyl-8-quinolinolate)-4-(phenylphenolato)aluminium (Balq), bis(10-hydroxybenzo[h] quinolinato)-beryllium (Bebq2), 2,9-dimethyl-4,7-diphenyl-1,10-phenanthroline (BCP), 4,7-diphenyl-1,10-phenanthroline (Bphen), 2,2′,2″-(benzene-1,3,5-triyl)-tris(1-phenyl-1H-benzimidazole) (TPBI), 3-(4-biphenyl)-4-(phenyl-5-tert-butylphenyl-1,2,4-triazole (TAZ), 4-(naphthalene-1-yl)-3,5-diphenyl-4H-1,2,4-triazole (NTAZ), 2,9-bis(naphthalen-2-yl)-4,7-bis-1,10-penanthroline (NBphen), tris(2,4,6-trimethyl-3-(pyridin-3-yl)phenyl) borane (3TPYMB), phenyl-dipyrenylphosphine oxide (POPy2), 3,3′,5,5′-tetra[(m-pyridyl)-phen-3-yl] biphenyl (BP4mPy), 1,3,5-tri[(3-pyridyl)-phen-3-yl]benzene (TmPyPB), 1,3-bis[3,5-di(pyridin-3-yl)phenyl]benzene (BmPyPhB), bis(10-hydroxybenzo[h] quinolinato) beryllium (Bepq2), diphenylbis(4-(pyridin-3-yl)phenyl) silane (DPPS), 1,3,5-tri (p-pyrid-3-yl-phenyl)benzene (TpPyPB), 1,3-bis[2-(2,2′-bipyridine-6-yl)-1,3,4-oxadiazo-5-yl]benzene (Bpy-OXD), 6,6′-bis[5-(biphenyl-4-yl)-1,3,4-oxadiazo-2-yl]-2,2′-bipyridyl (BP-OXD-Bpy), TSPO1 (diphenylphosphine oxide-4-(triphenylsilyl)phenyl), TPBi (1,3,5-tris(N-phenylbenzimidazol-2-yl)benzene), tris(8-quinolinolate)aluminum (Alq3), 2,5-diaryl silole derivatives (PyPySPyPy), perfluorinated compounds (PF-6P), COTs (Octasubstituted cyclooctatetraene), etc. Preferably, the electron transport layer may be TPBi.

In addition, the thickness of the electron transport layer described above may be applied without limitation as long as the thickness is a thickness that may be usually used as the electron transport layer and thus is not particularly limited in the present disclosure. Specifically, the thickness may be 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm or 100 nm, preferably 30 nm, 35 nm, 40 nm, 45 nm, 50 nm, 55 nm, 60 nm, 65 nm, 70 nm, 75 nm, 80 nm, 85 nm or 90 nm, and more preferably 30 nm, 35 nm, 40 nm, 45 nm or 50 nm.

The electron injection layer may include one or more metal oxides selected from aluminum doped zinc oxide (AZO), AZO doped with alkali metal (Li, Na, K, Rb, Cs, or Fr), TiOx (x is a real number of 1 to 3), indium oxide (In₂O₃), tin oxide (SnO₂), zinc oxide (ZnO), zinc tin oxide, gallium oxide (Ga₂O₃), tungsten oxide (WO₃), aluminum oxide, titanium oxide, vanadium oxide (V₂O₅, vanadium (IV) oxide (VO₂), V₄O₇, V₅O₉, or V₂O₃), molybdenum oxide (MoO₃ or MoOx), copper oxide (Copper (II) Oxide: CuO), nickel oxide (NiO), copper aluminium oxide (CAO, CuAlO₂), zinc rhodium Oxide (ZRO, ZnRh₂O₄), iron oxide, chromium oxide, bismuth oxide, indium-gallium zinc oxide (IGZO), and ZrO₂, but is not limited thereto.

In addition, the thickness of the electron injection layer described above may be applied without limitation as long as the thickness is a thickness that may be usually used as the electron injection layer and thus is not particularly limited in the present disclosure. Specifically, the thickness may be 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm or 100 nm, preferably 30 nm, 35 nm, 40 nm, 45 nm, 50 nm, 55 nm, 60 nm, 65 nm, 70 nm, 75 nm, 80 nm, 85 nm or 90 nm, and more preferably 30 nm, 35 nm, 40 nm, 45 nm or 50 nm.

The cathode is a conductive film having a lower work function than the anode, and may be, for example, metals such as aluminum, magnesium, calcium, sodium, potassium, titanium, indium, yttrium, lithium, gadolinium, aluminum, silver, tin, lead, cesium, barium, or alloys containing two or more thereof, and may be a multilayer structure material such as LiF/Al, LiO₂/Al, LiF/Ca, LiF/Al and BaF₂/Ca. Preferably, the cathode may be LiF/Al.

In addition, the thickness of the cathode described above may be applied without limitation as long as the thickness is a thickness that may be usually used as the cathode and thus is not particularly limited in the present disclosure. Specifically, the thickness may be 40 nm, 45 nm, 50 nm, 55 nm, 60 nm, 65 nm, 70 nm, 75 nm, 80 nm, 85 nm, 90 nm, 95 nm or 100 nm.

The method for manufacturing the light emitting device described above may include forming an anode on a substrate, forming a hole injection layer on the anode, forming a hole transport layer on the hole injection layer, forming a light emitting layer on the hole transport layer, forming an electron transport layer on the light emitting layer, forming an electron injection layer on the electron transport layer, and forming a cathode on the electron transport layer.

The anode, the hole injection layer, the hole transport layer, the electron transport layer, the electron injection layer, and the cathode described above may be stacked according to a stacking method that may be commonly used in the art, and thus the present disclosure is not particularly limited thereto. Preferably, the anode, the hole injection layer, the hole transport layer, the electron transport layer, the electron injection layer, and the cathode may be stacked by a deposition process or a coating process.

Hereinafter, the present disclosure will be described in more detail through the following Examples, but the following Examples do not limit the scope of the present disclosure, and should be interpreted as helping to understand the present disclosure.

### EXAMPLES

### Example 1

0.015 mol of CsBr (first precursor) and 0.01 mol of PbBr₂ (second precursor) were mixed in 50 mL of a DMSO solvent to form a precursor solution, and then 40 mL of HBr was added to form a perovskite precipitate using a precipitation method. The formed perovskite precipitate was added with the precursor solution and ethanol (EtOH) in a volume corresponding to a ratio of 2:1, and purified, and then vacuum-treated to remove the remaining solvent and form a perovskite powder.

The formed perovskite material was mechanically milled using a pestle and a mortar to manufacture a polycrystalline perovskite powder containing CsPbBr₃ crystals having a crystallite size of 70 nm. This process was shown in FIGS. 1A and 1B.

### Example 2

A polycrystalline perovskite powder containing CsPbBr₃ crystals was manufactured in the same manner as in Example 1 except that 0.01 mol of CsBr (first precursor) and 0.01 mol of PbBr₂ (second precursor) were mixed to form a precursor solution.

### Example 3

A polycrystalline perovskite powder containing CsPbBr₃ crystals was manufactured in the same manner as in Example 1 except that 0.011 mol of CsBr (first precursor) and 0.01 mol of PbBr₂ (second precursor) were mixed to form a precursor solution.

### Example 4

A polycrystalline perovskite powder containing CsPbBr₃ crystals was manufactured in the same manner as in Example 1 except that 0.02 mol of CsBr (first precursor) and 0.01 mol of PbBr₂ (second precursor) were mixed to form a precursor solution.

### Example 5

A polycrystalline perovskite powder containing CsPbBr₃ crystals was manufactured in the same manner as in Example 1 except that 0.03 mol of CsBr (first precursor) and 0.01 mol of PbBr₂ (second precursor) were mixed to form a precursor solution.

### Example 6

A polycrystalline perovskite powder containing CsPbBr₃ crystals was manufactured in the same manner as in Example 1 except that 0.0135 mol of CsBr, 0.0015 mol of FABr (first precursor) and PbBr₂ (second precursor) were mixed to form a precursor solution.

### Example 7

A polycrystalline perovskite powder containing CsPbBr₃ crystals was manufactured in the same manner as in Example 1 except that 0.0135 mol of CsBr, 0.0015 mol of MABr (first precursor) and PbBr₂ (second precursor) were mixed to form a precursor solution.

TABLE 2

| | | Ex. 1 | Ex. 2 | Ex. 3 | Ex. 4 | Ex. 5 | Ex. 6 | Ex. 7 |
|---|---|---|---|---|---|---|---|---|
| First | Type | CsBr | CsBr | CsBr | CsBr | CsBr | CsBr/FABr | CsBr/MABr |
| precursor | Molar | 1.5 | 1 | 1.1 | 2.0 | 3.0 | 1.35/0.15 | 1.35/0.15 |
| | ratio | | | | | | | |
| Second | Type | PbBr₂ | PbBr₂ | PbBr₂ | PbBr₂ | PbBr₂ | PbBr₂ | PbBr₂ |
| precursor | Molar | 1 | 1 | 1 | 1 | 1 | 1 | 1 |
| | ratio | | | | | | | |

### EXPERIMENTAL EXAMPLES

### Experimental Example 1: XRD Analysis of Perovskite Powder

Examples 1 to 4 were subjected to XRD analysis using D8-Advanced (XRD, al system) equipment, and the results were shown in FIG. 4D.

It may be seen in Examples 1 to 4 that peaks are shown at 20 values of 14˜16°, 20˜22°, 30˜31°, 33˜35°, and 37˜38° in a XRD graph, and CsPbBr₃ crystals were successfully synthesized.

However, in Example 4, it may be seen that in the XRD graph, peaks are shown at the 20 value of 11-14° and it may be also seen that Cs₄PbBr₆ crystals were additionally synthesized in addition to CsPbBr₃ crystals. This is because the molar ratio of CsBr exceeded 1.8 in the molar ratio of CsBr and PbBr₂.

### Experimental Example 2: X-Ray Photoelectron Spectroscopy (XPS) Analysis of Deposition Powder

For Examples 1 to 3, XPS analysis was performed using VersaProbe III equipment, and the results were shown in FIG. 4F.

In the XPS graph of Examples 1 to 3, it may be seen that peaks are shown at binding energy of 138 to 140 eV and 143 to 145 eV, and CsPbBr₃ crystals were successfully synthesized. However, in Examples 1 and 2, it may be seen that peaks are shown at binding energy of 136 to 138 eV and 141 to 142 eV in the XPS graph, which indicates that there is a large amount of unreacted PbBr₂ and a large amount of metallic Pb remains in the deposition powder.

If a large amount of metallic Pb remains, excitons disappear due to a quenching phenomenon, and thus light emission efficiency is lowered. This may be confirmed through FIGS. 4A to 4C showing experimental values for light emission of the light emitting layers manufactured in Examples 1 to 3.

### Experimental Example 3: Thermogravimetric Analysis (TGA) Curve Analysis

A pyrolysis temperature was determined by measuring the mass change of a material according to a temperature change with TG. Specifically, the pyrolysis temperature is determined on the basis of a temperature at which the mass of a first sample (sample weight: 10 mg) is reduced by 5% under heating conditions (10° C./min, 25 to 600° C. (N₂ purge)).

A TGA curve for Examples 1, 2, 4 and 5 was analyzed using a Discovery TGA 5500 instrument, and the results were shown in FIG. 5.

As a result of analyzing the TGA curve, it was confirmed that the pyrolysis temperatures of Examples 1, 2, 4, and 5 were measured as 550 to 600° C., which was higher than 500° C. as a temperature of thermal deposition used in the present disclosure, and thus Example 1, 2, 4 and 5 were not pyrolyzed in the deposition process.

### PREPARATION EXAMPLES

### Preparation Example 1

A porous material of Ag nanoparticles, polystyrene beads, TiO₂ nanoparticles, and porous silicon having a regular arrangement of a 50 nm nano size was applied to a glass substrate at a thickness of 50 nm by a spin coating method. The perovskite powder of Example 1 was used as a deposition source, and the deposition rate of the powder was set to 1 Å/s. Then, the powder was deposited to a thickness of 50 nm on the porous material layer by a physicochemical vacuum deposition method using a vacuum deposition apparatus (manufacturer: Daedong Hi-Tech, product name: Solar Double Passage) as a deposition device to prepare a light emitting layer for a light emitting device.

### Preparation Example 2

A light emitting layer for a light emitting device was prepared in the same manner as in Preparation Example 1 except that the perovskite powder of Example 2 was used as a deposition source.

### Preparation Example 3

A light emitting layer for a light emitting device was prepared in the same manner as in Preparation Example 1 except that the perovskite powder of Example 3 was used as a deposition source.

### Preparation Example 4

A light emitting layer for a light emitting device was prepared in the same manner as in Preparation Example 1 except that the perovskite powder of Example 4 was used as a deposition source.

### Preparation Example 5

A light emitting layer for a light emitting device was prepared in the same manner as in Preparation Example 1 except that the perovskite powder of Example 5 was used as a deposition source.

### COMPARATIVE PREPARATION EXAMPLES

### Comparative Preparation Example 1

A porous material of Ag nanoparticles, polystyrene beads, TiO₂ nanoparticles, and porous silicon having a regular arrangement of a 50 nm nano size was applied to a glass substrate at a thickness of 50 nm by a spin coating method. A light emitting layer was not prepared using a single-source deposition source, but CsBr and PbBr₂ were used as two perovskite deposition sources, and the deposition rates of each deposition source were set to 1.05 Å/s and 0.7 Å/s, respectively. Then, the powder was deposited to a thickness of 50 nm on the porous material layer by a physicochemical vacuum deposition method using a vacuum deposition apparatus (manufacturer: Daedong Hi-Tech, product name: Solar Double Passage) as a deposition device to prepare a light emitting layer for a light emitting device.

### Comparative Preparation Example 2

A light emitting layer for a light emitting device was prepared in the same manner as in Comparative Preparation Example 1 except that the deposition rates of CsBr and PbBr₂ were 1.04 Å/s and 0.8 Å/s.

### Comparative Preparation Example 3

A light emitting layer for a light emitting device was prepared in the same manner as in Comparative Preparation Example 1 except that the deposition rates of CsBr and PbBr₂ were 0.99 Å/s and 0.9 Å/s.

TABLE 3

| | Prep. | Prep. | Prep. | Prep. | Prep. | Com. Prep. | Com. Prep. | Com. Prep. |
|---|---|---|---|---|---|---|---|---|
| | Ex. 1 | Ex. 2 | Ex. 3 | Ex. 4 | Ex. 5 | Ex. 1 | Ex. 2 | Ex. 3 |
| Deposition | Ex. 1 | Ex. 2 | Ex. 3 | Ex. 4 | Ex. 5 | CsBr and | CsBr and | CsBr and |
| source | | | | | | PbBr₂ | PbBr₂ | PbBr₂ |
| Deposition | 1.0 | 1.0 | 1.0 | 1.0 | 1.0 | CsBr: 1.05 | CsBr: 1.04 | CsBr: 0.99 |
| rate (Å/s) | | | | | | PbBr₂: 0.7 | PbBr₂: 0.8 | PbBr₂: 0.9 |

### EXPERIMENTAL EXAMPLES

### Experimental Example 4: Photoluminescence Spectrum Analysis

A photoluminescence spectrum was measured with an FP-8500 instrument from JASCO using an integrating sphere. The photoluminescence spectra of Preparation Examples 1 to 5 were measured, and the results were shown in FIGS. 4A and 4C. In addition, the photoluminescence spectrum of Comparative Preparation Example 1 was also measured.

Referring to FIGS. 4A and 4C, it was confirmed that the light emission characteristics were different depending on a molar ratio of CsBr and PbBr₂. In particular, when the molar ratio of CsBr and PbBr₂ was set to a ratio of 1.5:1 as in Example 1, it was confirmed that the light emission intensity was 2.0 arbitrary unit (a.u.) or higher.

On the other hand, referring to FIG. 4F, since crystallization was not completed, Comparative Preparation Example 1 was not present on the perovskite phase, and thus fluorescence was not measured in the photoluminescence spectrum.

### Experimental Example 5: Time-Correlated Single-Photon Counting (TCSPC) Analysis

The TCSPC was measured by using a laser with a fixed wavelength using FluoTime 300 equipment of PicoQuant. The TCSPC of Preparation Examples 1 to 5 was measured, and the results were shown in FIGS. 4A and 4C. In addition, the TCSPC of Comparative Preparation Example 1 was also measured.

Referring to FIGS. 4B and 4C, it was confirmed that the light emission characteristics were different depending on a molar ratio of CsBr and PbBr₂. In particular, when the molar ratio of CsBr and PbBr₂ was set to a ratio of 1.5:1 as in Example 1, it was confirmed that the fluorescence lifetime was as high as 140 ns or more.

### Experimental Example 6: XRD Analysis of Light Emitting Layer for Light Emitting Device

Preparation Examples 1 to 4 and Comparative Preparation Example 1 were subjected to XRD analysis using D8-Advanced (XRD, al system) equipment, and the results were shown in FIG. 4E.

It may be seen in Preparation Examples 1 to 4 that in a XRD graph, peaks were shown at 20 values of 14˜16°, 20˜22°, 30˜31°, 33˜35°, and 37˜38°, and it may be seen that the CsPbBr₃ crystals were not pyrolyzed in the deposition process even after the deposition process was performed and was included in the light emitting layer as it was.

In Comparative Preparation Example 1, when an excessive amount of Cs cations (CsBr/PbBr₂>1.5) is contained, it may be seen that the Cs₄PbBr₆ phase, which is an impurity phase without luminescence characteristics, appears, and peaks are shown at 20 values of 11 to 14° in the XRD graph.

### PREPARATION EXAMPLES

### Preparation Example 6

A porous material of Ag nanoparticles, polystyrene beads, TiO₂ nanoparticles, and porous silicon having a regular arrangement of a 50 nm nano size was applied to a glass substrate at a thickness of 50 nm by a spin coating method. The perovskite powder of Example 1 was used as a first deposition source for co-deposition, and benzylammonium bromide (BzABr, manufacturer: Grate Cell Solar, product name: Benzylammonium Bromide) was used as a second deposition source for the co-deposition in the form of a solid powder. The deposition rate of the first deposition source was set to 1.0 Å/s, and the deposition rate ratio of the first deposition source and the second deposition source was set to 1:0.7. Then, the first deposition source and the second deposition source were deposited on the porous material layer with a thickness of 50 nm using a vacuum deposition apparatus (manufacturer: Daedong Hi-Tech, product name: Solar Double Passage) as deposition equipment by a physicochemical co-vacuum deposition method to prepare a light emitting layer for a light emitting device.

### Preparation Example 7

A light emitting layer for a light emitting device was prepared in the same manner as in Preparation Example 6 except that the deposition rate ratio of the first deposition source and the second deposition source was set to 1:0.2.

### Preparation Example 8

A light emitting layer for a light emitting device was prepared in the same manner as in Preparation Example 6 except that the deposition rate ratio of the first deposition source and the second deposition source was set to 1:0.4.

### Preparation Example 9

A light emitting layer for a light emitting device was prepared in the same manner as in Preparation Example 6 except that the deposition rate ratio of the first deposition source and the second deposition source was set to 1:0.5.

### Preparation Example 10

A light emitting layer for a light emitting device was prepared in the same manner as in Preparation Example 6 except that the deposition rate ratio of the first deposition source and the second deposition source was set to 1:0.6.

### Preparation Example 11

A light emitting layer for a light emitting device was prepared in the same manner as in Preparation Example 6 except that the deposition rate ratio of the first deposition source and the second deposition source was set to 1:0.8.

### Preparation Example 12

A light emitting layer for a light emitting device was prepared in the same manner as in Preparation Example 6 except that the deposition rate of the first deposition source was set to 0.4 Å/s.

### Preparation Example 13

A light emitting layer for a light emitting device was prepared in the same manner as in Preparation Example 6 except that the deposition rate of the first deposition source was set to 1.4 Å/s.

TABLE 4

| | | Prep. | Prep. | Prep. | Prep. | Prep. | Prep. | Prep. | Prep. |
|---|---|---|---|---|---|---|---|---|---|
| | | Ex. 6 | Ex. 7 | Ex. 8 | Ex. 9 | Ex. 10 | Ex. 11 | Ex. 12 | Ex. 13 |
| First | Type | Ex. 1 | Ex. 1 | Ex. 1 | Ex. 1 | Ex. 1 | Ex. 1 | Ex. 1 | Ex. 1 |
| deposition | Deposition | 1.0 | 1.0 | 1.0 | 1.0 | 1.0 | 1.0 | 0.4 | 1.4 |
| source | rate (Å/s) | | | | | | | | |
| Second | Type | BzABr | BzABr | BzABr | BzABr | BzABr | BzABr | BzABr | BzABr |
| deposition | Deposition | 0.7 | 0.2 | 0.4 | 0.5 | 0.6 | 0.8 | 0.28 | 0.98 |
| source | rate (Å/s) | | | | | | | | |

### EXPERIMENTAL EXAMPLES

### Experimental Example 7: Photoluminescence Spectrum Analysis

A photoluminescence spectrum was measured with an FP-8500 instrument from JASCO using an integrating sphere. The photoluminescence spectra of Preparation Examples 6 to 8 and 10 to 13 were measured, and the results were shown in FIGS. 6A and 7A.

Referring to FIG. 6A, it may be confirmed that the light emission characteristics are varied depending on a deposition rate ratio of a first deposition source (deposition powder containing CsPbBr₃) and a second deposition source (BzABr). In particular, when the deposition rate ratio is 1:0.65 to 1:0.85 as in Preparation Examples 6 and 11, it may be confirmed that the light emission intensity is as high as 60 a.u or more.

Meanwhile, referring to FIG. 7A, it may be confirmed that the light emission characteristics are varied depending on a deposition rate of the first deposition source. In particular, when the deposition rate of the first deposition source is 0.7 to 1.2 Å/s as in Preparation Examples 6 and 13, it may be confirmed that the light emission intensity is higher than that of Preparation Example 12 in which the deposition rate is 0.4 Å/s. Even if the light emission intensity of Preparation Example 13 is higher than that of Preparation Example 6 in the graph, the light scattering degree of Preparation Example 13 increases due to an increase in pinholes in the light emitting layer caused by rapid deposition, and in the case where Preparation Example 13 is prepared as a device, excitons are not effectively formed while electric charges move to the pinholes, so that the overall light emission efficiency decreases.

Consequently, Preparation Example 6 has the best light emission efficiency in which the deposition rate ratio is 1:0.65 to 1:0.85 and the deposition rate of the first deposition source is 0.7 to 1.2 Å/s.

### Experimental Example 8: UV-Vis Spectrum

A UV-vis spectrum was measured with a V-770 instrument from JASCO. The UV-vis spectra of Preparation Examples 6 to 8 and 10 to 13 were measured, and the results were shown in FIGS. 6B and 7B.

Referring to the UV-vis spectra, a low content of ammonium does not form a sufficient amount of high-dimensional quasi-2D phase and does not effectively control defects. On the other hand, an excess of ammonium forms an excess of quasi-2D phase, which results in a decrease in light emission efficiency as the phases capable of emitting light decrease as a result of aggregated ammonium.

If the deposition rate is too high, pores are generated and light is scattered, resulting in an increase in photoluminescence efficiency. However, in order to enable the application to a light emitting device, all of injected charges are recombined in the light emitting layer to form excitons, and the charges are left through the pores of the surface, resulting in current leakage and reduced light emission efficiency in the device.

### Experimental Example 9: Scanning Electron Microscope (SEM) Image Analysis of Surface of Light Emitting Layer

The scanning electron microscope (SEM) image of the surface of the light emitting layer was measured in an Inlens manner with FESEM (SIGMA) equipment. The surfaces of the light emitting layers of Preparation Examples 6 to 8 and 10 to 13 were analyzed by SEM, and the results were shown in FIGS. 6C to 6G and 7C to 7E.

Referring to FIGS. 6C to 6F, in the case of Preparation Example 11 in which the deposition rate ratio of the first deposition source (deposition powder containing CsPbBr₃) and the second deposition source (BzABr) is 1:0.65 to 1:0.85, it may be confirmed that a uniform surface is formed as compared with Preparation Examples 7, 8, and 10, and thus it may be confirmed through FIGS. 6A and 6B that Preparation Example 11 has good light emission characteristics.

In addition, referring to FIG. 6G, in the case of Preparation Example 11 in which the deposition rate ratio of the first deposition source (deposition powder containing CsPbBr₃) and the second deposition source (BzABr) is 1:0.65 to 1:0.85, it may be seen that Preparation Example 11 has crystal grains smaller than those in Preparation Examples 7, 8, and 10, and it may be seen from FIGS. 6A and 6B that Preparation Example 11 exhibits excellent light emission characteristics due to a small grain size and a large exciton confinement effect.

Referring to FIGS. 7C to 7E, it may be seen that in Preparation Examples 6 and 12 in which the deposition rate of the first deposition source is 1.2 Å/s or less, there are almost no pores on the surface, whereas in Preparation Example 13 in which the deposition rate is 1.4 Å/s, it may be seen that there are many pores on the surface and the light scattering degree increases, and the light emission efficiency of Preparation Example 13 is poorer than that of Preparation Example 12. Further, in Preparation Example 6 in which the deposition rate of the first deposition source was relatively slow at 0.4 Å/s, the bonding between perovskite and ammonium decreased, but the bonding between ammoniums increased, and the defect control of the perovskite was not effectively performed. Therefore, the light emission efficiency was significantly reduced as compared with Preparation Example 12 in which the deposition rate was relatively fast at 0.7 to 1.2 Å/s.

### EXPERIMENTAL EXAMPLES

### Experimental Example 10: Current Density-Voltage Analysis of Light Emitting Device

GraHIL was applied onto ITO by spin coating under a condition of 4000 rpm so as to have a thickness of 80 nm, and then the light emitting layers of Preparation Examples 1, 6, and 9 were deposited thereon by a co-deposition method, and then an electron transport layer, an electron injection layer, and a cathode were vacuum-deposited to prepare a light emitting device.

A current density-voltage graph of the light emitting device was measured using a spectrometer in the dark with IVL equipment and Kisley equipment. The current density-voltage of the light emitting devices including the light emitting layers of Preparation Examples 1, 6, and 9 was measured, and the results were shown in FIG. 8B.

Referring to FIG. 8B, it may be confirmed that the light emitting devices including Preparation Examples 6 and 9 in which perovskite crystals and benzylammonium bromide were co-deposited together showed a higher current density from 3.5 V or more, and showed better efficiency than the light emitting devices including Preparation Example 1 in which quasi-2D perovskite crystals were not included.

### Experimental Example 11: Current Efficiency-Voltage Analysis of Light Emitting Device

Light emitting devices manufactured to include the light emitting layers of Preparation Examples 1, 6, and 9 by the method described above in Experimental Example 10 were prepared.

A current efficiency-voltage graph of the light emitting devices was measured using a spectrometer in the dark with IVL equipment and Kisley equipment. The current efficiency-voltage of the light emitting devices including the light emitting layers of Preparation Examples 1, 6, and 9 was measured, and the results were shown in FIG. 8C.

Referring to FIG. 8C, the light emitting device including Preparation Example 9 showed a low turn-on voltage of 2.5 V, and the light emitting device including Preparation Example 6 showed superior current efficiency from 3.5 V to the light emitting device including Preparation Example 9. That is, it may be confirmed that the higher the deposition rate of benzylammonium bromide, the better the efficiency.

### Experimental Example 12: Luminance-Voltage Analysis of Light Emitting Device

Light emitting devices manufactured to include the light emitting layers of Preparation Examples 1, 6, and 9 by the method described above in Experimental Example 10 were prepared.

A luminance-voltage graph of the light emitting devices was measured using a spectrometer in the dark with IVL equipment and Kisley equipment. The luminance-voltage of the light emitting devices including the light emitting layers of Preparation Examples 1, 6, and 9 was measured, and the results were shown in FIG. 8D.

Referring to FIG. 8D, from about 4V, the light emitting device including Preparation Example 6 showed better luminance than the light emitting device including Preparation Example 9. That is, it may be confirmed that the higher the deposition rate of benzylammonium bromide, the better the efficiency.

Although the examples of the present disclosure have been described as above, the technical spirit of the present disclosure is not limited to the examples presented in the present specification and those skilled in the art, who appreciate the technical spirit of the present disclosure will be able to easily propose other examples by addition, modification, deletion, annexation, and the like of components within the same scope of the technical spirit, but this is also included in the claims of the present disclosure.

### <Perovskite Layered Structure, Optoelectronic Device Including the Same, and Method for Manufacturing the Same>

In the present specification, “high n-phase” in quasi-2D perovskite means when layers on the perovskite crystal are 5 to 25 layers.

In addition, in the present specification, “low n-phase” in quasi-2D perovskite means when layers on the perovskite crystal are 1 to 2 layers.

In addition, in the present specification, “intermediate n-phase” in quasi-2D perovskite means when layers on the perovskite crystal are 3 to 4 layers.

In addition, in the present specification, the “3D perovskite” means that layers on the perovskite crystal are 26 layers or more.

As described above, perovskite based on a solution process has limitations in that reproducibility is poor depending on thin film formation conditions and the surrounding environment, thickness adjustment is difficult, and it is difficult to form a thin film having a uniform morphology because large-area coating is difficult, and therefore, various studies for forming a perovskite thin film using a dry deposition method have been attempted. However, when quasi-2D perovskite was formed according to a conventional deposition method, not only a high n-phase and a low n-phase were unevenly mixed, but also 3D perovskite was formed. Therefore, an energy absorption or energy funneling phenomenon was inefficiently generated, and thus light absorption performance, photoelectric conversion efficiency, light emission performance, or the like was deteriorated when applied to a device, and a light emission FWHM of a light emission spectrum was widened, so that there was a limit that high color purity characteristics of a perovskite material could be lost.

Accordingly, the present disclosure sought to solve the problems by providing a perovskite layered structure 100 including a first scaffold layer 110, a second scaffold layer 120 formed on the first scaffold layer 110 and a perovskite thin film 130 formed on the second scaffold layer 120.

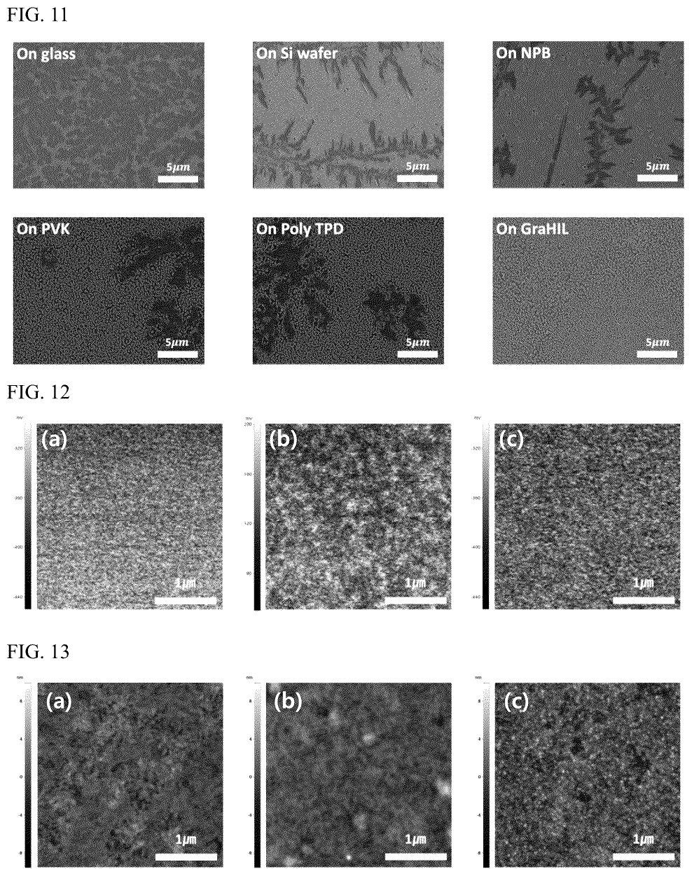

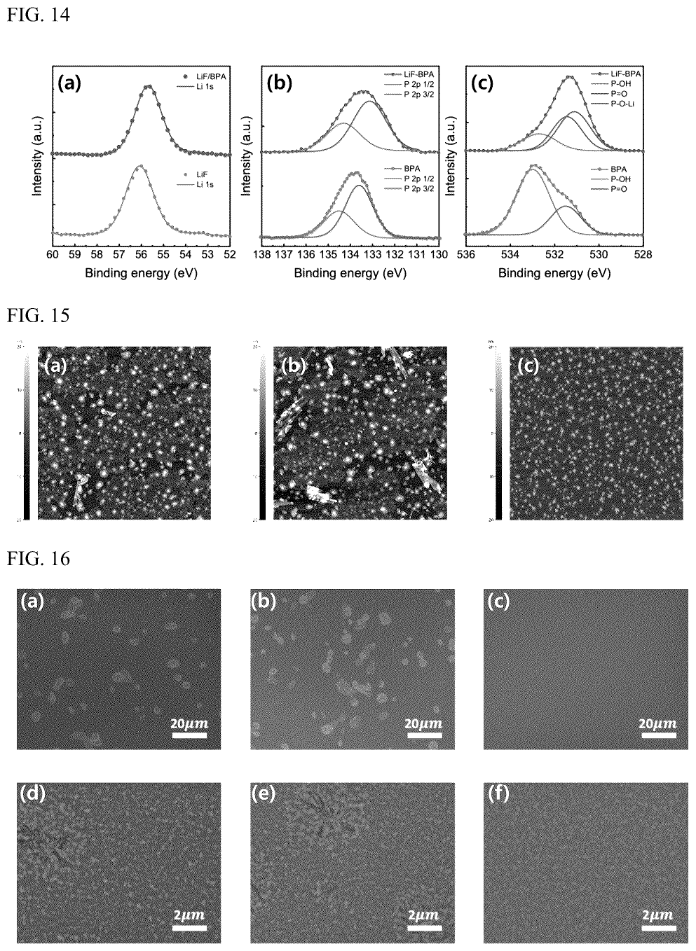

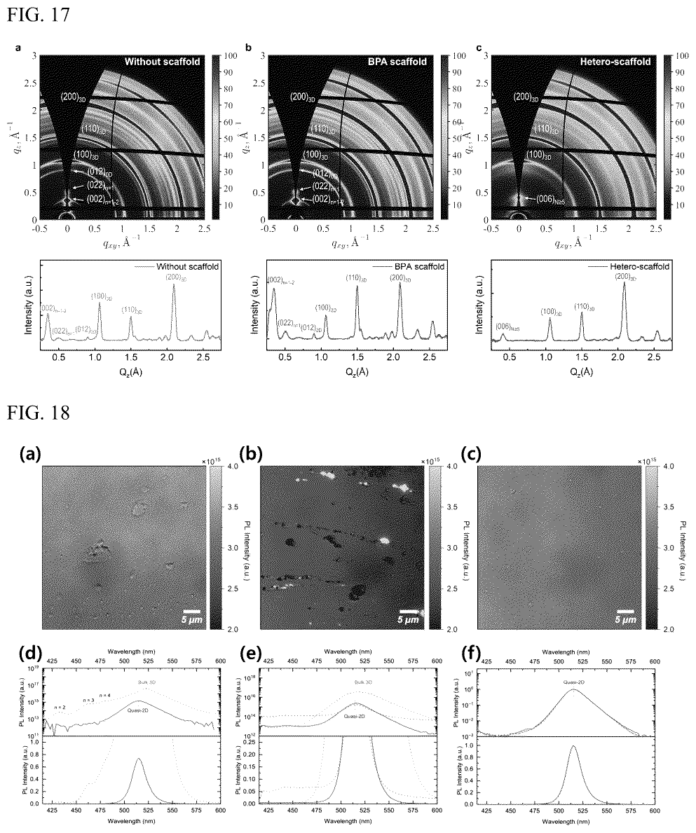

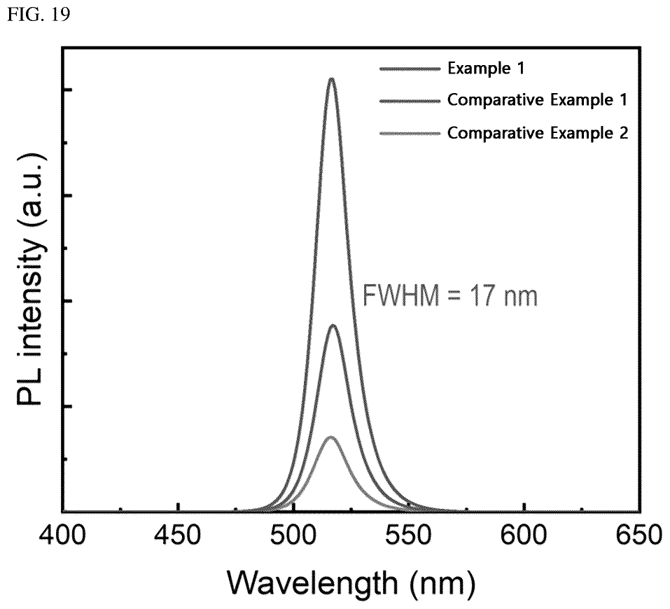

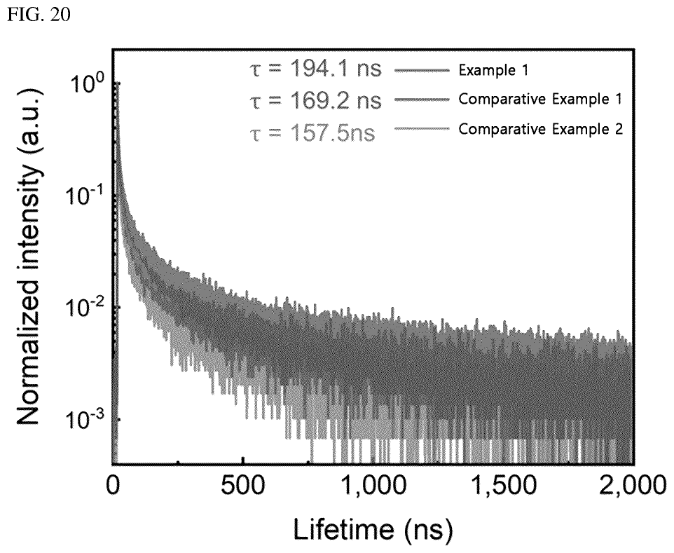

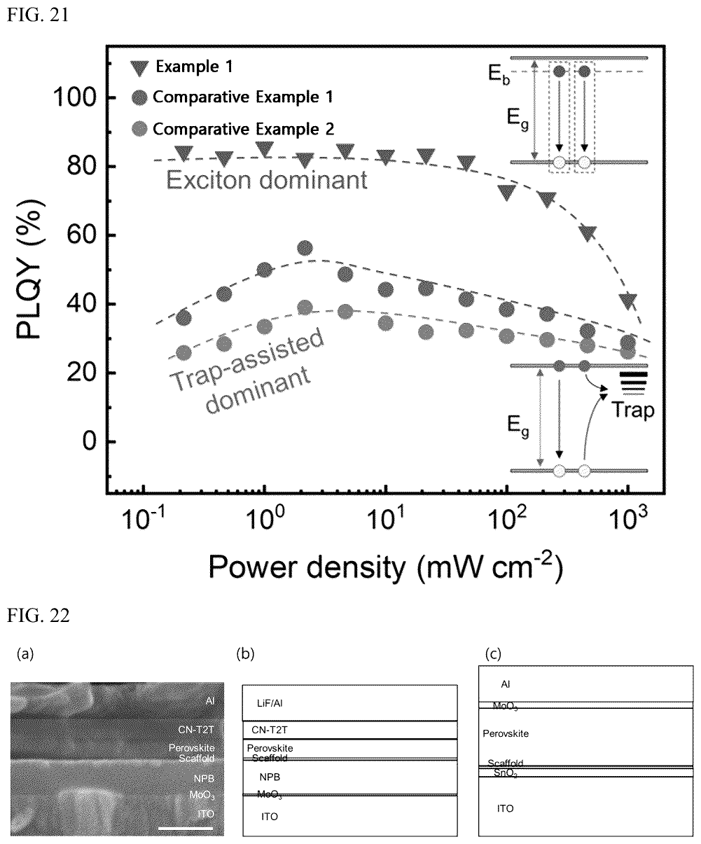

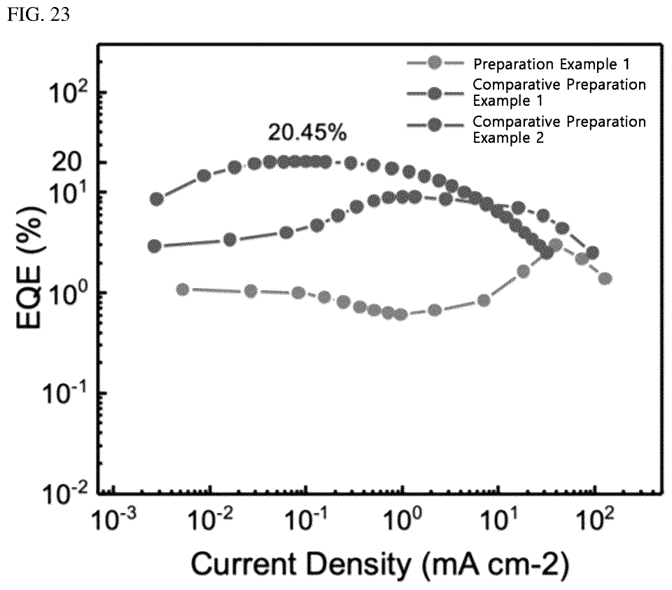

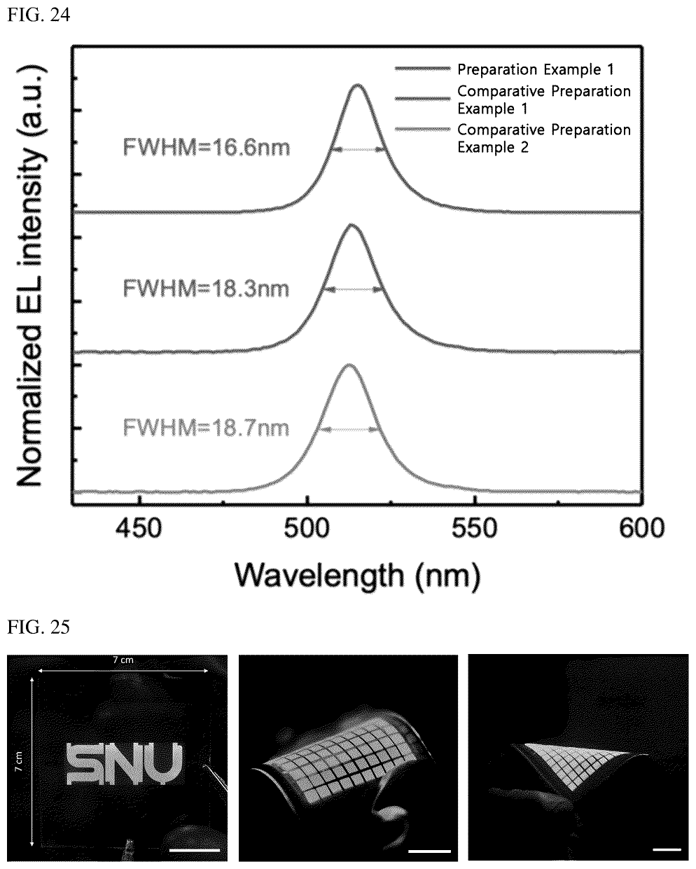

As a result, high phase-uniformity of the perovskite thin film was maintained, thereby maximizing light emission performance such as the light absorption performance and photoelectric conversion efficiency when used in solar cells or the photoluminescence efficiency and external quantum efficiency when used in light emitting devices. In addition, the light emission FWHM on the light emission spectrum may be very narrow. Hereinafter, the perovskite layered structure will be described with reference to FIGS. 9 and 10.

First, the perovskite layered structure according to the present disclosure includes both a first scaffold layer and a second scaffold layer. If both the first and second scaffold layers are not included, not only low-n-phase quasi-2D perovskite crystals but also 3D perovskite crystals are included in large amounts in the perovskite thin film (see FIG. 10), so that the light absorption performance and photoelectric conversion efficiency, the light emission performance and color purity, or the like may be extremely poor. This may be seen through the morphology of the perovskite thin film when the perovskite thin film is formed without a scaffold layer in FIG. 11.

For example, when perovskite crystals are grown directly on a substrate or a hole transport layer without a scaffold layer, molecules (e.g., benzylphosphonic acid) capable of forming quasi-2D crystals may not be first stacked on the substrate or the hole transport layer, and thus a large amount of 3D perovskite may be formed. In addition, the molecules capable of forming the quasi-2D crystals may be aggregated without being regularly arranged on the substrate or the hole transport layer, so that the thin film may become non-uniform.

The first scaffold layer according to the present disclosure may induce self-assembly of the second scaffold layer of the present disclosure. This is because the first scaffold layer forms an electrical dipole on a specific surface for reasons such as lattice matching or interface energy minimization, and the surface thereof becomes polar to form the first scaffold layer. For example, in the first scaffold layer including LiF, since LiF is an ion-binding material, Li⁺ and F⁻ ions in the lattice are crossed and located on the surface, and the acid functional groups of organic molecules of the second scaffold layer may react with Li⁺, so that the second scaffold layer may be self-assembled.

The first scaffold layer may include a metal halide. If the first scaffold layer includes the metal halide, the first scaffold layer may form regularly arranged ionic crystals, thereby strongly interacting with electrical dipoles or partial charges of the material included in the second scaffold layer, and the first scaffold layer may have an advantage in inducing self-assembly of the second scaffold layer. In particular, when applied to devices, the introduction of only the second scaffold layer may greatly reduce the degree of alignment of the second scaffold layer depending on the properties of various lower layers, but the introduction of both the first and second scaffolds may maintain the degree of alignment of the second scaffold layer by making the second scaffold layer strongly bound with the first scaffold layer regardless of a type of lower layer. Additionally, the surface potential of various second scaffold layers may be adjustable in binding with the first scaffold layer.

Preferably, when the metal halide included in the first scaffold layer is represented by MXₙ (n is an integer of 1 to 3), the M may be at least any one of Li, Na, K, Rb, Cs, Fr, Be, Mg, Ca, Sr, Ba, B, Ra, Al, Ga, In, Ti, Sn, and Pb, and the X may be at least one of F, Br, Cl, and I. Preferably, the M may be at least one of Li, Na, K, Rb, Cs, Fr, Be, Mg, Ca, Sr or Ba. When the M is in Group 1 or Group 2, the M has strong cationic properties so that the first scaffold layer exhibits strong ionicity, thereby more strongly self-assembling the second scaffold layer.

The thickness of the first scaffold layer may be 0.1 to 10 nm. Specifically, the thickness may be 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 6, 7, 8, 9 or 10 nm. The forming of the thickness of the first scaffold layer to be less than 0.1 nm may not be realized in consideration of the length, size, and the like of materials constituting the first scaffold layer, and if the thickness of the first scaffold layer is in the range described above, the first scaffold layer may maintain a monomolecular layer level, and thus may be good in terms of optical performance such as transmittance and the like. On the other hand, if the thickness of the first scaffold layer exceeds 10 nm, the optical performance may decrease, and many raw materials may be used, so that the production cost may increase.

Next, the second scaffold layer of the present disclosure will be described.

The second scaffold layer may crystallize the perovskite thin film into a high n-phase quasi-2D structure. If the perovskite thin film is formed without the second scaffold layer, a thin film in which a high n-phase and a low n-phase are mixed is formed because the surface on which perovskite crystals grow is non-uniform even if the formation conditions of the thin film are variously adjusted, and thus it may be disadvantageous in the light absorption performance and the photoelectric conversion efficiency or the light emission performance and the FWHM, the color purity, and the like of the perovskite thin film. In particular, an adsorption coefficient between each precursor of the perovskite and a ligand may be greatly varied, and thus, even if the deposition rate and the like of each precursor of the perovskite and the ligand are finely adjusted, there is inevitably a portion that is deposited locally non-uniformly. As a result, a low-n phase may be dominantly formed in the case where the perovskite crystals grow at a portion where the content of the ligand is relatively high or a specific precursor of the perovskite is included in a small amount.

The second scaffold layer may include an organic molecule containing an acid functional group for self-assembly of the second scaffold layer. For example, when the first scaffold layer includes a metal halide, the acid functional group of the organic molecule may substitution-react with the halogen of the metal halide to be self-assembled on the first scaffold layer.

The acid functional group may be at least any one of a carboxylic acid group (—COOH), a hydroxyl group (—OH), a sulfonic acid group (—SO₃H), a sulfuric acid group (—OSO₃H), a thiol group (—SH), and a phosphoric acid group (—PO₃H₂, —PO₄H₂).

The organic molecule may include an aromatic group. When the organic molecule contains the aromatic group, the self-assembly of the second scaffold layer may be enhanced by T-T stacking, and it may be advantageous in charge transfer due to an electron resonance structure, and there is an advantage that the second scaffold layer is self-assembled by exposing a hydrophobic head group of the organic molecule onto the substrate, and thus the perovskite crystallization is slowed down and a thin film having a uniform grain size may be manufactured by forming a large amount of small crystal seeds.

The aromatic group may include 1 to 5 aromatic rings, but is not limited thereto. For example, the aromatic group may be benzene, naphthalene, anthracene, fluorene, pyrene, chrysene, carbazole, and derivatives thereof. If the number of aromatic rings is 6 or more, the synthesis difficulty of the organic molecule may increase, the structure may become unstable, and the self-assembly effect may decrease. In addition, formation of monolayers and uniform coverage may be difficult because of excessive steric hindrance due to the large volume.

Further, referring to FIG. 14, when the metal halide is included in the first scaffold layer, the aromatic group may be covalently bonded to the metal of the metal halide when a substitution reaction between the metal halide and the acid functional group occurs. Accordingly, the second scaffold layer may be strongly fixed to the first scaffold layer.

In addition, when P is an aromatic group containing 1 to 5 aromatic rings, Q is a C1 to C10 hydrocarbon, and R is an acid functional group, the organic molecule may be P—R or P-Q-R. When the organic molecule has such a structure, the self-assembly effect and durability on the first scaffold layer are increased, and charge transfer may be excellent due to an electron resonance structure. If the Q is a hydrocarbon of C11 or higher, the organic molecule may become too long, resulting in a problem of self-assembly.

Specifically, the organic molecule may be at least any one of benzoic acid, 4-methylbenzoic acid, 4-vinylbenzoic acid, phenylacetic acid, 3-phenylpropionic acid, 5-phenylvaleric acid, 1-naphthoic acid, 2-naphthoic acid, 9-anthracene carboxylic acid, 2-fluorene carboxylic acid, 1-pyrene carboxylic acid, 3-chrysene carboxylic acid, 3-carbazole carboxylic acid, phenol, 4-methylphenol (p-cresol), 4-vinylphenol, 1-naphthol, 2-naphthols, anthracenol, fluorenol, pyrenol, chrysenol, carbazolol, benzenesulfonic acid, toluene sulfonic acid, naphthalene-2-sulfonic acid, anthracene sulfonic acid, fluorene sulfonic acid, pyrene sulfonic acid, chrysene sulfonic acid, carbazole sulfonic acid, phenyl sulfate, naphthyl sulfate, benzenethiol, toluenethiol, naphthalenethiol, anthracenethiol, fluorenethiol, pyrenethiol, chrysenethiol, carbazole thiol, phenylphosphonic acid, benzylphosphonic acid, naphthalenylphosphonic acid, anthracenylphosphonic acid, fluorenylphosphonic acid, pyrenylphosphonic acid, chrysenylphosphonic acid, carbazolylphosphonic acid, phenylphosphoric acid, 1-naphthyl phosphate and their derivatives, but is not limited thereto.

In this case, the benzylphosphonic acid may be at least one of benzylphosphonic acid (BPA), 4-bromobenzylphosphonic acid (Br-BPA), pentafluorobenzylphosphonic acid (pentaF-BPA), 4-vinylbenzylphosphonic acid, 3-methoxybenzylphosphonic acid, 4-methylbenzylphosphonic acid, 4-fluorobenzylphosphonic acid, 4-nitrobenzylphosphonic acid, 4-chlorobenzylphosphonic acid, 4-trifluoromethylbenzylphosphonic acid, 3,5-dimethylbenzylphosphonic acid and 2-phenylethylphosphonic acid, but is not limited thereto.

In addition, the carbazolephosphonic acid may be at least one of 2-(9H-carbazol-9-yl)ethyl)phosphonic acid (2PACz), 2-(3-bromo-9H-carbazol-9-yl)ethyl)phosphonic acid (Br-2PACz), 3-(9H-carbazol-9-yl) propyl)phosphonic acid (3PACz), 4-(9H-carbazol-9-yl)butyl)phosphonic acid (4PACz), 4-(3-bromo-9H-carbazol-9-yl)butyl)phosphonic acid (Br-4PACz), 2-methyl-2-(9H-carbazol-9-yl)ethyl)phosphonic acid (Me-2PACz), 4-(9H-carbazol-9-yl)-2-methylbutyl)phosphonic acid carbazolylphosphonic (Me-4PACz), acid (CzPA), 9-phenylcarbazolephosphonic acid, 3,6-dimethyl-9-(4-phosphonobutyl) carbazole, 3,6-di-tert-butyl-9-(4-phosphonobutyl) carbazole, 9-(4-phosphonobutyl) carbazole, 9-(3-phosphonopropyl) carbazole, N-phenylcarbazolephosphonic acid and 9-(4-phosphonobutyl)-3,6-dimethoxycarbazole, but is not limited thereto.

Referring to FIG. 12, in the second scaffold layer, the surface in a direction toward the perovskite thin film may be negatively charged, which may vary depending on a type of material included in the first or second scaffold layer and thus is not limited thereto. Specifically, the mean surface potential of the negatively charged surface may be −500 to −50 mV. For example, the surface potential may be −500, −490, −480, −470, −460, −450, −440, −430, −420, −410, −400, −390, −380, −370, −360, −350, −340, −330, −320, −310, −300, −290, −280, −270, −260, −250, −240, −230, −220, −210, −200, −190, −180, −170, −160, −150, −140, −130, −120, −110, −100, −90, −80, −70, −60 and −50 mV.

Further, as may be seen in FIG. 13, in the second scaffold layer, the root mean square roughness (Rq) in the direction toward the perovskite thin film may be 4 nm or less. For example, the Rq may be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9 or 4.0 nm. On the other hand, if the Rq exceeds 4 nm, the phase uniformity of the perovskite thin film formed on the second scaffold layer may be lowered, and thus a problem of poor color purity may occur when the thin film is applied to a light emitting device.

Meanwhile, the thickness of the second scaffold layer may be 0.4 to 10 nm. Specifically, the thickness may be 0.4, 0.5, 0.6, 0.7, 0.8, 0.9, 1.0, 1.5, 2.0, 2.5, 3.0, 3.5, 4.0, 4.5, 5.0, 6, 7, 8, 9 or 10 nm. The forming of the thickness of the second scaffold layer to be less than 0.4 nm may not be realized in consideration of the length, size, and the like of materials constituting the second scaffold layer, and if the thickness of the second scaffold layer is in the range described above, the second scaffold layer may maintain a monomolecular layer level, and thus may be good in terms of optical performance such as transmittance and the like. On the other hand, if the thickness of the second scaffold layer exceeds 10 nm, the optical performance may decrease, and many raw materials may be used, and thus the production cost may increase.

Furthermore, when the perovskite layered structure of the present disclosure includes both the first scaffold layer and the second scaffold layer, the second scaffold layer is self-assembled and as a result, quasi-2D low n-phase perovskite crystal growth may be suppressed in a perovskite thin film so as to have high phase uniformity. If either the first scaffold layer or the second scaffold layer is not included, high phase uniformity may not be maintained, and the optical performance of the layered structure may be deteriorated.

In addition, the perovskite layered structure may further include an additional scaffold layer between the second scaffold layer and the perovskite thin film, and in the additional scaffold layer may be formed of multiple layers, the same layers as the first scaffold layer and the same layers as a second scaffold layer are alternately stacked several times. As a result, the perovskite layered structure may form a multi-layer (Multi) scaffold structure.

When the same layer as the first scaffold layer is referred to as an A layer and the same layer as that of the second scaffold layer is referred to as a B layer, a layer including one A layer and one B layer may be represented as an AB layer. In this case, the additional scaffold layer may include 1 to 5 AB layers, but is not limited thereto. On the other hand, the last layer to be stacked may be layer B.

A perovskite thin film according to the present disclosure will be described.

The perovskite thin film may include perovskite crystals, and the perovskite crystals may have a structure such as ABX₃ (3D crystal structure), A₄BX₆ (0D crystal structure) AB₂X₅ (2D crystal structure), A₂BX₄ (2D crystal structure), A₂BX₆ (0D crystal structure), A₂B⁺B³⁺X₆ (3D crystal structure), A₃B₂X₉ (2D crystal structure) or A′₂Aₘ₋₁BₘX₃ₘ₊₁ (qausi-2D crystal structure) (m is an integer between 2 and 6). However, since the perovskite thin film of the present disclosure is formed on the second scaffold layer, most perovskite crystals included in the perovskite thin film may have the qausi-2D crystal structure.

At this time, the A may be a monovalent organic cation, a monovalent inorganic cation, or a combination thereof. Examples of A include (CₓH₂ₓ₊₁NH₃)⁺, (C₆H₅CₓH₂ₓ₊₁NH₃)⁺, (CH(NH₂)₂)⁺, (CₓH₂ₓ(NH₃)₂)⁺ (NH₄)⁺, (NF₄)⁺, (NCl₄)⁺, (N(CₓH₂ₓ₊₁)₄)⁺, ((CₓH₂ₓ₊₁)₂NH₂)⁺, (C4H₁₀N)⁺, (C₃H₅N₂)⁺, (PH₄)⁺, (PF₄)⁺, (C(NH₂)₃)⁺, (PCl₄)⁺, ((CₓH₂ₓ₊₁)ₙNH₃)₂(CHNH₃)ₙ⁺, (CF₃NH₃)⁺, ((CₓF₂ₓ₊₁)ₙNH₃)₂(CFNH₃)ₙ⁺, ((CₓF₂ₓ₊₁)ₙNH₃)ₙ⁺, (CH₃PH₃)⁺, (CH₃AsH₃)⁺, (CH₃SbH₃)⁺, (AsH₄)⁺ (SbH₄)⁺, monovalent alkali metal ions (n is an integer of 1 to 100, and x is an integer of from 1 to 100), or a combination thereof. Preferably, A may be a monovalent alkali metal ion, and more preferably, A may be Cs⁺.

The A′ is not particularly limited in the present disclosure since there is no limitation as long as the material is any material capable of forming a quasi-2D crystal structure. For example, the A′ may be the following organic ligand.

In addition, the B is a metal ion, preferably B may be a divalent metal ion, a monovalent metal ion, a trivalent metal ion, or a combination thereof, and more preferably B may be divalent Pb. In addition, the X may be F⁻, Cl⁻, Br⁻, I⁻ or a combination thereof, preferably X may be a single halogen anion other than a combination, and more preferably X may be Br—.

The perovskite thin film may further include an organic ligand. As a result, surface defects of the perovskite thin film may be suppressed, stability against moisture, oxygen, and the like is increased, and perovskite nucleation and crystal growth may be controlled to induce a uniform grain size distribution. In addition, strong ligand-perovskite bonds may physically interfere with the diffusion of halide ions or metal ions, thereby reducing hysteresis and device degradation due to voltage stress or changes in charge distribution during light irradiation. In addition, the ligand-perovskite bonds inhibit pyrolysis or radical reaction of the ligands to slow down the breakdown of the perovskite structure even under ultraviolet irradiation or a high-temperature environment, thereby improving the lifetime of an optoelectronic device including such perovskite.

The organic ligands are not particularly limited as long as the organic ligands may be used to form perovskite crystals. For example, the organic ligand may be an amine-based ligand, an organic acid-based ligand, an organoammonium based ligand, and combinations thereof.

Specifically, the amine-based ligand may be selected from N,N-diisopropylethylethylamine, ethylenediamine, hexamethylenediamine, methylamine, N,N,N,N-tetramethylenediamine, triethylamine, diethanolamine, 2,2-(ethylenedioxyl)bis-(ethylamine), but is not limited thereto.

In addition, the organic acid-based ligand may be at least any one of benzoic acid, 4-methylbenzoic acid, 4-vinylbenzoic acid, phenylacetic acid, 3-phenylpropionic acid, 5-phenylvaleric acid, 1-naphthoic acid, 2-naphthoic acid, 9-anthracene carboxylic acid, 2-fluorene carboxylic acid, 1-pyrene carboxylic acid, 3-chrysene carboxylic acid, 3-carbazole carboxylic acid, phenol, 4-methylphenol (p-Cresol), 4-vinylphenol, 1-naphthol, 2-naphthols, anthracenol, fluorenol, pyrenol, chrysenol, carbazolol, benzenesulfonic acid, toluene sulfonic acid, naphthalene-2-sulfonic acid, anthracene sulfonic acid, fluorene sulfonic acid, pyrene sulfonic acid, chrysene sulfonic acid, carbazole sulfonic acid, phenyl sulfate, naphthyl sulfate, benzenethiol, toluenethiol, naphthalenethiol, anthracenethiol, fluorenethiol, pyrenethiol, chrysenethiol, carbazole thiol, phenylphosphonic acid, benzylphosphonic acid, naphthalenylphosphonic acid, anthracenylphosphonic acid, fluorenylphosphonic acid, pyrenylphosphonic acid, chrysenylphosphonic acid, carbazolylphosphonic acid, phenylphosphoric acid, 1-naphthyl phosphate and their derivatives, but is not limited thereto. In this case, the benzylphosphonic acid and the carbazolephosphonic acid are as described above.

In addition, the organoammonium-based ligand is a ligand having an alkyl-X structure, and the alkyl is selected from acylic alkyls (CₙH₂ₙ₊₁); polyhydric alcohols (CₙH₂ₙ₊₁OH) including primary alcohols, secondary alcohols, and tertiary alcohols; alkylamines (alkyl-N) including hexadecyl amine, 9-octadecenylamine, 1-amino-9-octadacene (C₁₉H₃₇N); p-substituted aniline, phenyl ammonium and fluorine ammonium, in which X may be Cl, Br or I.

The organic ligand may be in a fluorinated form. For example, the organic ligand may be 2-fluorophenylbornic acid, 3,5-diformyl-2-fluorophenylboronic acid, 3-chloro-4-fluorophenylboronic acid, 4-cyano-3-fluprpbenzoic acid, L-Fmoc-3-fluorophenylalanine, L-Fmoc-4-fluorophenylalanine, methyl 6-fluorochromone-2-carboxylic acid, 4-fluorobenzoic acid, 2-fluorobenzoic acid, 2-fluorobenzyl amine, 2-fluorocinnamicacid, 2-fluorophenyl isothiocyanate, 4-fluorobenzenesulfonic acid, 4-flurobenzylamine, 4-fluorophenyl isothiocyanate, 4-fluorophenylacetic acid, fluorocinnamic acid, (3-fluoro-4-methylphenyl) acetic acid, (3-fluoro-5-isopropoxyphenyl) boronic acid, (3-fluoro-5-methoxycarbonylphenyl) boronic acid, (3-fluoro-5-methylphenyl) boronic acid, (4-fluoro-2-methoxyphenyl)oxoacetic acid, (4-fluoro-3-methoxyphenyl) acetic acid, (4-fluoro-3-methoxyphenyl) boronic acid, and combinations thereof, but is not limited thereto.

In addition, preferably, the fluorinated organic compound may be in the form of a perfluorinated compound. The perfluorinated compound may be perfluorinated alkyl halides, perfluorinated aryl halide, fluorochloroalkene, perfluoroalcohol, perfluoamine, perfluorocarboxylic acid, perfluorosulfonic acid, or derivatives thereof, but is not limited thereto.

The perfluorinated alkyl halides and the perfluorinated aryl halide may be trifluoroiodomethane, pentafluoroethyl iodide, perfluorooctyl bromide (perflubron), dichlorodifluoromethane, and derivatives thereof, but are not limited thereto.

The fluorochloroalkene may be chlorotrifluoroethylene, dichlorodifluoroethylene, and derivatives thereof, but is not limited thereto.

The fluorochloroalkene may be chlorotrifluoroethylene, dichlorodifluoroethylene, and derivatives thereof, but is not limited thereto.

The perfluorocarboxylic acid may be trifluoroacetic acid, heptafluorobutryric acid, pentafluorobenzoic acid, perfluorooctanoic acid, perfluornonanoic acid, and derivatives thereof, but is not limited thereto.

The perfluorosulfonic acid may be triflic acid, perfluorobuanesulfonic acid, perfluorobutane sulfonamide, perfluorooctanesulfonic acid and derivatives thereof, but is not limited thereto.

Meanwhile, the organic ligand may be the same as the organic molecule included in the second scaffold layer described above. As a result, the lattice strain of the perovskite thin film may be reduced.

Referring to FIGS. 15 and 16, in the perovskite thin film, the root mean square roughness (Rq) of at least one surface may be 10 nm or less, and preferably 5 nm or less. For example, the Rq may be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.2, 2.4, 2.6, 2.8, 3.0, 3.2, 3.4, 3.6, 3.8, 4.0, 4.5, 5.0, 6.0, 7.0, 8.0, 9.0 or 10.0 nm. If the Rq is more than 5 nm, this means that the phase uniformity of the perovskite thin film is low, so that the light absorption performance and the photoelectric conversion efficiency may be low, or the light emission performance, the color purity, and the like may be low, and a leakage current problem may occur because a perovskite thin film portion formed non-uniformly has a low resistance value.

In addition, the thickness of the perovskite thin film may be 1 to 1000 nm, but is not limited thereto. For example, the thickness of the perovskite thin film may be 1, 2, 3, 4, 5, 6, 7, 8, 9, 10, 20, 30, 40, 50, 60, 70, 80, 90, 100, 200, 300, 400, 500, 600, 700, 800, 900, or 1000 nm.

As shown in FIG. 17, in the perovskite thin film, (002)ₙ₌₁ and (012)_{0D} peaks may not be shown in a Grazing Incident Wide Angle X-ray Scattering (GIWAXS) Z-direction graph. That is, this may mean that the perovskite thin film is mostly composed of high n-phase quasi-2D perovskite crystals, and hardly contains low n-phase quasi-2D perovskite crystals. Referring to FIGS. 16 and 18, since the perovskite thin film hardly contains low n-phase quasi-2D perovskite crystals, very high phase uniformity is maintained, and light absorption performance or light emission performance may be maximized.

Referring to FIG. 19, when the perovskite thin film is applied to a light emitting device, the perovskite thin film may have a full width at half maximum (FWHM) on the light emission spectrum of 20 nm or less, preferably 18 nm or less. As such, the perovskite thin film of the present disclosure may have a very low FWHM to have very good color purity when applied to an optoelectronic device.

Further, referring to FIG. 20, when the perovskite thin film is applied to a light emitting device, the perovskite thin film may have a photoluminescence mean lifetime (t) of 180 ns or more, preferably 190 ns or more. Accordingly, the perovskite thin film of the present disclosure may have excellent light emission performance.

Further, as shown in FIG. 21, when the perovskite thin film is applied to the light emitting device, the perovskite thin film may have photoluminescence quantum efficiency (PLQY) of 70% or more, preferably 80% or more, and more preferably 85% or more at a power density of 0.1 to 10 mW/cm².

In order to solve the problems, there is provided a method for manufacturing a perovskite layered structure, the method including: (1) forming a first scaffold layer on a substrate; (2) forming a second scaffold layer on the first scaffold layer; and (3) depositing a perovskite thin film on the second scaffold layer.

As a result, the perovskite layered structure may be manufactured in a large area, in which low n-phase quasi-2D perovskite crystal growth is suppressed in the perovskite thin film to have high phase uniformity, and excellent light emission performance or excellent light absorption performance and photoelectric conversion efficiency are maintained.

In the method for manufacturing the perovskite layered structure, the first scaffold layer, the second scaffold layer, and the perovskite thin film are as described above, and therefore, duplicated contents will be omitted in the description of the following manufacturing method.

First, in step (1), a first scaffold layer is formed on a substrate.

The substrate is not particularly limited in the present disclosure because the substrate may be made of a material having a transparent property or a material having a flexible property as a support. For example, the substrate may be glass, polycarbonate (PC), polyethylene terephthalate (PET), polyethylene naphthalate (PEN), polyimide (PI), polypropylene (PP), or metal substrate.

The first scaffold layer may be formed directly on the substrate, and may also be formed on another type of layer, for example, a hole transport layer, a hole injection layer, an electron transport layer, an electron injection layer, or the like, when another type of layer is present on the substrate. In the present disclosure, a lower layer on which the first scaffold layer is formed is not particularly limited.

The first scaffold layer may be formed in a deposition process and/or a solution process. For example, the deposition process may be any conventional deposition process used in the art, such as a thermal evaporation process, a vacuum deposition process, an atomic layer deposition (ALD) process, a chemical vapor deposition (CVD) process, and a physical vapor deposition (PVD) process. The solution process may be any general solution process used in the industry, such as a spin coating process, a slot die coating process, a blade coating process, a printing coating process, a gravure coating process, a spray coating process, and a Mayer Rod Coating process. Preferably, the first scaffold layer may be formed by a deposition process, more preferably a thermal deposition process.

When the first scaffold layer is formed by the deposition process, its deposition rate may be 0.01 to 0.5 Å/s. If the deposition rate exceeds 0.5 Å/s, the first scaffold layer may not be regularly arranged on the substrate and non-uniform aggregation of the raw materials may occur.

In the deposition of the first scaffold layer, other deposition conditions are not limited as long as the conditions are conditions that may be generally applied in the art.

Next, in step (2), a second scaffold layer is formed on the first scaffold layer formed in step (1).

The second scaffold layer may be formed in a deposition process and/or a solution process. For example, the deposition process may be any conventional deposition process used in the art, such as a thermal evaporation process, a vacuum deposition process, an atomic layer deposition (ALD) process, a chemical vapor deposition (CVD) process, and a physical vapor deposition (PVD) process. The solution process may be any general solution process used in the industry, such as a spin coating process, a slot die coating process, a blade coating process, a printing coating process, a gravure coating process, a spray coating process, and a Mayer Rod Coating process. Preferably, the second scaffold layer may be formed by a deposition process, more preferably a thermal deposition process.

When the second scaffold layer is formed by the deposition process, its deposition rate may be 0.01 to 0.5 Å/s. If the deposition rate exceeds 0.5 Å/s, the first scaffold layer may not be regularly arranged on the substrate and non-uniform aggregation of the raw materials may occur.

In the deposition of the second scaffold layer, other deposition conditions are not limited as long as the conditions are conditions that may be generally applied in the art.

Next, in step (3), a perovskite thin film is deposited on the second scaffold layer formed in step (2).

In the step (3), the deposition may be any deposition process capable of forming a perovskite thin film, and may be any general deposition process used in the art, such as a thermal evaporation process, a vacuum deposition process, an atomic layer deposition (ALD) process, a chemical vapor deposition (CVD) process, and a physical vapor deposition (PVD) process.

In step (3), the deposition may be performed using a perovskite double source or triple source. In this case, the perovskite double source or triple source means a source which is a direct raw material of the perovskite crystals. For example, when CsPbB₃ crystals are deposited, a CsBr source and a PbBr₂ source may be referred to as a perovskite double source. In the case of using the perovskite double source, the perovskite crystal phase may be finely controlled.

In addition, when deposited with the double source, the deposition rate ratio of the perovskite double source may be 1:0.4 to 2.5, but is not limited thereto. Preferably, the deposition rate of the perovskite double source may be 0.05 to 5 Å/s, respectively.

In addition, when deposited with the triple source, the deposition rate ratio of each source may be applied without limitation as long as the deposition rate ratio is any known deposition rate ratio, and therefore, in the present disclosure, it is not particularly limited. Preferably, the deposition rate of the perovskite triple source may be 0.05 to 5 Å/s, respectively.

During the deposition, an organic ligand source may be further used. Accordingly, the perovskite thin film may include an organic ligand, and the duplicated content of the organic ligand is the same as the content of the organic ligand described above, and thus the content thereof will be omitted.

The deposition rate of the organic ligand source may be 0.1 to 10 times higher than the deposition rate of at least any one of the perovskite double source or triple source, but is not particularly limited. Preferably, the deposition rate of the organic ligand source may be 0.05 to 5 Å/s, respectively.

On the other hand, in the deposition in step (3), other deposition conditions are not particularly limited in the present disclosure as long as the deposition conditions are conditions that may be generally applied in the art. For example, the temperature of the source may be 100 to 1000° C., respectively.

Further, in step (3), an additional scaffold layer may be further formed on the second scaffold layer before depositing the perovskite thin film. As a result, a multi-layer (Multi) scaffold structure may be formed.

The additional scaffold layer may be formed by alternately stacking the same layers as the first scaffold layer and the same layers as the second scaffold layer, and preferably the same layers as second scaffold layer may be formed last. At this time, the additional scaffold layer may be formed in the same manner as the first scaffold layer and the second scaffold layer.

In addition, the additional scaffold layer may be, but is not limited to, 2 to 10 layers. For example, the same layers as the first scaffold layer may be 1 to 5 layers, and the same layers as second scaffold layer may be 1 to 5 layers.

In order to solve the problems, there is provided an optoelectronic device including the perovskite layered structure. Such an optoelectronic device maximizes light emission performance or light absorption performance, photoelectric conversion efficiency, and the like, and has a low turn-on voltage.

Hereinafter, the optoelectronic device of the present disclosure will be described with reference to FIGS. 22 and 25.

The optoelectronic device may include a substrate, an anode, a hole transport layer, a perovskite layered structure, an electron transport layer, and a cathode, and preferably may be arranged in the order of the anode, the hole transport layer, the perovskite lamination structure, the electron transport layer and the cathode. On the other hand, it is not intended to exclude other configurations between the respective layers. For example, no other configuration is excluded between the anode and the hole transport layer.

In addition, the optoelectronic device may additionally include an electron injection layer and/or a hole injection layer. If the optoelectronic device further includes the electron injection layer and the hole injection layer, the optoelectronic device may be arranged in the order of the anode, the hole injection layer, the hole transport layer, the perovskite lamination structure, the electron transport layer, the electron injection layer and the cathode.

In addition, the thickness of each of the anode, the hole transport layer, the electron transport layer, the cathode, the electron injection layer, and the hole injection layer may be 1 to 1000 nm, but needs not be particularly the same. For example, the thickness thereof may be 1, 2, 3, 4, 5, 6, 7, 8, 9, 10, 20, 30, 40, 50, 60, 70, 80, 90, 100, 200, 300, 400, 500, 600, 700, 800, 900, or 1000 nm.

The anode may include, but is not limited to, a conductive material. Specifically, the anode may be a conductive polymer such as indium tin oxide (ITO), fluorine tin oxide (FTO), antimony tin oxide (ATO), tin oxide (SnO₂), zinc oxide (ZnO), molybdenum oxide (MoO₃), a metal, a metal alloy, a carbon material, or poly(3-methylthiophene), poly(3,4-(ethylene-1,2-dioxy)thiophene) (PEDT), polypyrole, and polyaniline.

In addition, the electron transport layer may be any one or more selected from CN-T2T (see the following Chemical Formula), bis-4,6-(3,5-di-3-pyridylphenyl)-2-methylpyrimi-dine (B3PYMPM), 2,2′,2″-(1,3,5-benzenetriyl)tris-[1-phenyl-1Hbenzimidazole] (TPBi), tris(8-quinolinolate)aluminum (Alq3), perfluorinated compound (PF-6P), 4,7-diphenyl-1,10-phenanthroline (Bphen), diphenylphosphineoxide-4-(triphenylsilylyl)phenyl (TSPO1) and 1,3,5-tri (N-phenylbenzimidazol-2-yl)benzene (TPBI) or metal oxides composed of ZnO, TiO₂, SnO, SnO₂, SrTiO₃, BaTiO₃, and the like, but is not limited thereto.

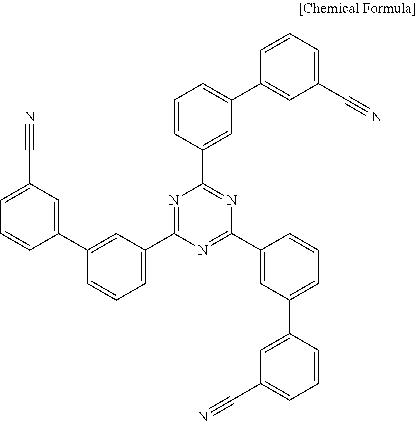 [SMILES: N#Cc1cccc(-c2cccc(-c3nc(-c4cccc(-c5cccc(C#N)c5)c4)nc(-c4cccc(-c5cccc(C#N)c5)c4)n3)c2)c1]

In addition, the hole transport layer may be at least any one selected from poly(9-vinylcarbazole) (PVK), poly(4-butylphenyl-diphenyl-amine) ([Poly-TPD], poly(p-phenylene sulfide), poly(p-phenylene vinylene) (PPV), poly(3-methylthiophene), polypyrrole, 1,3-bis(carbazol-9-yl)benzene (MCP), 1,3,5-tris(carbazol-9-yl)benzene (TCP), 4,4′,4″-tris(carbazol-9-yl)triphenylamine (TCTA), N,N′-bis(naphthalen-1-yl)-N,N′-bis(phenyl)-benzidine (NPB), N,N′-bis(naphthalen-2-yl)-N,N′-bis(phenyl)-benzidine (β-NPB), N,N′-bis(naphthalen-1-yl)-N,N′-bis(phenyl)-2,2′-dimethylbenzidine («-NPD), di-[4, —(N,N-ditolyl-amino)-phenyl]cyclohexane (TAPC), N,N,N′,N′-tetra-naphthalen-2-yl-benzidine (β-TNB), and N4,N4,N4′,N4′-tetra(biphenyl-4-yl) biphenyl-4,4′-diamine (TPD15), poly(9,9-dioctylfluorene-co-bis-N,N′-(4-butylphenyl)-bis-N,N′-phenyl-1,4-phenylenediamine) (PFB), poly(9,9′-dioctylfluorene-co-N-(4-butylphenyl)diphenylamine) (TFB), poly(9,9′-dioctylfluorene-co-bis-N,N′-(4-butylphenyl)-bis-N,N′-phenylbenzidine) (BFB), poly(9,9-dioctylfluorene-co-bis-N,N′-(4-methoxyphenyl)-bis-N,N′-phenyl-1,4-phenylenediamine) (PFMO), TAPC (4,4′-Cyclohexylidenebis[N,N-bis(4-methylphenyl)benzenamine]), CBP (4,4′-Bis(N-carbazolyl)-1,1′-biphenyl), mCBP (amorphous_4,4′-Bis(Ncarbazolyl)-1,1′-biphenyl), Spiro-OMeTAD (2,2′,7,7′-Tetrakis[N,N-di(4-methoxyphenyl)amino]-9,9′-spirobifluorene), Oxe-DCDPA (3,5-Di-9H-carbazol-9-yl-N,N-bis[4-[[6-[(3-ethyl-3-oxetanyl) methoxy]hexyl]oxy]phenyl]benzenamine), Poly-TPD (Poly[4-butylphenyl-diphenylamine]) and P-type metal oxides, but is not limited thereto.

Further, the cathode may be a metal or an alloy thereof, such as indium tin oxide (ITO), fluorine tin oxide (FTO), antimony tin oxide (ATO), tin oxide (SnO₂), zinc oxide (ZnO), molybdenum oxide (MoO₃), magnesium (Mg), calcium (Ca), sodium (Na), potassium (K), titanium (Ti), indium (In), yttrium (Y), lithium (Li), gadolinium (Gd), aluminum (Al), silver (Ag), tin (Sn), lead (Pb), cesium (Cs), barium (Ba), or the like, or may be a multilayered structure material, such as LiF/Al, LiO₂/Al, LiF/Ca, LiF/Al and BaF₂/Ca, but is not limited thereto.

In addition, the electron injection layer may include one or more metal oxides selected from aluminum doped zinc oxide (AZO), AZO doped with alkali metal (Li, Na, K, Rb, Cs, or Fr), TiOx (x is a real number of 1 to 3), indium oxide (In₂O₃), tin oxide (SnO₂), zinc oxide (ZnO), zinc tin oxide, gallium oxide (Ga₂O₃), tungsten oxide (WO₃), aluminum oxide, titanium oxide, vanadium oxide (V₂O₅, vanadium (IV) oxide (VO₂), V₄O₇, V₅O₉, or V₂O₃), molybdenum oxide (MoO₃ or MoOx), copper oxide (Copper (II) Oxide: CuO), nickel oxide (NiO), copper aluminium oxide (CAO, CuAlO₂), zinc rhodium Oxide (ZRO, ZnRh₂O₄), iron oxide, chromium oxide, bismuth oxide, indium-gallium zinc oxide (IGZO), and ZrO₂, but is not limited thereto.

In addition, the hole injection layer may include a hole injecting material. For example, the hole injection layer may include one or more of a metal oxide and a hole-injecting organic material. The metal oxide may include one or more metal oxides selected from the group consisting of MoO₃, WO₃, V₂O₅, nickel oxide (NiO), copper oxide (Copper (II) Oxide: CuO), copper aluminum oxide (CAO, CuAlO₂), zinc rhodium oxide (ZRO, ZnRh₂O₄), GaSnO, and GaSnO doped with metal-sulfide (FeS, ZnS, or CuS); and the hole-injecting organic material may include at least one selected from the group consisting of Fullerene (C₆₀), HAT-CN, F16CuPC, CuPC, m-MTDATA [4,4′,4″-tris(3-methylphenylphenylamino)triphenylamine], NPB [N,N′-Di(1-naphthyl)-N,N′-diphenyl-(1,1′-biphenyl)-4,4′-diamine)], TDATA, 2T-NATA, Pani/DBSA (Polyaniline/Dodecylbenzenesulfonic acid), PEDOT/PSS (Poly(3,4-ethylenedioxythiophene)/Poly(4-styrenesulfonate), Pani/CSA (Polyaniline/Camphor sulfonicacid), and PANI/PSS (Polyaniline)/Poly(4-styrenesulfonate), but are not limited thereto.

On the other hand, the optoelectronic device may be, for example, a solar cell, a light emitting device, a photodetector, or the like.

Referring to FIG. 23, when the optoelectronic device is the light emitting device, if the current density is 0.1 mA/cm², the external quantum efficiency (EQE) may be 10% or more, preferably 15% or more, and more preferably 20% or more.

In addition, as shown in FIG. 24, when the optoelectronic device is the light emitting device, the light emission FWHM in the light emission spectrum may be 18 nm or less, and more preferably 17 nm or less.

Hereinafter, the present disclosure will be described in more detail through the following Examples, but the following Examples do not limit the scope of the present disclosure, and should be interpreted as helping to understand the present disclosure.

### EXAMPLES

### Example 1

A sample stacked in the order of glass substrate/ITO (indium tin oxide, thickness: 70 nm)/MoO₃ (thickness: 5 nm)/NPB (N,N′-bis(naphthalen-1-yl)-N,N′,bis(phenyl)-benzidine, thickness: 60 nm) was prepared and fixed to a holder of a vacuum thermal depositor so that the deposition surface became NPB. Here, ITO was an anode, MoO₃ was a hole injection layer, and NPB was a hole transport layer.

Then, LiF was loaded on a tungsten boat of the vacuum thermal depositor, and then a first scaffold layer having a thickness of about 4 nm was formed at a deposition rate of 0.1 Å/s. At this time, the pressure of the vacuum thermal depositor was 2×10⁻⁷ Torr.

Thereafter, benzylphosphonic acid (BPA) was loaded into a crucible of the vacuum thermal depositor, and then a second scaffold layer having a thickness of about 3 nm was formed at a rate of 0.1 Å/s. At this time, the pressure of the vacuum thermal depositor was 5×10⁻⁶ Torr.

Next, CsBr, PbBr₂, and BPA were loaded into three crucibles of a vacuum thermal depositor, respectively, and then the deposition rates of CsBr, PbBr₂, and BPA were 1.66 Å/s, 1.43 Å/s and 1.1 Å/s, respectively to form a perovskite thin film having a thickness of 30 nm. At this time, the pressure of the vacuum thermal depositor was 5×10⁻⁶ Torr.

As a result, a perovskite layered structure including the first scaffold layer, the second scaffold layer, and the perovskite thin film was prepared on the NPB hole transport layer.

### Example 2

A sample stacked in the order of Glass substrate/ITO (thickness: 150 nm)/SnO₂ (thickness: 20 nm) was prepared and fixed to a holder of a vacuum thermal depositor so that the deposition surface became SnO₂. Here, ITO was a cathode, and SnO₂ was an electron transport layer.

A first scaffold layer and a second scaffold layer were formed in the same manner as in Example 1 described above.

Thereafter, a perovskite thin film was formed in the same manner as in Example 1 except that the thickness was 200 nm instead of 30 nm.

As a result, a perovskite layered structure including the first scaffold layer, the second scaffold layer, and the perovskite thin film was prepared on the SnO₂ electron transport layer.

### COMPARATIVE EXAMPLE

### Comparative Example 1

A perovskite thin film was formed in the same manner as in Example 1 except that the first scaffold layer and the second scaffold layer were not formed.

### Comparative Example 2

A perovskite thin film was formed in the same manner as in Example 1 except that the first scaffold layer was not formed.

### Comparative Example 3

A perovskite thin film was formed in the same manner as in Example 1 except that the second scaffold layer was not formed.

### Comparative Example 4

A glass substrate was fixed to the holder of the vacuum thermal depositor so that the deposition surface became a glass substrate. Thereafter, CsBr, PbBr₂, and BPA were loaded into three crucibles of the vacuum thermal depositor, respectively, and then the deposition rates of CsBr, PbBr₂, and BPA were 1.66 Å/s, 1.43 Å/s and 1.1 Å/s, respectively to form a perovskite thin film having a thickness of nm. At this time, the pressure of the vacuum thermal depositor was 5×10⁻⁶ Torr.

### Comparative Example 5

A perovskite thin film was formed in the same manner as in Comparative Example 4 except that a silicon wafer was used instead of the glass substrate.

### Comparative Example 6

A perovskite thin film was formed in the same manner as in Comparative Example 4 except that an NPB thin film was used instead of the glass substrate.

### Comparative Example 7

A perovskite thin film was formed in the same manner as in Comparative Example 4 except that poly(9-vinylcarbazole) (PVK) was used instead of the glass substrate.

### Comparative Example 8

A perovskite thin film was formed in the same manner as in Comparative Example 4 except that poly[4-butylphenyl-diphenylamine] (Poly-TPD) was used instead of the glass substrate.

### Comparative Example 9

A perovskite thin film was formed in the same manner as in Comparative Example 4 except that a GraHIL thin film having a mass ratio of [PEDOT:PSS]: [PFI] of 1:2 was used instead of the glass substrate.

### EXPERIMENTAL EXAMPLES

### Experimental Example 1: Scanning Electron Microscopy (SEM) Image

The morphology of the perovskite thin film was photographed using SEM equipment (FESEM, SIGMA).

The results for the perovskite thin films of Comparative Examples 4 to 9 were shown in FIG. 11. The results for the perovskite thin film of Comparative Example 1 were shown in (a) and (d) of FIG. 16, and the results for the perovskite thin film of Comparative Example 2 were shown in (b) and (e) of FIG. 16. In addition, the results for the perovskite thin film of Example 1 were shown in (c) and (f) of FIG. 16.

Referring to FIG. 11, when a perovskite thin film was deposited without a scaffold layer, it may be confirmed that the surface morphology thereof is non-uniform.

Referring to FIG. 16, it may be confirmed that in both Comparative Examples 1 and 2, the first scaffold layer was not present, and the surface morphology of the perovskite thin film is non-uniform. On the other hand, it may be seen that the perovskite thin film of Example 1 is deposited on the surface on which the first scaffold layer and the second scaffold layer are sequentially formed, and the surface morphology thereof is uniform.

### Experimental Example 2: Measurement of Surface Potential

The surface potential of a hole transport layer or a scaffold layer was measured using AFM equipment (NX-10, Park systems), before forming a perovskite thin film.

The results for the hole transport layer of Comparative Example 1 were shown in (a) of FIG. 12, the results for the second scaffold layer of Comparative Example 2 were shown in (b) of FIG. 12, and the results for the second scaffold layers of Example 1 were shown in (c) of FIG. 12. The mean surface potential was obtained from FIG. 12 and then shown in Table 5.

TABLE 5

| | Com. Ex. 1 | Com. Ex. 2 | Ex. 1 |
|---|---|---|---|
| | (hole transport | (second scaffold | (second scaffold |
| | layer) | layer) | layer) |
| Mean surface | −368 | 133 | −368 |
| potential | | | |
| [mV] | | | |

Referring to FIG. 12 and Table 5, the hole transport layer of Comparative Example 1 exhibited a negative charge as the NPB hole transport layer, and in Comparative Example 2, the second scaffold layer exhibited a positive charge because the first scaffold layer was not present. Specifically, the second scaffold layer of Comparative Example 2 included an organic molecule containing an aromatic group and an acid functional group, and the organic molecule had an electric dipole and was randomly disposed on the hole transport layer, so that the second scaffold layer in Comparative Example 2 was measured to be positively charged.

Meanwhile, in the case of Example 1, there is the first scaffold layer regularly arranged on the hole transport layer, so that the second scaffold layer is self-assembled on the first scaffold layer, and the organic molecule of the second scaffold layer substitution-reacts with the metal halide of the first scaffold layer and thus the net dipole of the entire scaffold corresponds to almost 0, and the surface potential of the NPB hole transport layer under the scaffold layer is measured. Accordingly, in Example 1, it may be seen that there are the first scaffold layer and the second scaffold layer, in which the first scaffold layer is in a regularly arranged state, and the second scaffold layer is in the self-assembled state.

### Experimental Example 3: Measurement of Surface Roughness Rq

The surface roughness of a hole transport layer or a scaffold layer was measured, or the roughness of a perovskite thin film was measured using AFM equipment (NX-10, Park systems), before forming the perovskite thin film.

The results for the hole transport layer of Comparative Example 1 were shown in (a) of FIG. 13, the results for the second scaffold layer of Comparative Example 2 were shown in (b) of FIG. 13, and the results for the second scaffold layers of Example 1 were shown in (c) of FIG. 12. The mean surface roughness Rq was obtained from FIG. 13 and then shown in Table 6.

The results for the perovskite thin film of Comparative Example 1 were shown in (a) of FIG. 15, the results for the perovskite thin film in Comparative Example 2 were shown in (b) of FIG. 15, and the results for the perovskite thin film in Example 1 were shown In (c) of FIG. 15. The mean surface roughness Rq was obtained from FIG. 15 and then shown in Table 7.

TABLE 6

| | Com. Ex. 1 | Com. Ex. 2 | Ex. 1 |
|---|---|---|---|
| | (hole transport | (second scaffold | (second scaffold |
| | layer) | layer) | layer) |
| Mean surface | 5.193 | 1.235 | 1.917 |
| roughness | | | |
| [nm] | | | |

TABLE 7

| | Com. Ex. 1 | Com. Ex. 2 | Ex. 1 |
|---|---|---|---|
| | (perovskite | (perovskite | (perovskite |
| | thin film) | thin film) | thin film) |
| Mean surface | 5.603 | 6.837 | 3.597 |
| roughness | | | |
| [nm] | | | |

First, referring to Table 6 and FIG. 13, the hole transport layer of Comparative Example 1 had the mean surface roughness Rq of 5.193 nm, and it may be confirmed that the surface roughness is reduced when the scaffold layer is deposited thinly like Comparative Example 2 and Example 1. When the surface roughness is reduced as such, there is a high possibility that the perovskite thin film is uniformly deposited on the scaffold layer, and as a result, the light emission efficiency of the perovskite thin film may be improved.

Referring to Table 7 and FIG. 15, in Comparative Example 1, the mean surface roughness was measured to be 5 nm or more, which means that in Comparative Example 1, the surface roughness of the perovskite thin film was measured to be high as the BPA contained in the perovskite thin film was randomly aggregated on the hole transport layer because the scaffold layer was not present. Similarly, even in Comparative Example 2, the mean surface roughness was measured to be 5 nm or more, which was because the second scaffold layer of Comparative Example 2 was not formed on the first scaffold layer, and then not self-assembled, so that the second scaffold layer was formed non-uniformly, and as a result, BPA contained in the perovskite thin film was not appropriately deposited, so that low n-phase quasi-2D perovskite crystals and high n-phase quasi-2D perovskite crystals were mixed. In contrast, in Example 1, the first scaffold layer was present, and the second scaffold layer was formed by self-assembly, so that a low n-phase quasi-2D crystal phase was suppressed in the perovskite thin film to constantly form a constant high n-phase quasi-2D crystal phase, and eventually, the surface roughness was measured to be low.

### Experimental Example 4: X-Ray Photoelectron Spectroscopy (XPS) Analysis

XPS analysis was performed using XPS equipment (VersaProbe III, UIVAC-PHI), and through this, binding energy was measured for each element of the scaffold layer.

The XPS analysis was performed for the scaffold layers of Comparative Examples 2 and 3, and Example 1, and the results were shown in FIG. 14.

Referring to (a) and (b) of FIG. 14, it may be seen that peaks of Li 1s and P 2p of the scaffold layer of Example 1 were shifted compared to the peaks of Comparative Examples 3 and 2, respectively, which indicates that bonding between Li and P occurred.

In particular, referring to (c) of FIG. 14, it may be confirmed that the P—OH peak intensity of the scaffold layer of Example 1 is reduced compared to that of Comparative Example 2, and a new P—O—Li peak is generated, which confirms that LiF of the first scaffold layer and BPA of the second scaffold layer were substitution-reacted.

### Experimental Example 5: Grazing Incident Wide Angle X-Ray Scattering (GIWAXS) Analysis

The phase distribution of a perovskite thin film was analyzed using GIWAXS equipment (PLS-II, Pohang accelerator laboratory).

The results for the perovskite thin film of Comparative Example 1 were shown in (a) of FIG. 17, the results for the perovskite thin film in Comparative Example 2 were shown in (b) of FIG. 17, and the results for the perovskite thin film in Example 1 were shown in (c) of FIG. 17. In addition, the z-direction graph of the upper drawing of (a) of FIG. 17 was shown in the lower drawing of (a) of FIG. 17, the z-direction graphic of the upper drawing of (b) of FIG. 17 was shown in the lower drawing of (b) of FIG. 17, and the z-directions graphic of the upper drawing of (c) of FIG. 17 was shown in the lower drawing of (c) of FIG. 17.

Referring to FIG. 17, in (a) and (b) of FIG. 17 showing the results of Comparative Examples 1 and 2, (002)ₙ₌₁ and (012)_{0D} peaks were observed, whereas in (c) of FIG. 17 showing the results of Example 1, (002)ₙ₌₁ and (012) 0D peaks were not observed. As a result, it was meant that in the perovskite thin film of Example 1, the low n-phase quasi-2D perovskite crystals were hardly formed, and the high n-phase quasi-2D perovskite crystals were mostly formed. Therefore, it may be confirmed that the thin film of Example 1 maintains high phase uniformity.

### Experimental Example 6: Confocal-Hyperspectral Photoluminescence (PL) Analysis

The confocal-hyperspectral PL properties of a perovskite thin film were analyzed using hyperspectral microscope equipment (IMA hyperspectral microscope, Photon Etc.).

A map for the perovskite thin film of Comparative Example 1 was shown in FIG. 18A, a map for the perovskite thin film in Comparative Example 2 was shown in FIG. 18B, and a map for the perovskite thin film in Example 1 were shown In FIG. 18C. In addition, PL spectra processed in the maps of (a), (b) and (c) of FIG. 18 were shown in (d), (e) and (f) of FIG. 18, respectively.

Referring to FIG. 18, in Comparative Examples 1 and 2, light emission was non-uniformly shown due to the presence of a 3D-phase or low n-phase quasi-2D phase in the perovskite thin film, but it may be confirmed that the light emission of the perovskite thin film of Example 1 was kept very constant due to the presence of most of a high n-phase quasi-2D phase.

### Experimental Example 7: Photoluminescence (PL) Spectral Graph

A PL spectrum graph, a Transient PL (TrPL) spectrum graph, and a Power dependent PL (PDPL) spectrum graph of a perovskite thin film were obtained using PL equipment (FluoTime 300, PicoQuant).

A PL spectrum, a TrPL spectrum, and a PDPL spectrum for the perovskite thin films of Comparative Examples 1 and 2, and Example 2 were shown in FIGS. 19, 20, and 21, respectively. The light emission FWHMs obtained through FIG. 19 were shown in Table 8.

TABLE 8

| | Com. Ex. 1 | Com. Ex. 2 | Ex. 1 |
|---|---|---|---|
| Light emission FWHM [nm] | 18.1 | 17.4 | 17 |

Referring to FIG. 19, in Example 1, the FWHM was measured as 17 nm, while in Comparative Examples 1 and 2, the FWHMs were measured as 18.1 and 17.4 nm, respectively, which was because Example 1 exhibited very uniform crystallinity. Therefore, it is expected that the color purity of the light emitting device manufactured in Example 1 will be very high.

Referring to FIG. 20, Comparative Examples 1 and 2 were measured at t=157.5 ns and t=169.2 ns, respectively, while Example 1 was measured at t=194.1 ns. This is a result showing that in Example 1, defects within the crystal are effectively suppressed, resulting in a long PL lifetime.

In FIG. 21, the PLQY of Comparative Examples 1 and 2 was less than 70% at a power density of 0.1 to 10 mW/cm², whereas the PLQY of Example 1 showed 80% or more to have excellent luminescence characteristics. As described above, this is because defects within the crystal of the perovskite thin film of Example 1 were effectively suppressed, thereby reducing electron-hole recombination at the defects.

### PREPARATION EXAMPLES

### Preparation Example 1

A perovskite layered structure of Example 1, prepared on a sample stacked in the order of Glass substrate/ITO (thickness: 70 nm)/MoO₃ (thickness: 5 nm)/NPB (thickness: 60 nm) was prepared.

Next, CN-T2T was loaded into a crucible of a vacuum thermal depositor, and then the deposition rate was set to 0.5 Å/s to form an electron transport layer having a thickness of 30 nm. The pressure of the vacuum thermal depositor was 2×10⁻⁷ Torr.

Next, Al was loaded into a crucible of a vacuum thermal depositor, and then the deposition rate was set to 1.0 Å/s to form a cathode having a thickness of 80 nm. The pressure of the vacuum thermal depositor was 2×10⁻⁷ Torr.

As a result, a light emitting device including the perovskite layered structure was prepared.

### Preparation Example 2

A perovskite layered structure of Example 2, prepared on a sample stacked in the order of Glass substrate/ITO (thickness: 150 nm)/SnO₂ (thickness: 20 nm) was prepared.

Then, Spiro-OMeTAD was spin-coated to form a hole transport layer having a thickness of 150 nm under conditions of 3,000 rpm and 30 seconds.

Next, MoO₃ and Al were loaded into a crucible of a vacuum thermal depositor, respectively, and then cathodes having thicknesses of 15 nm and 80 nm were sequentially formed at deposition rates of 0.1 Å/s and 1 Å/s, respectively. The pressure of the vacuum thermal depositor was 2×10⁻⁷ Torr.

As a result, a solar cell device including the perovskite layered structure was prepared.

### COMPARATIVE PREPARATION EXAMPLES

### Comparative Preparation Example 1

A light emitting device was prepared in the same manner as in Preparation Example 1 except that a perovskite thin film of Comparative Example 1 was used instead of the perovskite layered structure of Example 1.

### Comparative Preparation Example 2

A light emitting device was prepared in the same manner as in Preparation Example 1 except that a perovskite thin film of Comparative Example 2 was used instead of the perovskite layered structure of Example 1.

### EXPERIMENTAL EXAMPLES

### Experimental Example 8: Current Density-External Quantum Efficiency Graph of Light Emitting Device

The external quantum efficiency according to a current density of the light emitting device was measured using an IVLQE measuring device (CS2000 spectrometer, ENC technology). The external quantum efficiency of the light emitting devices of Preparation Example 1, and Comparative Preparation Examples 2 and 3 was measured and shown in FIG. 23, respectively.

As shown in FIG. 23, in the light emitting device of Preparation Example 1, the external quantum efficiency was measured to be 15% or more when the current density was 0.1 mA/cm², whereas in Comparative Preparation Examples 1 and 2, the external quantum efficiency was measured to be 10% or less when the current density was 0.1 mA/cm². That is, the light emitting device of Preparation Example 1 was measured to have excellent light emitting properties by using the perovskite thin film of Example 1 having very excellent phase uniformity.

### Experimental Example 9: Electroluminescence Spectrum of Light Emitting Device

The electroluminescence spectrum of the light emitting device was measured using an IVLQE measuring device (CS2000 spectrometer, ENC technology). The electroluminescence spectra of the light emitting devices of Preparation Example 1, and Comparative Preparation Examples 2 and 3 were measured and shown in FIG. 24, respectively.

Referring to FIG. 24, in Comparative Preparation Examples 1 and 2, the light emission FWHMs were measured to be 18.7 nm and 18.3 nm, respectively, but in Preparation Example 1, the light emission FWHM was measured to be 16.6 nm, which was the FWHM of 17 nm or less. The light emitting device of Preparation Example 1 is expected to exhibit very excellent color purity.

Although the examples of the present disclosure have been described as above, the technical spirit of the present disclosure is not limited to the embodiments presented in the present specification and those skilled in the art, who appreciate the technical spirit of the present disclosure will be able to easily propose other examples by addition, modification, deletion, annexation, and the like of components within the same scope of the technical spirit, but this is also included in the claims of the present disclosure.

What is claimed is:

1. A perovskite powder having a CsBX₃ structure with a crystallite size of 110 nm or less, wherein the powder has peaks at 14˜16°, 20˜22°, 30˜31°, 33˜35°, and 37˜38° without peaks at 11˜14° as 20 values in a XRD graph,
the B is a metal ion,
the X is F⁻, Cl⁻, Br⁻, I⁻, SCN⁻, OCN⁻, SeCN⁻, HCO²⁻, CH₃COO⁻, CF₃COO⁻ or a combination thereof,
the crystallite size of the powder is measured by X-ray diffraction and then obtained using Scherrer equation (D=λ/β cos θ), and
in the Scherrer equation, D denotes a crystallite size, K denotes a shape coefficient, λ denotes an X-ray wavelength, β denotes a full width at half maximum (FWHM) of a maximum intensity peak, and θ denotes an X-ray incident angle.

2. The perovskite powder of claim 1, wherein in the perovskite powder, perovskites having a CsBX₃ structure are manufactured into powder by adding and reacting an aqueous solution of HX (H is hydrogen) in a solution dissolved with CsX and BX₂ precursors.

3. The perovskite powder of claim 1, wherein the B is a divalent transition metal ion, a rare earth metal ion, an alkaline earth metal ion, a monovalent metal ion, a trivalent metal ion, or a combination thereof.

4. The perovskite powder of claim 2, wherein the molar ratio of the CsX and BX₂ is 1.15:1 to 1.95:1.

5. The perovskite powder of claim 2, wherein A′X is added and reacted in the solution,
wherein the A′ is a monovalent organic cation, a monovalent inorganic cation without Cs⁺ or a combination thereof, and
the X is F⁻, Cl⁻, Br⁻, I⁻, SCN⁻, OCN⁻, SeCN⁻, HCO²⁻, CH₃COO⁻, CF₃COO⁻ or a combination thereof.

6. The perovskite powder of claim 5, wherein the perovskite powder includes Cs₁₋ₐA′ₐBX₃ crystals,
wherein the A′ is a monovalent organic cation, a monovalent inorganic cation without Cs⁺ or a combination thereof, and
the a is more than 0 and 0.9 or less.

7. The perovskite powder of claim 1, wherein the powder has peaks at binding energy of 138 to 140 eV and 143 to 145 eV, without peaks at binding energy of 136 to 138 eV and 141 to 142 eV in the XPS graph.

8. A method for manufacturing a light emitting layer for a light emitting device, the method comprising: manufacturing a light emitting layer for a light emitting device by using a perovskite powder containing Cs₁₋ₐA′ₐBX₃ crystals as a single-source deposition source, performing vapor deposition by applying heat in a high vacuum state of 10-5 torr or less, and forming a thin film through the vapor deposition,
wherein the A′ is a monovalent organic cation, a monovalent inorganic cation without Cs⁺ or a combination thereof,
the B is a metal ion,
the X is F⁻, Cl⁻, Br⁻, I⁻, SCN⁻, OCN⁻, SeCN⁻, HCO²⁻, CH₃COO⁻, CF₃COO⁻ or a combination thereof, and
the a is 0 to 0.9.

9. The method of claim 8, wherein the deposition rate of single-source deposition source is 0.7 to 1.2 Å/s.

10. The method of claim 8, wherein the deposition is co-depositing a compound containing cations having an ionic radius larger than the ionic radius of Cs in order to substitute part or all of the Cs.

11. The method of claim 10, wherein the compound containing cations having the ionic radius larger than the ionic radius of Cs is an aromatic ammonium halide compound.

12. The method of claim 10, wherein a deposition rate ratio of the single-source deposition source and the deposition source containing the compound in the co-deposition is 1:0.65 to 1:0.85.

13. A light emitting layer for a light emitting device comprising:
Cs₁₋ₐA′ₐBX₃ crystals and/or A″₂(Cs₁₋ₐA′ₐ)ₘ₋₁BₘX₃ₘ₊₁ crystals inside the light emitting layer,
wherein the A′ is a monovalent organic cation, a monovalent inorganic cation without Cs⁺ or a combination thereof,
the A″ is a cation having an ionic radius greater than the ionic radius of Cs for partially or fully substituting Cs,
the B is a metal ion,
the X is F⁻, Cl⁻, Br⁻, I⁻, SCN⁻, OCN⁻, SeCN⁻, HCO²⁻, CH₃COO⁻, CF₃COO⁻ or a combination thereof,
the a is 0 to 0.9,
the m is an integer of 2 to 6, and
in an XPS graph of the light emitting layer, peaks are not shown at binding energy of 136 to 138 eV and 141 to 142 eV and peaks are shown at binding energy of 138 to 140 eV and 143 to 145 eV.

14. The light emitting layer for the light emitting device of claim 13, wherein the Cs₁₋ₐA′ₐBX₃ crystal is a 3D perovskite crystal, and the A″₂(Cs₁₋ₐA′ₐ)ₘ₋₁BₘX₃ₘ₊₁ crystal is a quasi-2D perovskite crystal.

15. The light emitting layer for the light emitting device of claim 13, wherein a mean grain size of the Cs₁₋ₐA′ₐBX₃ crystal and/or A″₂(Cs₁₋ₐA′ₐ)ₙ₋₁BₙX₃ₙ₊₁ crystal is 50 nm or less.
